(19) United States
(12) Patent Application Publication
(10) Pub. No.: US 2026/0254625 A1
(43) Pub. Date: Aug. 27, 2026

(54) JOINT MODULAR MULTIPLICATIVE INVERSE OPERATIONS FOR ACTIVE VOLUME QUANTUM COMPUTING

(71) Applicant: PsiQuantum, Corp., Palo Alto, CA (US)

(72) Inventor: Daniel Litinski, Berlin (DE)

(21) Appl. No.: 19/489,704

(22) PCT Filed: Jun. 13, 2024
(86) PCT No.: PCT/US2024/033884

§ 371 Date: Dec. 3, 2025

Related U.S. Application Data
(60) Provisional application No. 63/521,064, filed on Jun. 14, 2023.

(51) Int. Cl. H04L 9/08; H04L 9/30

(52) U.S. Cl. CPC H04L 9/0858; H04L 9/3066

(57) ABSTRACT

Systems, methods, and quantum circuits for utilizing a joint modular multiplicative inverse operation to perform quantum decryption. First and second private keys are determined by applying first and second series of quantum phase estimation circuits to first and second pluralities of qubits. The private keys are determined further based on public keys and a base point P. The first and second series of quantum phase estimation circuits include application of a joint modular multiplicative inverse circuit on a first qubit of the first plurality of qubits and a second qubit of the second plurality of qubits that calculates a modular multiplicative inverse of a modular product of a first value of the first qubit and a second value of the second qubit. The first and second private keys are stored in a non-transitory computer-readable memory medium.

### PRIORITY INFORMATION

This application claims priority to U.S. Provisional Patent Application No. 63/521,064, titled “Joint Modular Multiplicative Inverse Operations for Active Volume Quantum Computing”, and filed on Jun. 14, 2023, which is hereby incorporated by reference in its entirety as though fully and completely set forth herein.

### TECHNICAL FIELD

Embodiments herein relate generally to quantum computational methods, systems and devices, performing active volume quantum computation.

### BACKGROUND

Quantum computing is an emerging field with many technological challenges related to the efficient and effective control and manipulation of qubits. Current quantum computing systems and methods are less than ideally efficient, particularly in active volume quantum computing applications. Accordingly, improvements in the field of active volume quantum computation are desirable.

### SUMMARY

Some embodiments described herein include quantum computing devices, systems, quantum circuits and methods for utilizing a joint modular multiplicative inverse operation to perform quantum decryption, according to some embodiments.

In some embodiments, a first plurality of private keys is determined based on an application of a first series of quantum phase estimation circuits to a first plurality of qubits. The first plurality of private keys is determined further based on a first plurality of respective public keys and a base point P.

In some embodiments, a second plurality of private keys is determined based on an application of a second series of quantum phase estimation circuits to a second plurality of qubits. The second plurality of private keys is determined further on a second plurality of respective public keys and the base point P.

In some embodiments, applying the first and second series of quantum phase estimation circuits includes applying a joint modular multiplicative inverse circuit on a first qubit of the first plurality of qubits and a second qubit of the second plurality of qubits. The at least one joint modular multiplicative inverse circuit calculates a modular multiplicative inverse of a modular product of a first value of the first qubit and a second value of the second qubit.

In some embodiments, the first and second pluralities of private keys are stored in a non-transitory computer-readable memory medium.

In some embodiments, systems and methods are described for performing a quantum simulation to evolve a plurality of m physical systems in time. In some embodiments, the method includes representing time evolution of each physical system j of the plurality of m physical systems as a series of n Pauli operators, Pᵢⱼ for i=1 . . . n and j=1 . . . m, where the i denotes the n Pauli operators in the series and j denotes the m physical systems.

In some embodiments the method further includes, for each respective value of i, constructing a respective Hamming-weight phasing circuit to implement the m Pauli operators Pᵢⱼ, for j=1 . . . m, with the respective value of i.

The techniques described herein may be implemented in and/or used with a number of different types of devices, including but not limited to photonic quantum computing devices and/or systems, hybrid quantum/classical computing systems, and any of various other quantum computing systems.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the Figures.

FIG. 1 illustrates an example of a qubit entangling system in accordance with some embodiments;

FIGS. 2A-2H show examples of surface-code implementations for a logical qubit, according to some embodiments. FIG. 2A shows a physical qubit; FIGS. 2B and 2C show an entangled system of physical qubits providing a surface code usable for error correction. FIGS. 2D-2F illustrate circuits implementing stabilizer measurements on the surface code of FIGS. 2B and 2C. FIGS. 2G and 2H illustrate graphical representations of an identity gate applied to a logical qubit;

FIG. 3 shows a graph representation of a resource state that can be used in fusion-based quantum computing, according to some embodiments;

FIG. 4A shows an example of a fusion graph that can be used in some embodiments;

FIGS. 4B-4D shows examples of how fusion graphs (shown in FIG. 4D) can be generated from surface-code spacetime diagrams (shown in FIG. 4B) and time-slice diagrams (shown in FIG. 4C) for various logical operations on logical qubits, according to some embodiments;

FIG. 4E shows a legend for the fusion-graph notation used in FIG. 4D, according to some embodiments;

FIG. 5 shows schematic diagram of a quantum circuit, according to some embodiments;

FIG. 6 shows an active volume quantum computer system, according to some embodiments;

FIG. 7 illustrates a method for performing quantum decryption using a joint modular multiplicative inverse operation, according to some embodiments;

FIGS. 8A-B show Toffoli counts and active volume estimates, according to some embodiments;

FIG. 9A is a quantum circuit diagram illustrating a method for determining a private key from a private key and a base point, according to some embodiments;

FIG. 9B illustrates an example quantum circuit diagram to determine λᵣ, according to some embodiments;

FIG. 10 is a quantum circuit diagram configured to perform point addition, according to some embodiments;

FIG. 11A is a quantum circuit for performing in-place modular addition, according to some embodiments;

FIG. 11B is a quantum circuit for performing modular negation of x, according to some embodiments;

FIG. 11C is a quantum circuit for performing modular subtraction, according to some embodiments;

FIG. 11D is a quantum circuit for performing modular doubling, according to some embodiments;

FIGS. 11E-F are quantum circuit diagrams for performing modular multiplication, according to some embodiments;

FIG. 12 is a quantum circuit diagram illustrating an efficient modular inversion circuit, according to some embodiments;

FIG. 13A is a quantum circuit diagram configured to determine multiple private keys in a single computation, according to some embodiments;

FIG. 13B is a quantum circuit diagram configured to perform parallel modular inversion of two numbers, according to some embodiments;

FIGS. 14A-B show steps 1 and 2 of the elliptic curve point addition circuit in FIG. 10, according to some embodiments;

FIGS. 15A-B shows steps 3 and 4 of the elliptic curve point addition circuit in FIG. 10, according to some embodiments;

FIGS. 16A-B show steps 5 and 6 of the elliptic curve point addition circuit in FIG. 10, according to some embodiments;

FIG. 17 shows an example of parallel modular inversion of four numbers, according to some embodiments;

FIGS. 18A-B show parallel modular inversion of four numbers in which the four inverses are made available sequentially to save qubits, according to some embodiments;

FIGS. 19A-B show an example of two quantum circuits being executed in parallel, each one employing a modular inversion, according to some embodiments;

FIGS. 20A-B shows how a parallel modular inversion can take advantage of shared resources, in accordance with one or more embodiments;

FIGS. 21A-D illustrate embodiments related to quantum chemistry simulation, according to some embodiments; and

FIG. 22 is a flowchart of an example method for determining private keys, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

Disclosed herein are examples (also referred to as “embodiments”) of quantum systems and methods for estimating expectation values of arbitrary observables in arbitrary quantum states.

Although embodiments are described with specific detail to facilitate understanding, those skilled in the art with access to this disclosure will appreciate that the claimed invention may be practiced without these details. Reference will now be made in detail to embodiments, examples of which are illustrated in the accompanying drawings. In other instances, well-known methods, procedures, components, circuits, and networks have not been described in detail so as not to unnecessarily obscure aspects of the embodiments.

### Quantum Computing System

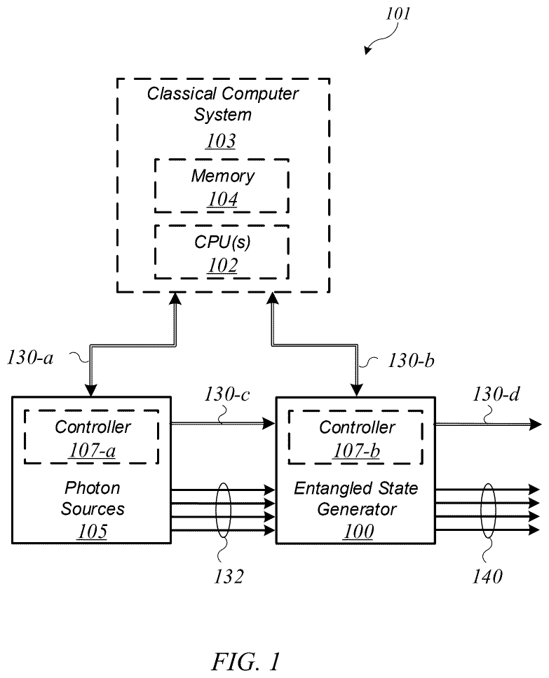

FIG. 1 illustrates an example of a qubit entangling system 101 in accordance with some embodiments. Such a system can be used to generate qubits (e.g., photons) in an entangled state (e.g., a GHZ state, Bell pair, and the like), in accordance with some embodiments. In some embodiments, qubit entangling system 101 can operate as a resource state generator as described below.

In an illustrative photonic architecture, qubit entangling system 101 can include a photon source module 105 that is optically connected to entangled state generator 100. Both the photon source module 105 and the entangled state generator 100 may be coupled to a classical processing system 103 such that the classical processing system 103 can communicate and/or control (e.g., via the classical information channels 130a-b) the photon source module 105 and/or the entangled state generator 100. Photon source module 105 may include a collection of single-photon sources that can provide output photons to entangled state generator 100 by way of interconnecting waveguides 132. Entangled state generator 100 may receive the output photons and convert them to one or more entangled photonic states and then output these entangled photonic states into output waveguides 140. In some embodiments, output waveguide 140 can be coupled to some downstream quantum photonic circuit that may use the entangled states, e.g., for performing a quantum computation. For example, the entangled states generated by the entangled state generator 100 may be used as resource states for one or more interleaving modules as described below.

In some embodiments, system 101 may include classical channels 130 (e.g., classical channels 130-a through 130-d) for interconnecting and providing classical information between components. It should be noted that classical channels 130-a through 130-d need not all be the same. For example, classical channel 130-a through 130-c may comprise a bi-directional communication bus carrying one or more reference signals, e.g., one or more clock signals, one or more control signals, or any other signal that carries classical information, e.g., heralding signals, photon detector readout signals, and the like.

In some embodiments, qubit entangling system 101 includes the classical computer system 103 that communicates with and/or controls the photon source module 105 and/or the entangled state generator 100. For example, in some embodiments, classical computer system 103 can be used to configure one or more circuits, e.g., using a system clock that may be provided to photon sources 105 and entangled state generator 100 as well as any downstream quantum photonic circuits used for performing quantum computation. In some embodiments, the quantum photonic circuits can include optical circuits, electrical circuits, or any other types of circuits. In some embodiments, classical computer system 103 includes memory 104, one or more processor(s) 102, a power supply, an input/output (I/O) subsystem, and a communication bus or interconnecting these components. The processor(s) 102 may execute modules, programs, and/or instructions stored in memory 104 and thereby perform processing operations.

In some embodiments, memory 104 stores one or more programs (e.g., sets of instructions) and/or data structures. For example, in some embodiments, entangled state generator 100 can attempt to produce an entangled state over successive stages, any one of which may be successful in producing an entangled state. In some embodiments, memory 104 stores one or more programs for determining whether a respective stage was successful and configuring the entangled state generator 100 accordingly (e.g., by configuring entangled state generator 100 to switch the photons to an output if the stage was successful, or pass the photons to the next stage of the entangled state generator 100 if the stage was not yet successful). To that end, in some embodiments, memory 104 stores detection patterns (described below) from which the classical computing system 103 may determine whether a stage was successful. In addition, memory 104 can store settings that are provided to the various configurable components (e.g., switches) described herein that are configured by, e.g., setting one or more phase shifts for the component.

In some embodiments, some or all of the above-described functions may be implemented with hardware circuits on photon source module 105 and/or entangled state generator 100. For example, in some embodiments, photon source module 105 includes one or more controllers 107-a (e.g., logic controllers) (e.g., which may comprise field programmable gate arrays (FPGAs), application specific integrated circuits (ASICS), a “system on a chip” that includes classical processors and memory, or the like). In some embodiments, controller 107-a determines whether photon source module 105 was successful (e.g., for a given attempt on a given clock cycle, described below) and outputs a reference signal indicating whether photon source module 105 was successful. For example, in some embodiments, controller 107-a outputs a logical high value to classical channel 130-a and/or classical channel 130-c when photon source module 105 is successful and outputs a logical low value to classical channel 130-a and/or classical channel 130-c when photon source module 105 is not successful. In some embodiments, the output of control 107-a may be used to configure hardware in controller 107-b.

Similarly, in some embodiments, entangled state generator 100 includes one or more controllers 107-b (e.g., logical controllers) (e.g., which may comprise field programmable gate arrays (FPGAs), application specific integrated circuits (ASICS), or the like) that determine whether a respective stage of entangled state generator 100 has succeeded, perform the switching logic described above, and output a reference signal to classical channels 130-b and/or 130-d to inform other components as to whether the entangled state generator has succeeded.

In some embodiments, a system clock signal can be provided to photon source module 105 and entangled state generator 100 via an external source (not shown) or by classical computing system 103 generates via classical channels 130-a and/or 130-b. In some embodiments, the system clock signal provided to photon source module 105 triggers photon source module 105 to attempt to output one photon per waveguide. In some embodiments, the system clock signal provided to entangled state generator 100 triggers, or gates, sets of detectors in entangled state generator 100 to attempt to detect photons. For example, in some embodiments, triggering a set of detectors in entangled state generator 100 to attempt to detect photons includes gating the set of detectors.

It should be noted that, in some embodiments, photon source module 105 and entangled state generator 100 may have internal clocks. For example, photon source module 105 may have an internal clock generated and/or used by controller 107-a and entangled state generator 100 has an internal clock generated and/or used by controller 107-b. In some embodiments, the internal clock of photon source module 105 and/or entangled state generator 100 is synchronized to an external clock (e.g., the system clock provided by classical computer system 103) (e.g., through a phase-locked loop). In some embodiments, any of the internal clocks may themselves be used as the system clock, e.g., an internal clock of the photon source may be distributed to other components in the system and used as the master/system clock.

In some embodiments, photon source module 105 includes a plurality of probabilistic photon sources that may be spatially and/or temporally multiplexed, i.e., a so-called multiplexed single photon source. In one example of such a source, the source is driven by a pump, e.g., a light pulse, that is coupled into an optical resonator that, through some nonlinear process (e.g., spontaneous four wave mixing, second harmonic generation, and the like) may generate zero, one, or more photons. As used herein, the term “attempt” is used to refer to the act of driving a photon source with some sort of driving signal, e.g., a pump pulse, that may produce output photons non-deterministically (i.e., in response to the driving signal, the probability that the photon source will generate one or more photons may be less than 1). In some embodiments, a respective photon source may be most likely to, on a respective attempt, produce zero photons (e.g., there may be a 90% probability of producing zero photons per attempt to produce a single-photon). The second most likely result for an attempt may be production of a single-photon (e.g., there may be a 9% probability of producing a single-photon per attempt to produce a single-photon). The third most likely result for an attempt may be production of two photons (e.g., there may be an approximately 1% probability of producing two photons per attempt to produce a single photon). In some circumstances, there may be less than a 1% probability of producing more than two photons.

In some embodiments, the apparent efficiency of the photon sources may be increased by using a plurality of single-photon sources and multiplexing the outputs of the plurality of photon sources.

The precise type of photon source used is not critical and any type of source can be used, employing any photon generating process, such as spontaneous four wave mixing (SPFW), spontaneous parametric down-conversion (SPDC), or any other process. Other classes of sources that do not necessarily require a nonlinear material can also be employed, such as those that employ atomic and/or artificial atomic systems, e.g., quantum dot sources, color centers in crystals, and the like. In some cases, sources may or may be coupled to photonic cavities, e.g., as can be the case for artificial atomic systems such as quantum dots coupled to cavities. Other types of photon sources also exist for SPWM and SPDC, such as optomechanical systems and the like. In some examples the photon sources can emit multiple photons already in an entangled state in which case the entangled state generator may not be necessary, or alternatively may take the entangled states as input and generate even larger entangled states.

For the sake of illustration, an example which employs spatial multiplexing of several non-deterministic photon sources is described as an example of a MUX photon source. However, many different spatial MUX architectures are possible without departing from the scope of the present disclosure. Temporal MUXing can also be implemented instead of or in combination with spatial multiplexing. MUX schemes that employ log-tree, generalized Mach-Zehnder interferometers, multimode interferometers, chained sources, chained sources with dump-the-pump schemes, asymmetric multi-crystal single photon sources, or any other type of MUX architecture can be used. In some embodiments, the photon source can employ a MUX scheme with quantum feedback control and the like.

The foregoing description provides an example of how photonic circuits can be used to implement physical qubits and operations on physical qubits using mode coupling between waveguides. In these examples, a pair of modes can be used to represent each physical qubit. Examples described below can be implemented using similar photonic circuit elements.

### Fault Tolerance and Logical Qubits

“Quantum computation,” as used herein, refers generally to performing a sequence of operations (a “computation”) on an ensemble of qubits. Quantum computation is often considered in the framework of “circuit-based quantum computation” (CBQC), in which the operations are specified as a sequence of logical “gates” performed on qubits. Gates can be either single-qubit unitary operations (rotations), two-qubit entangling operations such as the CNOT gate, or other multi-qubit gates such as the Toffoli gate. In the CBQC framework, quantum computations can be modeled as reversible circuits in which a set of input qubits are initialized in known states, then operated on by applying a series of “gates,” each of which is a unitary transform operation acting on one or more of the qubits. A measurement of the state of each qubit after applying the last gate yields a result of the computation. Gates used in quantum computing correspond to unitary operators acting on the qubits. Gates can include single-qubit unitary operations (e.g., Pauli rotations, identity gate), two-qubit entangling operations such as the CNOT gate, and other multi-qubit gates such as the three-qubit Toffoli gate. In a commonly-used circuit model of quantum computing, a particular computation can be defined by specifying a number of qubits and a particular sequence of gates. It has been shown that arbitrary quantum computations can be modeled using a finite set of gates that includes Clifford gates (which belong to a mathematical group of unitary transforms that includes Pauli rotations, CNOT gates, and Hadamard transforms), T gates that implement the transform

$$T = ( \begin{matrix}1 & 0 \\ 0 & {e}^{\frac{i π}{4}}\end{matrix} ) ,$$

and Toffoli gates (which are three-qubit gates analogous to a classical logic gate that negates its third input bit if and only if the first two input bits are both in the logical 1 state). A “general-purpose quantum computer” refers to a quantum computer that is able to execute different quantum computations (or circuits) using the same hardware, for example by applying different sequences of gates to the underlying physical qubits.

A quantum circuit model provides a conceptual framework that can potentially be realized using a variety of physical systems to implement the qubits and gates. However, physical systems implementing qubits and operations on qubits are often non-deterministic and noisy. For example, the photonic Bell state generator and fusion circuits described above can create entanglement between photonic qubits, but they do so non-deterministically, with a probability of success that is considerably less than 1. In addition, the physical systems may be “noisy”; for instance, a waveguide propagating a photon may be somewhat less than perfectly efficient, resulting in occasional loss of photons. For reasons such as these, fault tolerant quantum computing is a desirable goal. In general, fault tolerance entails constructing a “logical qubit” using systems of multiple physical qubits that are entangled in a manner that allows errors to be detected and corrected. Gate operations can then be performed on the logical qubits. One technique for fault tolerance that has been developed uses surface codes, in which many physical qubits are subject to parity-check operations to encode a single logical qubit.

It should be understood that a “qubit” is a unit of information. In some contexts, the term “qubit” refers to a physical system whose state space corresponds to one qubit of information, and in some contexts, the term “qubit” refers to a logical construct (such as a surface code) involving multiple physical qubits that collectively encode one qubit of information in a fault-tolerant manner. Where the context may leave the meaning ambiguous, the present disclosure uses the term “physical qubit” to refer to a physical system and “logical qubit” to refer to the fault-tolerant construct. A “measurement” operation on a logical qubit generally involves measuring the underlying physical qubits and analyzing the result (e.g., using a decoder algorithm) to extract a qubit of information.

### Surface Code Quantum Computing

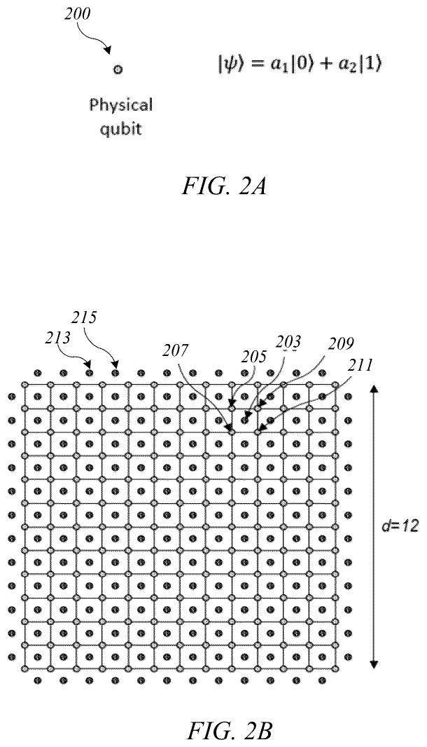

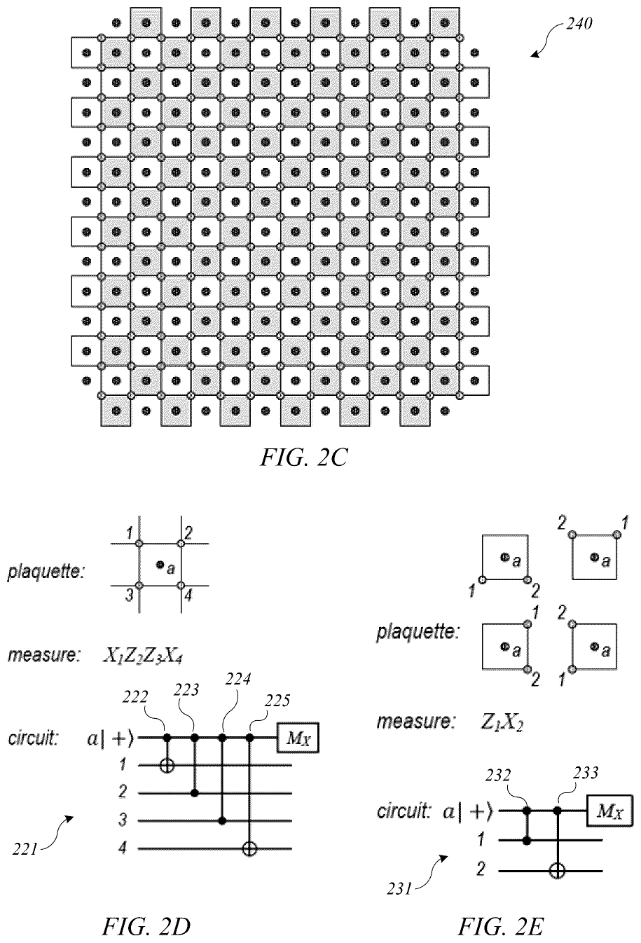

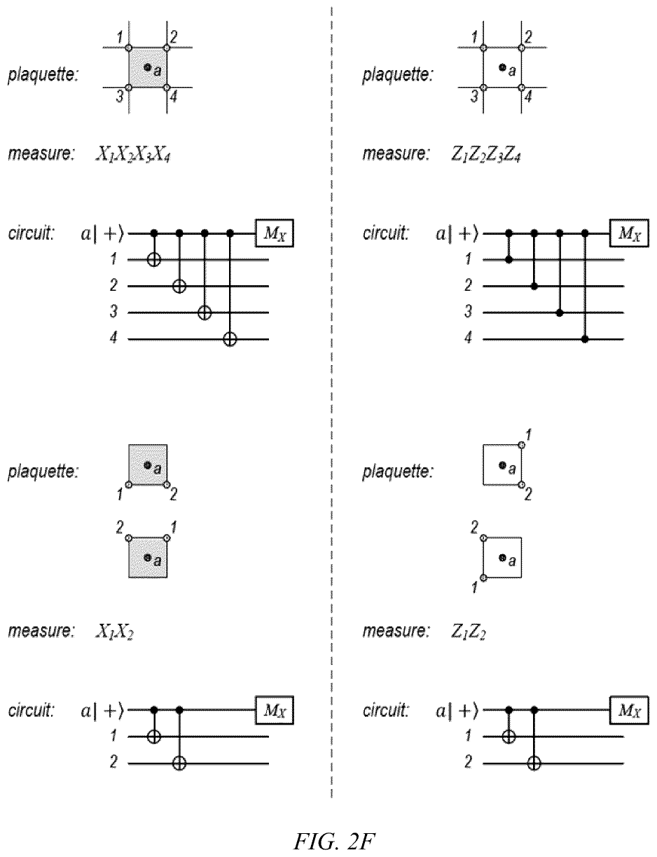

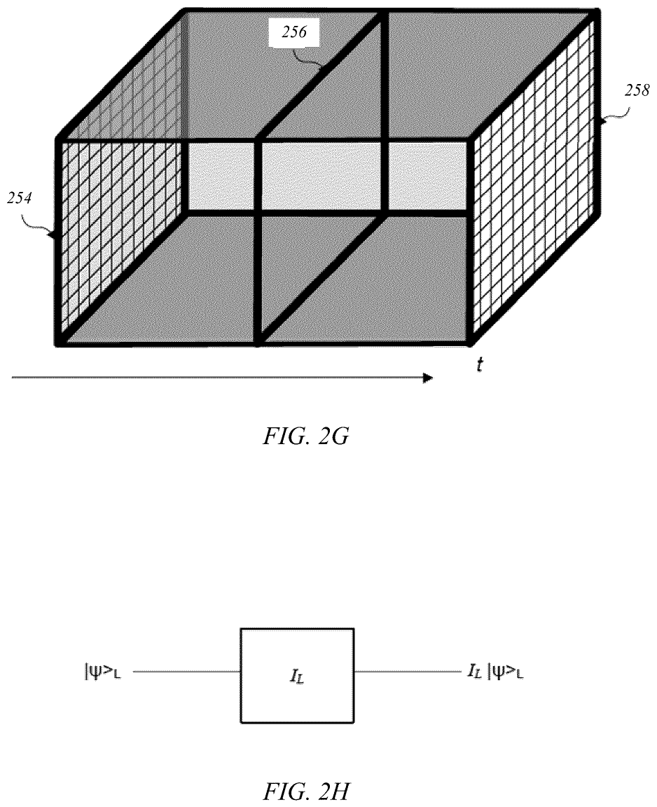

A single physical qubit (such as the 2-level physical qubit 200 illustrated in FIG. 2A with a quantum state |ψ [symbol] =a₁|0 [symbol] +a₂|1 [symbol] may be used for quantum computation. However, individual physical qubits are generally highly susceptible to noise and decoherence. Fault-tolerant quantum computing utilizes a plurality of entangled physical qubits to encode a single logical qubit to mitigate the frailty and/or short coherence times of individual physical qubits. In fault-tolerant quantum computing schemes, a plurality of physical qubits such as those illustrated in FIG. 2B are mutually entangled according to a specific error correcting code to produce a single logical qubit that is less susceptible to noise and decoherence. Encoding qubits in this manner causes the resultant logical qubit to be less sensitive to error and noise, and resultant errors may be dealt with via quantum error correction.

In some quantum computing methodologies, such as the fusion-based quantum computing described herein and circuit-based quantum computing, a logical qubit is encoded from a plurality of physical qubits using a sequence of specific measurements (e.g., stabilizer measurements). The measurement sequence may be constructed where a subset of the physical qubits is measured (e.g., producing classical information in the form of the measurement result) in such a way that the remaining unmeasured/un-collapsed degrees of freedom (e.g., a 2-dimensional subspace which has support over all the physical qubits) form the desired encoded logical qubit. Accordingly, the processes of performing stabilizer measurements and/or encoding a fault-tolerant logical qubit may receive a plurality of physical qubits as input and as output may produce both the encoded logical qubit and classical information (e.g., syndrome graph data) resulting from the measurement sequence.

In some quantum computing implementations, the classical information takes the form of syndrome graph data, where the syndrome graph is a geometric representation of the outcomes of the measurement sequence. Because the input physical qubits are prepared in an initial state and measured according to a predetermined measurement sequence, it may be determined how the syndrome should appear in the absence of any errors involving the physical qubits during the measurement sequence (e.g., Pauli or erasure errors). Accordingly, any deviation of the syndrome graph data from the expected result may be indicative of one or more errors within the logical qubit. In general, these deviations may not indicate precisely which measurement(s) had an error, or which type of error has occurred, as there may be more than one type of error or combination of errors that is consistent with a given observed deviation from the anticipated error-free syndrome graph. For example, a syndrome graph may be determined as a grid of parity checks for adjacent nodes of the grid, whereby a parity error may indicate that one or more of the adjacent nodes had an error, but the parity error may not indicate precisely which adjacent node had an error, or which error occurred.

As used herein, the term “syndrome graph data” refers to a set of classical information (e.g., data represented by digital values such as ones and zeros) that specifies the location of one or more syndromes and/or one or more erasure errors within the syndrome graph of a logical block. A series of measurements (e.g., stabilizer measurements) are applied to the physical qubits of the error correcting code containing the encoded logical information, producing measurement outcomes as classical information. As described in further detail below, based on the knowledge of the particular geometry of the error correcting code, these measurement outcomes may be used to determine classical data referred to herein as the “syndrome graph data.”

Errors that occur during operations on an encoded logical qubit may have varying degrees of severity. For example, errors in a fault-tolerant logical qubit may cause logical failure if they link up in a way that spans the syndrome graph of the logical qubit.

FIG. 2B shows an arrangement of physical qubits, including qubits 203, 205, 207, 209, 211, that can be used to encode a fault-tolerant logical qubit using a surface code according to one or more embodiments. In FIG. 2B, the solid grid lines are guides to the eye and form an array of squares, also referred to herein as a “surface code,” with physical “data qubits” (e.g., qubits 205, 207, 209, 211) disposed on the four vertices of each square and physical “measure qubits” (e.g., qubit 203) disposed on the face of each square. As used herein, measure qubits are the physical qubits which are measured to perform the stabilizer measurements (also referred to herein as “parity checks”) on adjacent data qubits without directly measuring the data qubits and collapsing the quantum information. In this example the surface code has a length (or more precisely, a “code distance”) d of 12, but any length can be employed. The surface code arrangement of qubits also includes four lines of boundary measure qubits (e.g., qubits 213, 215) disposed adjacent to the outermost lines of data qubits. Each square is referred to herein as a plaquette. Within the bulk of the surface code (i.e., the plaquettes which don't form the outer boundary of the code) each data qubit may be coupled, via 4 two-qubit gates (not shown in FIG. 2B), to its 4 nearest neighbor measure qubits (each on four different plaquettes) and likewise, each measure qubit may be coupled, via 4 two-qubit gates to its 4 nearest neighbor data qubits. On the boundaries of the code, each boundary measure qubit may be coupled, via two two-qubit gates (not shown in FIG. 2B) to its nearest adjacent data qubits. According to one or more embodiments, the two-qubit gates can be CNOT gates, CZ gates, and the like.

In order to operate the collection of data and measure qubits as a logical qubit that is protected against errors, the following set of measurements may be repetitively performed on the system. For each plaquette within the bulk of the surface code, 4-qubit stabilizers are measured. For example, as shown in FIG. 2D, if the data qubits of a given plaquette (e.g., data qubits 205-211 in FIG. 2B) are labeled 1, 2, 3,4 and the measure qubit (e.g., measure qubit 203 in FIG. 2B) is labeled a, the stabilizer to be measured on that plaquette can be x₁Z₂Z₃X₄. The “quantum circuit” (which is a term that refers to the sequence of gates and measurement operations to be performed on physical qubits) used to implement this stabilizer measurement is also shown as circuit 221 in FIG. 2D and includes first initializing the measure qubit a in the |ℑ+) state, then performing the following gates: a CNOT gate 222 between the measure qubit a and data qubit 1, respective CZ gates 223, 224 between the measure qubit a and qubit 2 and qubit 3, and a CNOT gate Z125 between the measure qubit a and qubit 4; followed by an X-basis measurement Mₓ of measure qubit a. The resulting measurement outcome (which takes the form of a classical bit, e.g., 0 or 1 or −1 or 1, depending on the choice of conventions) is equal to the outcome of the measurement of the parity check stabilizer x₁Z₂Z₃X₄ and becomes part of the syndrome graph. For the plaquettes found at the boundary of the surface code, examples of which are shown in FIG. 2E, a two-qubit stabilizer of the form Z₁x₂ is measured. The quantum circuit 231 used to implement this two-qubit stabilizer measurement is also shown in FIG. 2E and includes first initializing the boundary measure qubit a in the |ℑ+) state, then performing the following gates: a CZ gate 1132 between the measure qubit a and qubit 1; and a CNOT gate 233 between the measure qubit and qubit 2; followed by an X-basis measurement Mₓ of measure qubit a. In the example surface code 240 shown in FIG. 2C, there are two different types of boundaries depending on whether the boundary includes shaded plaquettes (e.g., at the top and bottom edges in the figure as drawn) or unshaded plaquettes (e.g., at the left and right edges in the figure). A boundary surface that includes shaded plaquettes is referred to as a “dual boundary surface” and measurements including measure qubits within the dual boundary surface contribute to the “dual syndrome graph.” Similarly, a boundary surface that includes unshaded plaquettes is referred to herein as a “primal boundary surface,” and measurements including measure qubits within a primal boundary surface contribute to the “primal syndrome graph.”

In order to implement the surface code scheme shown in FIG. 2C-2E, the plaquette measurements may be broken into two groups of measurements: a first group of measurements that measures the stabilizers associated with the shaded plaquettes during a first duration of time and a second group of measurements that measures the stabilizers with the unshaded plaquettes during a second duration of time. These two sets of measurements are performed in different times to ensure that each qubit only participates in one quantum gate at a time. One of ordinary skill in the art will appreciate that any gates that can commute with one another may be performed in the same time step, or even simultaneously, if desired. The classical data generated by each one of these measurements, referred to herein as “syndrome graph data,” is then passed to a decoder for quantum error correction according to known methods, e.g., using union find decoding, minimum weight perfect matching or any other decoding process.

One of ordinary skill will appreciate that the example shown in FIGS. 2C-2E is based on a particular choice of local basis for the surface code and that other choices for the basis may be employed. For example, in some contexts, taking certain assumptions on the likely form of the errors that may occur on the underlying data and measure qubits, one may apply a single qubit gate to each data qubit to obtain a modified surface code. One may modify the basis for each check to obtain a scheme for the modified code. One example includes the CSS (Calderbank, Shor, Steane) version, where stabilizer measurements are either x-type or z-type. To obtain this version of the surface code, the stabilizers are conjugated by a Hadamard H: X→Z, Z→X on half the data qubits in a bipartition, thereby resulting in the CSS surface code. Note that the measurement schedule described above remains the same, but the stabilizers are somewhat different, as summarized in FIG. 2F.

If the above-described surface code measurement schedule is applied for numerous time steps, the system of entangled physical qubits effectively acts as a fault-tolerant quantum memory for the logical qubit encoded by the underlying surface code or, viewed another way, as a fault-tolerant logical identity gate on the logical qubit that is encoded by the underlying surface code. Viewed yet another way, this process operates as a fault-tolerant logical channel.

FIG. 2G illustrates a 3-dimensional graphical depiction of such a fault-tolerant logical identity gate. The surface labeled 254 is the input port to the gate and includes an arbitrary logical state encoded in a surface code, represented as the input checkerboard surface. Likewise, the surface labeled 258 identifies the output qubits after the identity gate/has been applied to it. The input and output surfaces, which may be associated with the physical 2D arrangement of data and measure qubits described above, are connected to each other via an intervening volume that represents the unique set of measurements to be applied over time as described above in reference to FIG. 2C-2E. Accordingly, in FIG. 2G, time flows from left to right and the lighter shaded (front and back) and darker shaded (top and bottom) sides of the boundaries of the volume depict whether the primal or dual plaquettes are disposed on that boundary as described above in reference to FIG. 2C-2E. For convenience of description, a graphical depiction of a fault-tolerant gate such as the identity gate in FIG. 2G can be associated with cardinal directions referred to as North-South (N-S), East-West (E-W), and Up-Down (U-D), with time flowing “upward” along the U-D axis and the north, south, east, and west directions corresponding to the boundaries of the volume. Such directional references are not to be understood as implying an actual spatial arrangement of physical qubits or circuit components.

FIG. 2H represents the same concept (an identity gate) but written in a more familiar quantum circuit notation illustrating the analogy between surface codes and the more familiar quantum circuit. While FIG. 2G shows the logical identity gate, any gate can be depicted in this manner and such a depiction is one example of a “logical block” that specifies a set of instructions to be performed on the underlying surface code qubits to perform a logical operation (the identity gate in this example) on the logical qubit that is encoded by surface code. Other examples of such gates are the S gate, the Hadamard gate, and the CX gate, among other possibilities.

The sequence of measurements performed over the flow of time illustrated in FIG. 2G (e.g., a sequence of measurements including the circuit measurements) may include a subset of measurements that incur a logical error (e.g., a Pauli error) or an erasure error. To identify errors in the measurement outcomes, syndrome graph data may be generated from the collection of measurement outcomes resulting from the measurements of the physical qubits. For example, the bit values associated with a plurality of edge qubits may be combined to create a syndrome value associated with an adjacent vertex that results from the intersection of the respective edges, e.g., the result of the measurements. A set of syndrome values (or “syndromes”), also referred to herein as parity checks, may be associated with each vertex of the syndrome graph. The parity check values may be found by computing the parity of the bit values associated with each edge of the syndrome graph incident to the vertex. In some embodiments, a parity computation entails determining whether the sum of the edge values is an even or odd integer, with the parity result being the result of the sum modulo 2. If no errors have occurred in the quantum state or in the qubit measurements, then all syndrome values should be even (or 0). On the contrary, if an error occurs, it may result in some odd (or 1) syndrome values.

In some embodiments, half of the bit values from the qubit measurements are associated with the primal boundary surfaces, and this syndrome graph is referred to herein as the “primal graph.” The syndrome graph resulting from measurements on the dual boundary surfaces is referred to as the “dual graph.” There is generally an equivalent decoding problem on the syndrome values of the primal and dual graphs.

Surface codes can be implemented using a qubit entangling system, e.g., the system of FIG. 1 described above, to generate entangled systems of physical qubits. In some embodiments, an entangled system of multiple physical qubits can be mapped to one or more “logical qubits,” and operations associated with a quantum computation can be defined as logical operations on logical qubits, which in turn can be mapped to physical operations on physical qubits. In general, the term “qubit,” when used herein without specifying physical or logical qubit, should be understood as referring to a physical qubit.

Those skilled in the art will appreciate that the foregoing examples of surface codes and stabilizers are illustrative of topological codes that can be used for quantum error correction, with different topological codes using different stabilizers applied to different numbers and combinations of physical qubits. Accordingly, while surface codes are used herein for purposes of illustration, systems and methods described herein are not limited to surface codes or to any particular stabilizers and can be implemented in connection with other topological codes, including toric codes, color codes, and so on.

### Overview of Fusion-Based Quantum Computing (FBQC)

Fusion-based quantum computing (FBQC) is a technique for implementing surface-code quantum computing that is well suited to systems where the physical qubits are implemented using photons. In FBQC, a large number of “resource states” is generated, where each resource state includes a small number (e.g., around 6 to 30) of entangled qubits. By performing projective entangling measurements (e.g., Type II fusion as described above) on qubits of different resource states, the same parity-check measurements as in conventional surface code implementations can be obtained, without the need to construct or maintain large entangled systems of physical qubits.

To understand FBQC, it is useful to first consider measurement-based quantum computing (MBQC), which is an approach to implementing quantum computing that allows for fault-tolerance. In MBQC, computation proceeds by first preparing a particular entangled state of many physical qubits, commonly referred to as a “cluster state,” then carrying out a series of single-qubit measurements to enact (or execute) the quantum computation. For instance, rather than implementing a sequence of gates operating on one or two physical qubits, a subset of the physical qubits in the cluster state can be mapped to a “logical” qubit, and a gate operation on logical qubits can be mapped to a particular set of measurements on physical qubits associated with one or more logical qubits. Entanglement between the physical qubits results in expected correlations among measurements on different physical qubits, which enables error correction. The cluster state can be prepared in a manner that is not specific to a particular computation (other than, perhaps, the size of the cluster state), and the choice of single-qubit measurements is determined by the particular computation. In the MBQC approach, fault tolerance can be achieved by careful design of the cluster state and by using the topology of the cluster state to encode logical qubits in a manner that protects against any logical errors that may be caused by errors on any of the physical qubits that make up the cluster state. The value (or state) of the logical qubit(s) can be determined, i.e., read out, based on the results (also referred to herein as measurement outcomes) of the single-particle measurements that are made on the cluster state's physical qubits as the computation proceeds.

For example, a cluster state suitable for MBQC can be defined by preparing a collection of physical qubits in a particular state (sometimes referred to as the |+) state) and applying a controlled-phase gate (sometimes referred to as a “CZ gate”) between pairs of physical qubits to generate the cluster state. Graphically, a cluster state formed in this manner can be represented by a graph with vertices representing the physical qubits and edges that represent entanglement (e.g., the application of CZ gates) between pairs of qubits. The graph can be a three-dimensional graph having a regular structure formed from repeating unit cells and is sometimes referred to as a “lattice.” One example of a lattice is the Raussendorf lattice, which is described in detail in R. Raussendorf et al., “Fault-Tolerant One-Way Quantum Computer,” Annals of Physics 321 (9): 2242-2270 (1106). In such representations, two-dimensional boundaries of the lattice can be identified. Qubits belonging to those boundaries are referred to as “boundary qubits” while all other qubits are referred to as “bulk qubits.” Other cluster state structures can also be used. Logical operations are performed by making single-qubit measurements on qubits of the cluster state, with each measurement being made in a particular logical basis that is selected according to the particular quantum computation to be performed. The collection of measurement results across the cluster state can be interpreted as the result of a quantum computation on a set of logical qubits through the use of a decoder. Numerous examples of decoder algorithms are available, including the Union-Find decoder as described in International Patent Application Publication No. WO 2019/002934 A1.

However, the generation and maintenance of long-range entanglement across the cluster state and subsequent storage of large cluster states can be a challenge. For example, for any physical implementation of the MBQC approach, a cluster state containing many thousands, or more, of mutually entangled qubits may be prepared and then stored for some period of time before the single-qubit measurements are performed.

“Fusion-based quantum computing” (FBQC) is a technique related to MBQC in that a computation on a set of logical qubits can be defined as a set of measurements on a (generally much larger) number of physical qubits, with correlations among measurement results on the physical qubits enabling error correction. FBQC, however, avoids the need to first create, then subsequently manipulate, a large cluster state. In a photonic implementation of FBQC, entangled states consisting of a few physical qubits (referred to as “resource states”) are periodically generated and transported (via waveguides) to circuits that can perform measurement operations (e.g., type II fusion operations as described above, which can provide two-qubit measurements, and/or single-qubit measurements). The measurements destroy the measured qubits; however, the quantum information is preserved as it is transferred (teleported) to other qubits of other resource states. Thus, quantum information is not stored in a static array of physical qubits but is instead periodically teleported to freshly generated physical qubits.

In FBQC, somewhat similarly to MBQC, a computation can be mapped to an undirected graph, referred to as a fusion graph, that can have a lattice-like structure. The fusion graph can define operations to be performed on the physical qubits of the resource states, including fusion operations on selected qubits of different resource states (e.g., in the “bulk” region of a lattice) and individual qubit measurements (e.g., at boundaries of the lattice). Examples of FBQC techniques are described in WO 2021/155289, “Fusion Based Quantum Computing,” published Aug. 5, 2021. This section provides a conceptual description of FBQC, to provide context for interleaving modules and other hardware components described below.

### Resource States

As noted, FBQC can use a “resource state” as a basic physical element to implement quantum computations. As used herein, a “resource state” refers to an entangled system of a number (n) of physical qubits in a non-separable entangled state (which is an entangled state that cannot be decomposed into smaller separate entangled states). In various embodiments, the number n can be a small number (e.g., between 3 and 30), although larger numbers are not precluded.

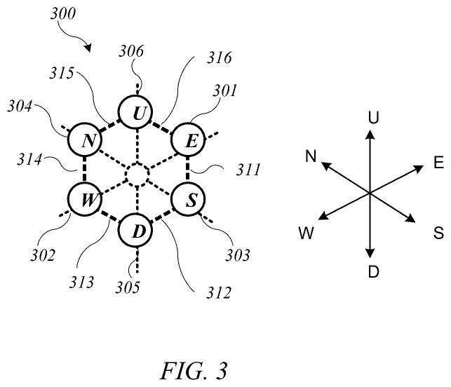

FIG. 3 shows a graph representation of a resource state 300 that can be used according to some embodiments. In the graph representation of FIG. 3, each physical qubit 301-306 of resource state 300 is represented as a circle, and entanglement between physical qubits is represented by lines 311-316 connecting pairs of qubits. Resource state 300 is sometimes referred to as a “6-ring” resource state. In examples used herein, the entanglement geometry defines a three-dimensional space. For convenience, the cardinal directions in the entanglement space are referred to as North-South (N-S), East-West (E-W), and Up-Down (U-D). Resource state 300 has one qubit associated with each cardinal direction (N, S, U, D, E, W) in the entanglement space. It should be understood that the directional labels refer to entanglement space and need not correspond to physical dimensions or directions in physical space. Further, in some instances qubits may be separated in time rather than in spatial dimensions. For example, each physical qubit can be implemented using photons propagating in waveguides, and a particular section of waveguide may propagate photons associated with different qubits at different times.

In some embodiments, resource state 300 can be generated using photon sources and entanglement circuits of the kind described above. For example, Bell pairs can be generated using one or more photon sources, which can be MUX photon sources. A 3-GHZ state can be generated from two Bell pairs using a type-I fusion photonic integrated circuit. From a set of six 3-GHZ states, 6-ring resource state 300 can be formed using a type-II fusion circuit. In some implementations, outputs of several such circuits can be multiplexed using temporal and/or spatial multiplexing techniques to increase the probability of producing a resource state.

Resource state 300 is illustrative and not limiting. In some embodiments, the entanglement geometry of a resource state can be chosen based on a particular computation to be executed, and different resource states that are used in the same computation can have different entanglement geometries. Further, while resource state 300 includes six qubits, the number of qubits in a resource state can also be varied. Accordingly, a resource state may be larger or smaller than the example shown. The circuitry used to generate a resource state can also be varied, depending on the particular entanglement geometry and/or the probability of success of various entanglement-generating operations. Error correcting codes may also be constructed to account for a nonzero probability of a resource state not being generated.

### Logical Operations

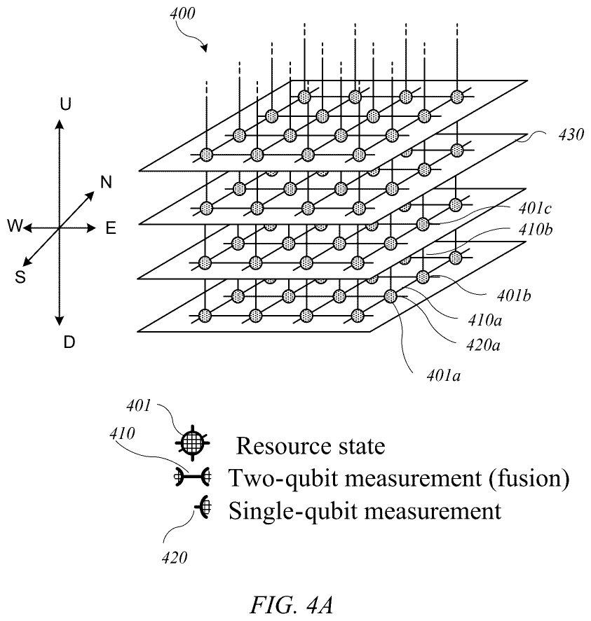

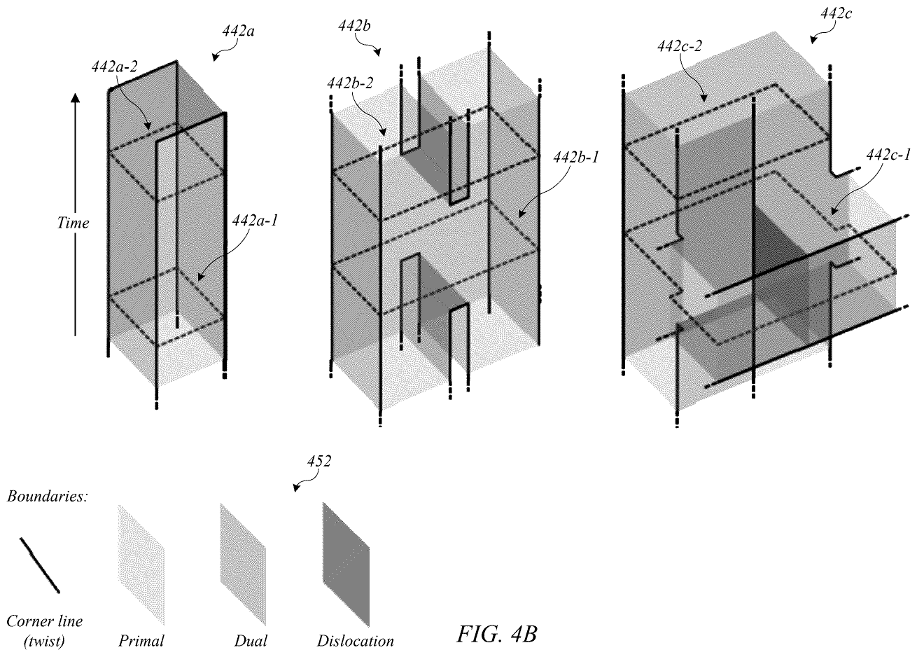

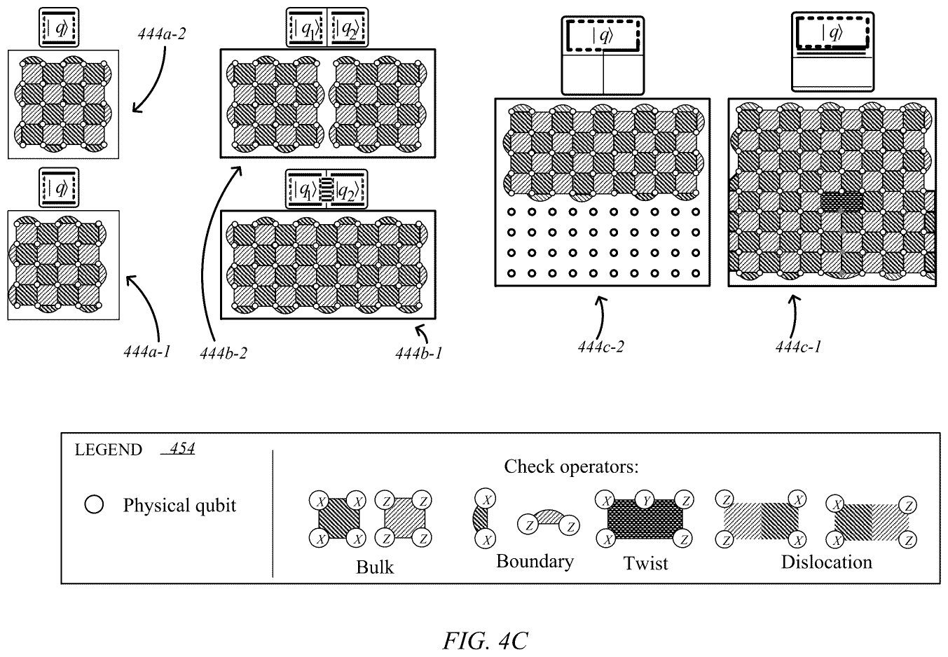

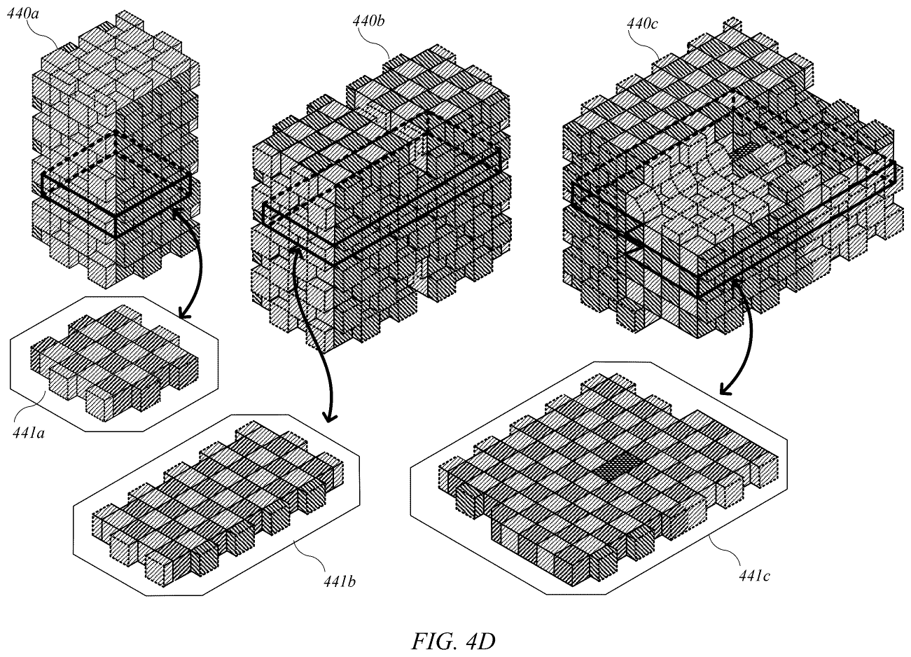

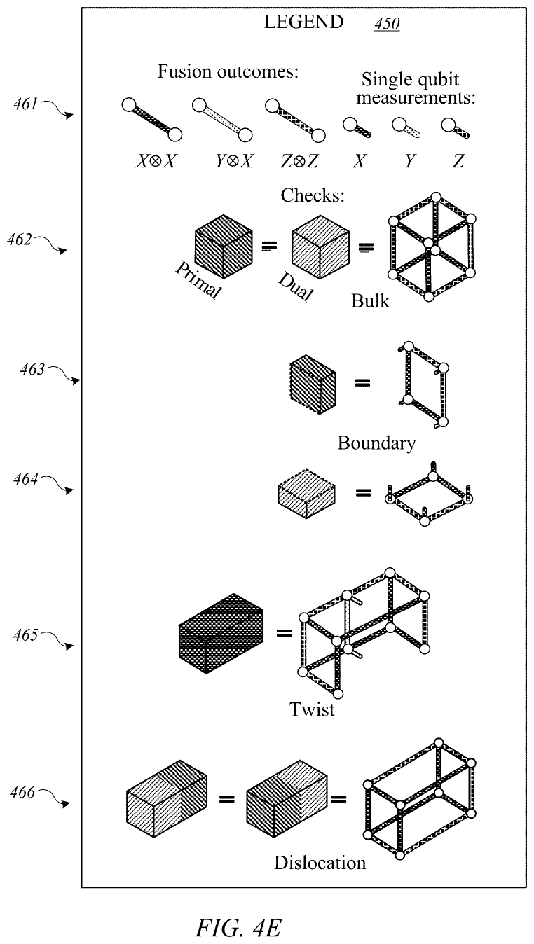

Operations to be performed on qubits of resource states in connection with FBQC can be represented conceptually using a fusion graph. FIG. 4A shows an example of a fusion graph 400, according to some embodiments. The same three-dimensional entanglement space defined in FIG. 3 is used, with the same N-S, E-W, U-D naming convention (which need not correspond to any physical dimension or direction). However, unlike in FIG. 3, each vertex 401 represents a resource state (e.g., 6-ring resource state 300) rather than an individual qubit. Each vertex 401 represents a physically distinct instance of the resource state. Each edge 410 connecting two vertices 401 corresponds to a fusion operation between qubits of different resource states. Each fusion operation can be, e.g., a type II fusion operation as described above that produces a two-qubit measurement. The particular qubits involved can be identified from the direction of the edges in the entanglement space. Thus, for example, edge 410a corresponds to a fusion operation between the N qubit of a resource state represented by vertex 401a and the S qubit of a (different) resource state represented by vertex 401b, while edge 410b corresponds to a fusion operation between the U qubit of the resource state represented by vertex 401b and the D qubit of a (third) resource state represented by vertex 401c. Each half-edge 420 (a “half-edge” is connected to only one vertex 401) represents a single-qubit measurement on the corresponding qubit of the resource state represented by that vertex 401. Thus, for example, half-edge 1320a corresponds to a single-qubit measurement on the E qubit of the resource state represented by vertex 401a.

In some embodiments, a fusion graph such as fusion graph 400 can be viewed as a series of “layers” 430, where each layer corresponds to a coordinate on the U-D axis. Implementing FBQC in a physical system can include successively generating resource states for each layer (e.g., in the direction from D to U) and performing the fusion and single-qubit measurement operations within each layer as specified by the edges and half-edges of the graph for that layer. As resource states for successive layers are generated, fusion operations can be performed between the U qubits of resource states in one layer and the D qubits of resource states in corresponding position of the next layer. In the description that follows, fusion operations may be referred to as “spacelike” or “timelike.” This terminology is evocative of particular implementations in which different qubits or resource states are generated or received at different times: spacelike fusion can be performed between qubits generated or received at the same time using different instances of hardware, while timelike fusion can be performed between qubits generated or received at different times using the same instance of hardware (or different instances of hardware). For photonic qubits, timelike fusion can be implemented by delaying an earlier-produced qubit (e.g., using additional lengths of waveguide material to create a longer propagation path for the photon), thereby allowing mode coupling with a later-produced qubit. By leveraging timelike fusion, the same hardware can be used to generate and/or process multiple instances of the resource states within a layer and/or to generate multiple layers of resource states. Examples are described below.

In some encoding schemes for sequences of operations on logical qubits, a logical qubit that is “at rest” (i.e., not interacting with other logical qubits or otherwise being operated on) can be mapped onto a fusion graph having a regular lattice pattern as shown in FIG. 4A. For the 6-ring resource state of FIG. 3, each resource state in the bulk of the lattice has each of its six qubits fused with a qubit of a neighboring resource state. (Two qubits that are input to a type II fusion circuit are sometimes colloquially described as being “fused with” each other.) For instance, E qubit 301 of a first instance of resource state 300 and W qubit 302 of a second instance of resource state 300 can be input into a fusion circuit (e.g., a type II fusion photonic integrated circuit), resulting in a two-qubit measurement. At the boundaries of the lattice, qubits that are not subject to fusion operations can be subject to single-qubit measurements.

Logical operations on logical qubits can be specified by modifying the regular lattice pattern of a fusion graph at selected positions, e.g., by replacing single-qubit measurements with fusion operations or vice versa. The choice of modifications depends on the particular computation to be performed. Some examples will now be described.

In some embodiments, fusion graphs such fusion graph 400 can be used to specify logical operations to be performed on a set of logical qubits. For example, a fusion graph defining a logical operation implemented in FBQC can be generated from a surface-code spacetime or time-slice diagram of the kind used to define computations in fault-tolerant CBQC, as described above. FIGS. 4B-4D show examples of how fusion graphs can be generated from surface-code spacetime or time-slice diagrams for three different logical operations: (a) measurement of an idling logical qubit (i.e., a logical qubit that is not interacting with any other logical qubit); (b) two-qubit X⊗X measurements (“lattice surgery”); and (c) Y measurement with a twist. Figure two-qubit X 4E shows a legend 450 for the fusion-graph notation used in FIG. 4D.

FIG. 4B shows examples of surface-code spacetime diagrams 442a-442c, which can be constructed using techniques known in the art. As shown in legend 452, surface-code spacetime diagrams can represent logical operations (e.g., twists, dislocations) on surfaces (e.g., primal and dual boundaries) that define logical qubits. Spacetime diagram 442a corresponds to a logical qubit undergoing an identity gate. Spacetime diagram 442b corresponds to a two-qubit X⊗X measurement. Spacetime diagram 442c corresponds to a Y measurement with a twist. When performing fault-tolerant quantum computations with surface codes and CBQC, an entire quantum computation can proceed through a sequence of time slices (or time steps). At each time slice, a set of “check operator” measurements, also referred to herein a stabilizer measurements, is performed, where the check operator measurements are measurements of operators on physical qubits; the pattern of check operator measurements implements certain logical operations on logical qubits and enables the detection and correction of errors. The check operator measurements at a given time slice can be represented in a time-slice diagram. By way of example, for each logical operation in FIG. 4B, time-slice diagrams for two representative time slices are shown in FIG. 4C. Specifically, time slices 444a-1 and 444a-2 are selected from spacetime diagram 442a; time slices 444b-1 and 444b-2 are selected from spacetime diagram 442b; and time slices 444c-1 and 444c-2 are selected from spacetime diagram 442c. In all time slice diagrams of FIG. 4C, a square code distance of 5 is used, and a logical qubit is mapped to a square patch of 5×5 physical qubits to which check operators are applied. (It should be understood that different code distances can be applied.) As shown in legend 454, the check operators in each time slice include four-qubit operators X^{⊗4} and Z^{⊗4} in the bulk and two-qubit operators X^{⊗2} and Z^{⊗2} at the boundaries, where X, Y, and Z are the Pauli operators on physical qubits. Twist and dislocation operators are also defined as illustrated. As shown in time-slice diagrams 444a-1, 444a-2, 444b-1, 444b-2, 444c-1, and 444c-2, a time slice can be drawn in a simplified manner that omits notation of the physical-qubit operators; the correct operators can be inferred from the pattern of light and dark shading according to the legend.

A quantum computation can be expressed as a sequence of time slices such as the time slices of FIG. 4C. However, it is often more convenient to represent a sequence of 2D time slices in a 3D diagram, such as spacetime diagrams 442a-442c of FIG. 4B. The solid black lines in a spacetime diagram trace the trajectory of patch corners through spacetime. Shading-coded (or color-coded) surfaces track primal and dual boundaries through space time; the meaning of the various shading patterns is indicated in legend 452. A 2D spacelike cross section through a spacetime diagram 442 corresponds to a time-slice diagram 444. The bulk has a regular pattern of primal and dual measurements (as seen in the various time slice diagrams of FIG. 4C), and measurements in the bulk can be inferred from the boundaries. Also shown in FIG. 4B are corner lines indicating the twist operation (applied in time slice 444c-1) and associated dislocation of the boundary. Spacetime diagrams need not directly show the number of time slices (or the code distance) to which they correspond. Typically, though not necessarily, each change to the spatial configuration lasts for a number of time slices equal to the code distance.

For purposes of illustration, spacetime diagram 442a shows a logical qubit that idles for a while until it is measured in the Z basis, as indicated by the corner lines and dual boundary capping off spacetime diagram 442a. Spacetime diagram 442b corresponds to a logical two-qubit measurement X⊗X via “lattice surgery.” Spacetime diagram 442c corresponds to a logical qubit encoded in a rectangular patch contributing to a logical multi-qubit Pauli measurement with its Y operator. The details of these logical operations (including how the spacetime diagrams correspond to particular logical operations) are not relevant to understanding the present disclosure; those skilled in the art will be familiar with such details and techniques for constructing spacetime diagrams and time-slice diagrams.

In some embodiments for FBQC, a spacetime diagram can be translated to a fusion graph in a straightforward manner. For instance, FIG. 4D shows fusion graphs 440a-440c corresponding to spacetime diagrams 442a-442c. Fusion graphs 440a-440c can be generally similar to fusion graph 400 in that both describe a cubic lattice of resource states. However, fusion graphs 440 add additional information about the measurement operations to be performed, by assigning color or shading to certain cubic or cuboid volumes within the lattice. FIG. 4E shows a legend 450 indicating how the shading (or color) of a cubic or cuboid volume in fusion graphs 440a-440c maps to a corresponding set of measurements on qubits of different resource states. In FIG. 4E, top row 461 defines line styles representing specific two-qubit (fusion) and single-qubit measurements. Subsequent rows 462-466 indicate how each cubic or cuboid volume maps to a combination of fusion and single-qubit measurements. In some embodiments, each two-qubit fusion measurement (e.g., a type II fusion measurement) produces both X⊗X and Z⊗ Z measurement outcomes; thus the primal and dual checks of a CBQC spacetime diagram, when translated to a fusion graph, can both correspond to the same measurement operations (and the same hardware) and combinations of outcomes, as shown in second row 462 of legend 450. The difference between primal and dual checks can be in how the measurement outcome data is used in decoding. Boundary checks, shown in rows 463 and 464 of legend 450, correspond to half-cubes that involve a combination of fusion outcomes and two single-qubit measurements. Twists, shown in row 465 of legend 450, involve Y⊗Y fusion measurements (and skipping over certain lattice locations). In some implementations, the Y⊗Y fusion measurements do not require additional hardware, as they can be determined by multiplying the X⊗X and Z⊗Z fusion measurement outcomes. Dislocations, shown in row 466 of legend 450, skip over certain lattice locations and involve X⊗X and Z⊗Z fusion measurements.

The translation from spacetime diagram to fusion graph can be accomplished, e.g., by comparing FIGS. 4C and 4D. The bulk of the fusion graph is filled with primal and dual bulk cubes in a 3D checkerboard pattern, and the primal and dual boundaries are decorated with primal or dual half-cubes. If twists or lattice dislocations are present, they are added using the cuboids shown in legend 450. Slices of the fusion graph can mimic the pattern of the corresponding CBQC time slices, although the interpretation is different, as can be seen by comparing legend 450 (FIG. 4E) and legend 454 (in FIG. 4C). The number of cubes in the fusion graph depends on the code distance, and time slices of square patches having code distance d involve d² resource states.

Additional description related to generation of fusion graphs such as fusion graphs 440 can be found in above-referenced WO 2021/155289 and in H. Bombin et al., “Interleaving: Modular architectures for fault-tolerant photonic quantum computing,” arXiv: 2013.08612v1 [quant-ph], 15 Mar. 2021.

### Active Volume Quantum Computer Architectures

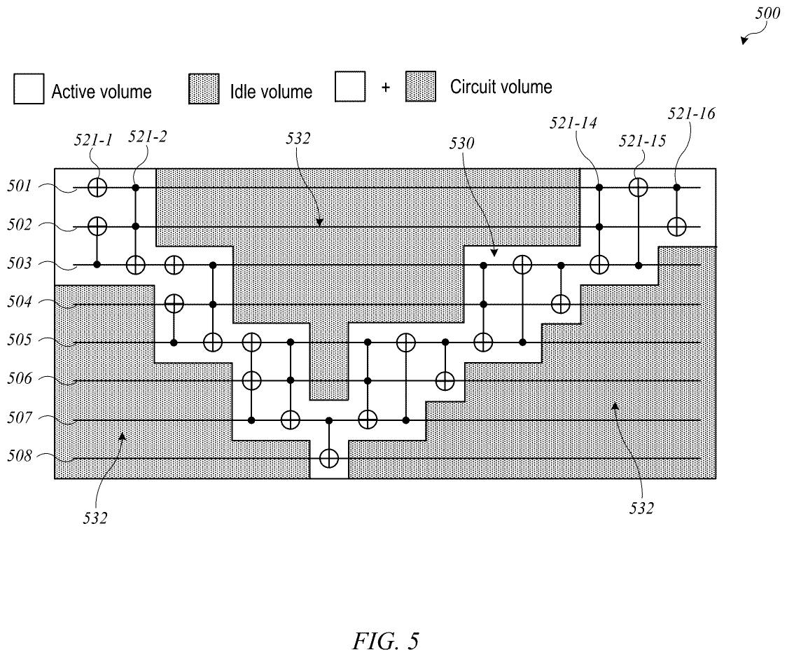

In fault-tolerant quantum computing, maintaining idle qubits can consume significant resources. By way of illustration, FIG. 5 shows schematic diagram of a quantum circuit 500 having eight qubits 501-508 (sometimes referred to as “memory” qubits, represented as horizontal lines) to which a series of T gates 521-1 through 521-16 are applied. In some embodiments, qubits 501-508 can be implemented as logical qubits and gates 521-1 through 521-16 can be implemented as logical gate operations as described above in reference to FIGS. 1-4. As shown, not all qubits actively participate in any one gate; some of the qubits are idle. For instance, qubits 501 and 502 are idle from gate 521-2 until gate 521-14. In fault-tolerant quantum computers, qubits 501-508 are logical qubits (e.g., implemented using surface code patches as described above), and hardware or storage resources may be used to maintain the information content of the idle (logical) qubits while gate operations are being performed on other logical qubits. For example, an identity gate as described above can be applied to each idle qubit. In typical fault-tolerant quantum computer architectures, the identity gate involves the same number of physical qubits and measurements as any other gate. Thus, the cost (a measure of resource requirements) for a fault-tolerant quantum computation scales roughly with the circuit volume, where the “circuit volume” is defined as the number of memory qubits multiplied by the number of non-Clifford gates (e.g., T gates and/or Toffoli gates). A computation that uses a number n_{Q} of memory qubits and includes a number n_{T} of non-Clifford gates has a circuit volume of n_{Q}×N_{T}.

The circuit volume of a quantum circuit can be divided into an “active volume” and an “idle volume.” The “active volume” is the portion of the circuit volume that corresponds to logical operations that progress the computation, including both Clifford and non-Clifford gates, while the “idle volume” is the portion of the circuit volume that corresponds to idle qubits. By way of illustration, the active volume 530 for circuit 500 of FIG. 5 is shown with light (cream) shading while the idle volume 532 is shown with dark (red) shading. The circuit volume is the sum of the active volume and the idle volume. As FIG. 5 suggests, the active volume can be significantly smaller than the circuit volume. The difference between circuit volume and active volume becomes more pronounced for quantum computers with more (logical) qubits. For example, the active volume of a 10,000-qubit quantum computation consisting primarily of adders is more than 100 times lower than the circuit volume.

Certain embodiments described herein relate to fault-tolerant quantum computer architectures (and implementations thereof) in which computational cost (as measured by spacetime volume) scales with the active volume rather than the circuit volume. For instance, in some embodiments, the computational cost of executing a given quantum circuit can be roughly twice the active volume of the circuit. Such architectures are referred to herein as “active volume architectures,” and a quantum computer that implements an active volume architecture is referred to as an “active volume quantum computer.” This section describes components and characteristics of active volume architectures and active volume quantum computers. Some examples of active volume quantum computers are described, e.g., in US Pat. App. No. 20240169239.

### Components of Active Volume Quantum Computer

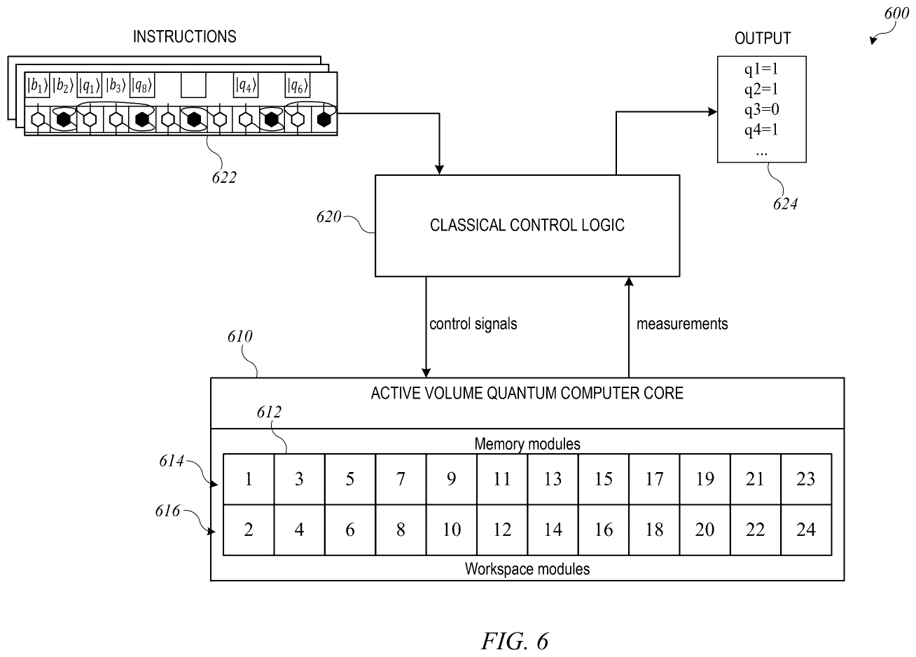

FIG. 6 shows a simplified block diagram of an active volume quantum computer system 600 according to some embodiments. System 600 includes an active volume quantum computer core 610 coupled to classical control logic 620.

Classical control logic 620 can be implemented as a digital logic circuit with an arrangement of classical logic gates (AND, OR, NOR, XOR, NAND, NOT, etc.), such as a field programmable gate array (FPGA) or system-on-a-chip (SOC) having a programmable processor and memory, or an on-chip hard-wired circuit, such as an application specific integrated circuit (ASIC). In some embodiments, classical control logic 620 (or portions thereof) can be implemented in an off-chip classical computer having a processor and a memory, and the off-chip classical computer can be programmed to perform some or all of the operations of classical control logic 620. Classical control logic 620 can be coupled to quantum computer core 610 to exchange classical control signals to control operations of core 610 and classical measurement data extracted from core 610.

In operation, classical control logic 620 (which can include a classical computer) can receive instructions 622 specifying a quantum computation to be executed. For example, instructions 622 can include a (classical) machine-readable data file defining a sequence of logical block networks and quickswap operations as described below, a fusion graph as described above, or other instructions defining operations to be performed in core 610. Classical control logic 620 can read the program code and generate control signals to cause quantum computer core 610 to perform the computation. The nature of the control signals depends on the particular implementation of core 610; examples are described below.

Quantum computer core 610 can include hardware components and devices that create and/or manipulate physical qubits to perform fault-tolerant logical operations on logical qubits. In operation, core 610 can execute operations in response to control signals from classical control logic 620 and return classical measurement data to classical control logic 620. Example structures for core 610 are described below.

As quantum computer core 610 returns measurement data (which can be classical binary digital data), classical control logic 620 can apply various analysis algorithms (including, e.g., decoder algorithms as described above) to the measurement data to determine results of the quantum computation. Classical control logic 620 can output data 624, which can include, e.g., final states of logical qubits and/or other information. In some embodiments, classical control logic 620 can use the results of analysis algorithms to select subsequent instructions 622 to issue to core 610. The term “reactive measurement” as used herein refers generally to a situation where a result of executing a first instruction is used to determine all or part of a subsequent instruction, and the “reaction time” (τᵣ) refers to the minimum time between completion of the first instruction and completion of the subsequent instruction. The reaction time can include time consumed in decoding measurement data output from the first instruction in order to determine which subsequent instruction should be issued. In general, the reaction time for a given implementation of system 600 depends in part on the implementation of core 610 and in part on the implementation of classical control logic 620.

Quantum computer core 610 can include a number (N) of interconnected qubit modules 612. In the example shown in FIG. 6, N=24. It should be understood that the architecture of core 610 is scalable and that N can be any number; for instance, N can be ~100, ~1,000 or ~10,000. Qubit modules 612 can be physically or conceptually divided into “memory” modules (shown as row 614 in core 610) and “workspace” modules (shown as row 616 in core 610). In embodiments where the total number N of qubit modules is even, the number of memory modules and the number of workspace modules can each be N/2. As will become apparent, this division can facilitate defining instructions for core 610. In particular, workspace modules 616 can be used to execute logical operations, while memory modules 614 can be used to store logical qubits and to rearrange logical qubits for use in subsequent operations. Despite the different roles of memory and workspace modules, there need not be any difference in physical structure or circuit design between memory and workspace modules. For convenience of identification, each module can be assigned an identifying index (or label) in the range from 1 to N. In examples herein, memory modules have odd indexes and workspace modules have even indexes. In the following description, “M1” refers to the module with index 1, and so on. (In the drawings, “M” is sometimes omitted.)

Each qubit module 612 can include hardware components (e.g., optical circuitry, electronic circuitry, engineered structures, or the like) to generate a surface code patch by operating on physical qubits. In some embodiments, the hardware components include circuitry or other devices to generate, receive, and/or store physical qubits and to perform surface-code check operator measurements, which can include twists and dislocations in at least one direction, on the physical qubits. The particular hardware components depend on the type and implementation of the physical qubits. Each surface code patch can have dimensions d×d, where dis a code distance as described above. In some embodiments, the value of d may be fixed for a given hardware implementation of qubit modules 612. Depending on implementation, different qubit modules 612 can operate concurrently (or in parallel) with each other or sequentially. Regardless of implementation, a “code cycle” for a given qubit module 612 as used herein refers to the time to generate one d×d surface code patch (e.g., the time to perform a full set of check operator measurements). At any given time, a given qubit module may be said to be empty (i.e., not storing any logical information used in the quantum computation but possibly storing random or other non-useful qubit states), storing a logical qubit in an idle state, or operating on a logical qubit (e.g., actively generating a surface code patch that encodes the state of a fault-tolerant logical qubit), or storing or operating on ancilla (e.g., actively generating surface code patches that can be used in operations on logical qubits).

As described above, surface codes can be defined in a three-dimensional entanglement space, with directions referred to for convenience as E, W, N, S, U, and D. For purposes of the present description, each d×d surface code patch is defined as being in the plane transverse to the U-D axis and has distinct E, W, N, and S boundaries. Surface code patches in different qubit modules 612 can be selectively coupled using boundary-to-boundary couplings of E, W, N, or S boundaries as well as transversal couplings in the U-D direction. In some embodiments, boundary-to-boundary couplings between modules can be implemented through the coupling of physical qubits on the edge of a patch within one module (e.g., the physical qubits that reside on an E boundary) with respective physical qubits on an edge of a patch within another module. In some embodiments, transversal couplings can be implemented through coupling each physical qubit in a patch within one module with the respective physical qubits in a patch within another module. Examples of connection networks for active volume architectures are described below.

Qubit modules 612 also support initialization of logical qubits. In some embodiments, any qubit module 612 can initialize a (logical) qubit in either the |├0) state (Pauli Z basis) or |├) state (Pauli X basis) in one code cycle. Initializing a logical qubit generally includes establishing the underlying physical qubits of the surface code patch in appropriate states (which may depend on the choice of Z or X basis).

In addition, any qubit module 612 can complete a measurement of a (logical) qubit in either the Pauli X basis or Pauli Z basis in one code cycle. Measuring a logical qubit generally includes performing a single-qubit measurement on each physical qubit of the surface code patch (in the appropriate basis) and providing the measurement outcomes to classical control logic 620. Thereafter, classical control logic 620 can decode the measurement data and extract a measured state (0 or 1) of the logical qubit.

Qubit modules 612 in active volume core 610 are advantageously interconnected to form a network in which a given qubit module 612 is directly connected to multiple other qubit modules 612, including qubit modules that are not physically adjacent. These interconnections can enable couplings of corresponding boundaries (e.g., couplings of boundaries oriented in the same direction in entanglement space, such as E to E, W to W, N to N, S to S, U to U, D to D) of surface code patches in different qubit modules 612 as well as transversal couplings of U and D surfaces of surface code patches in different qubit modules 612. In some embodiments, two types of connection networks can be provided, referred to herein as “port” connections and “quickswap” connections.

In some embodiments, port connections couple each pair of qubit modules 612 with index values i and j for which 1≤|i−j|≤r, where r is a range parameter that can be selected to provide a desired degree of connectivity. A pair of qubit modules with index values i and j is referred to as being “in range” if |i−j|≤r. As will be shown below, r=12 is sufficient to implement the most commonly used quantum algorithms in a resource-efficient manner.

However, other values can be chosen. For instance, r can be 6 or 24 or some other value. When qubit modules 612 are arranged in a two-dimensional grid, r>3 or r>4 may involve port connections between pairs of qubit modules that are not physically adjacent.

To summarize the foregoing, some embodiments of an active volume quantum computer core have the following properties:
(1) A network of N qubit modules for some number N. Each qubit module can store a d×d surface-code patch encoding a logical qubit or a d×d ancilla patch that facilitates multi-patch operations. Each patch has boundaries, including lateral boundaries (N, E, S, and W) and transversal boundaries (U and D). It is not required that every qubit module store a surface code patch at all times during a computation; at some times, some qubit modules may be empty. In some embodiments, no physical qubits, measurements, or other resources are utilized to maintain a qubit module in the empty state. Pairs of qubit modules with indexes i and j are directly coupled to each other by port connections (and said to be “in range”) if |i−j|≤r and directly coupled to each other by quickswap connections (and said to be “quickswappable”) if |i−j|=2^{k}, where k is an integer between 0 and [log N].
(2) Operation of the qubit modules defines a unit of time referred to herein as a “code cycle,” which is the time to perform all standard surface-code check measurements within each qubit module, including boundary checks; twist defects, and lattice dislocations in at least one direction; single-qubit measurements; and physical T gates for state injection. It should be noted that different qubit modules can operate in parallel or sequentially, and in some embodiments that use photons as qubits, the same hardware can be leveraged to provide multiple qubit modules.
(3) The surface code patches stored in a pair of qubit modules that are quickswappable can be swapped within one code cycle, e.g., using transversal physical SWAP gates or by physically moving qubits between modules. Quickswaps between disjoint pairs of qubit modules can be performed concurrently (i.e., in the same code cycle).
(4) A logical Bell state (|00 [symbol] +|11 [symbol] )/√2 encoded in two surface code patches can be prepared in any pair of empty qubit modules that are in range within one code cycle. In some embodiments, Bell state preparation is implemented by transversal physical Bell-state preparations between physical data qubits, e.g., via the preparation of |+ [symbol] states in one module and |0) states in the other, followed by transversal physical CNOT gates. While one of ordinary skill having the benefit of this disclosure will appreciate that any port connection can be used to support logical Bell state preparation within one logical cycle, in some embodiments, D-to-D port connections can support Bell state preparation within one code cycle.
(5) Surface-code checks can be measured between corresponding boundaries of the surface code patches of two qubit modules that are in range. In other words, lattice-surgery operations can be executed between any two surface-code patches within a range r. In examples described herein, corresponding boundaries are boundaries associated with the same direction, rather than opposite directions. (In some alternative embodiments, boundaries associated with opposite directions rather than the same direction can be coupled.)
(6) A logical Bell measurement can be performed (within one code cycle) between two logical qubits stored in a pair of qubit modules that are in range. Logical Bell measurement can be implemented using transversal physical Bell measurements between physical data qubits, i.e., transversal measurements of the two-qubit Pauli operators X⊗X and Z⊗Z, which can be completed within one code cycle. While one of ordinary skill having the benefit of this disclosure will appreciate that any port connection can be used to support logical Bell state measurement within one logical cycle, in some embodiments, U-to-U port connections can support logical Bell measurement within one code cycle.

Quantum computer cores having some or all of these properties can be implemented using a variety of physical systems and devices. Using photons as the physical qubits has the advantage that photons are inherently mobile; port and quickswap connections can be implemented using active optical switches and waveguides to transfer physical qubits between qubit modules. However, use of other physical systems and devices is not precluded.

All embodiments described herein are illustrative, and many modifications are possible. Photonic qubits can be implemented using dual-rail encodings as described above, other spatio-temporal encodings, polarization encodings, GKP qubit encoding, or any other encoding that provides the state behavior of a physical qubit. Further, while photonic qubits are particularly well suited for active volume architectures (due to the relative ease of implementing port and quickswap connection networks), active volume architectures are not limited to photonic qubits; any physical system that can be used as a qubit can be used to implement an active volume architecture, provided that an appropriate connection network implementing port and/or quickswap connections as described herein is constructed.

As described above, port connections are selectably operable to couple surface code patches generated in different qubit modules in a quantum computer, and quickswap connections are selectably operable to move logical qubits between qubit modules in a quantum computer. In some embodiments, port connections can be implemented without also implementing quickswap connections, and vice versa, while still providing at least some of the benefits described herein. For instance, in a quantum computer that implements port connections but not quickswap connections, the amount of surface code generated to perform a gate operation between logical qubits encoded in non-adjacent surface code patches can be reduced in the manner described above. Conversely, in a quantum computer that implements quickswap connections but not port connections, surface code patches encoding different logical qubits can be quickly rearranged in memory to position logical qubits involved in a gate operation closer together prior to executing the gate operation. Closer positioning reduces the amount of surface code generated during the operation, which can reduce computational cost.

The convention that the sub-connections of a port connection couple corresponding boundaries of surface code patches in different modules (E to E, N to N, W to W, S to S, U to U, D to D) is chosen for convenience of implementation in certain photonic systems. Along the U-D axis, the U to U and D to D port couplings enable generation and measurement of Bell states, as used for bridge qubits. In the networks of interleaving modules described above, a rule that all sub-connections couple corresponding boundaries can simplify design of the modules and connection paths. However, it is also possible to implement port connections such that sub-connections in directions transverse to the U-D axis are made between complementary boundaries (i.e., E to W, W to E, N to S, and S to N). Depending on the particular hardware used to generate surface code patches and establish port connections, providing complementary-boundary connections in the N-S and E-W directions may be more convenient than providing corresponding-boundary connections.

In examples above, quickswap connections are implemented using transversal physical SWAP gates. Depending on implementation, a quickswap operation is not limited to just two participating modules, and multi-way quickswaps may be supported, provided that the appropriate direct connections exist between the participating modules (e.g., in a three-way quickswap, module Mi can send its logical qubit to module Mj while module Mj sends its logical qubit to module Mk and module Mk sends its logical qubit to module Mi).

The use of directional labels (e.g., N, E, W, S, U, D) is for convenience of description and should be understood as referring to entanglement space, not as requiring or implying a particular physical arrangement of components or physical qubits. All numerical examples are for purposes of illustration and can be modified. In addition, while layers and patches are described with reference to square numbers, it should be understood that non-square layers and/or non-square patches can also be used. For example, patches or layers can be rectangular. Triangular patches or layers (or patches or layers having other shapes) can also be generated, e.g., by varying the number of resource states per row. Further, while examples described above assume that all instances of a resource state have the same entanglement pattern, such uniformity is not required. For instance, in some embodiments, resource states having different entanglement patterns can be provided to a particular RSIs at various times. In addition, there may be stochastic variation among resource states, e.g., due to the non-deterministic nature of resource state generation. To increase the probability of delivering a desired resource state to each RSI in a given RSI cycle, some embodiments can provide a number (R) of resource state generator circuits. If M is the total number of interleaving modules in a particular core, then R can be greater than M, and R can be chosen to provide a sufficiently high probability that at least M resource states will be generated during a given RSI cycle. (“Sufficiently high probability” in a given implementation can be determined based on the particular implementation of fault tolerance.) Active multiplexing techniques, examples of which are known in the art, can be used to select M of the R resource state generators on each clock cycle to deliver resource states to the resource state interconnects of the M interleaving modules.

Some embodiments described above provide examples of implementing active volume architectures using FBQC to implement the surface-code patches by providing resource states and performing appropriate measurements on qubits of different resource states. The particular size (number of qubits) and entanglement pattern of the resource states can be varied as appropriate for a particular use case. In addition or instead, the number of resource states and entanglement geometry between resource states can be varied according to the particular use-case. In addition, embodiments are not limited to FBQC, and active volume architectures may be implemented using other techniques for generating and operating on logical qubits, including other surface-code-based techniques.

Further, while examples herein refer to surface codes, those skilled in the art with the benefit of this disclosure will appreciate that surface codes are one category of topological codes that can be used to provide quantum error correction by defining and operating on logical qubits and that systems and methods described herein can be applied to any topological code, including surface codes, color codes, and so on. The particular stabilizers implemented are a matter of design choice.

Further, embodiments described above include references to specific materials and structures (e.g., optical fibers), but other materials and structures capable of producing, propagating, and operating on photons can be substituted. As noted above, resource states can be generated using photonic circuits, or a resource state can be created using matter-based qubits, after which an appropriate transducer technology can be applied to swap the state of the matter-based qubits onto a photonic state. Interleaving as described herein exploits the propagation of photonic qubits, and similar techniques may be applicable to systems of physical qubits that are realized using entities that propagate along well-defined hardware paths. Classical control logic can be implemented on-chip with the waveguides, beam splitters, detectors and/or and other photonic circuit components or off-chip as desired.

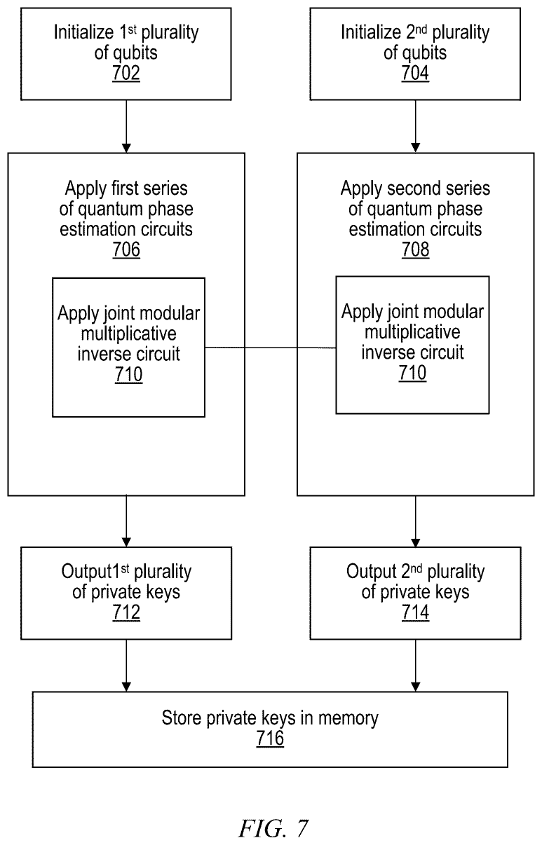

### FIG. 7-Flowchart for Quantum Decryption

FIG. 7 is a flowchart diagram illustrating a method for performing quantum decryption using a joint modular multiplicative inverse operation, according to some embodiments. In some implementations, one or more process operations of FIG. 7 may be performed by devices including a classical processor and a quantum information processing system. In some embodiments, the quantum information processing system implements an active volume quantum computing architecture.

The method shown in FIG. 7 may be used in conjunction with any of the computer systems or devices shown in the above Figures, among other devices. For example, the method shown in FIG. 7 may be performed by a quantum or classical/quantum hybrid computing device or system 101 as illustrated in FIG. 1. In some embodiments, the described quantum circuit may be implemented in any of a variety of types of quantum computing systems, including but not limited to photonic, semiconductor, superconducting and/or topological quantum computing systems. The quantum computing system may be configured to direct the described method steps, and may include (or be coupled to) a classical computer system 103 for processing classic information and directing operations of the quantum computing device. It is to be understood this method may be used by any of a variety of types of quantum computing architectures, and these other types of systems should be considered within the scope of the embodiments described herein. In various embodiments, some of the method elements shown may be performed concurrently, in a different order than shown, or may be omitted. Additional method elements may also be performed as desired. As shown, this method may operate as follows.

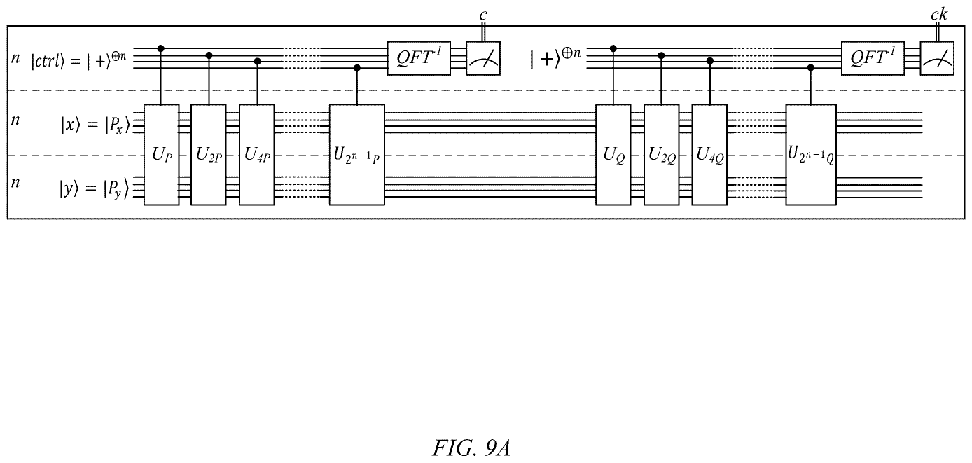

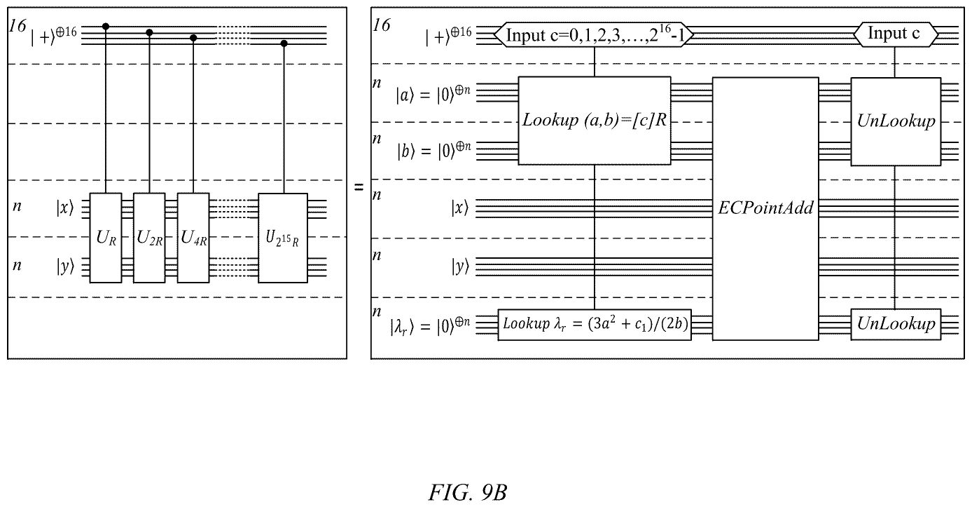

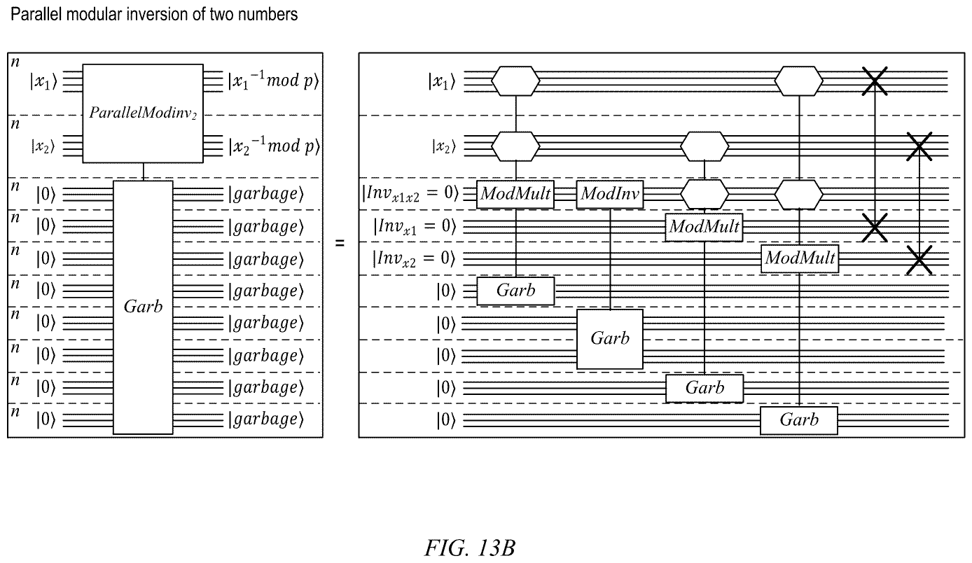

At 702, a first plurality of qubits is prepared in an initial state. The first plurality of qubits may be prepared in respective states to serve as the control (|ctrl)), x and y qubits shown in FIGS. 9A and 13A. The first plurality of qubits may also include additional register qubits used in the computation, which may be prepared into null states, for example. In some embodiments, the first plurality of qubits are prepared in an initial state by a first device, and provided to a quantum computing system to perform the subsequent method steps.

At 706, the first plurality of qubits is provided to a first series of quantum phase estimation circuits. Examples of the first series of quantum phase estimation circuits are shown in FIGS. 9A and 13A. In the circuit shown in FIG. 13A, a first quantum phase estimation circuit in the series includes the operators {U_{P}, U_{2P}, . . . , U₂ⁿ_{P}} which prepare a state |ψc), an inverse quantum Fourier transform, and a classical measurement of c. Advantageously, a single calculation of c is used to calculate a plurality of private keys k_{1 . . . m}, reducing the computational overhead by a factor that approaches 2 asymptotically for large values of m. Here c is an integer and n is a total number of bits of each private key. The operators {V_{Qj}, U_{2Qj}, . . . U_{2nQ}_{ⱼ}} which prepare a plurality of respective states |ψ_{ckj} [symbol] for j={1, . . . , m}, combined with an inverse quantum Fourier transform and a measurement of ckⱼ, represent subsequent quantum phase estimation circuits in the series. Here m is a total number of private keys in the first plurality of private keys and kⱼ denotes the keys in the first plurality of private keys. Other series of QPE circuits are also possible. The QPE circuits in the series may include modular multiplicative inverse operations, and as described below, these operations may be made more efficient by performing them jointly between the first and second series of QPEs.

A first plurality of private keys is determined by applying the first series of quantum phase estimation circuits to the first plurality of qubits. The first plurality of private keys is determined using a first plurality of respective public keys and a base point P.

At 704, a second plurality of qubits is prepared in an initial state. The second plurality of qubits may be prepared in respective states to serve as a second set of the control (|ctrl)), x and y qubits shown in FIGS. 9A and 13A. The second plurality of qubits may also include additional register qubits used in the computation, which may be prepared into null states, for example.

At 708, the second plurality of qubits is provided to a second series of quantum phase estimation circuits. The second series of quantum phase estimation circuits may be a second instance of the first series of quantum phase estimation circuits, i.e., the second series of QPE circuits may also take the form shown in FIG. 9A or 13A. A second plurality of private keys is determined by applying the second series of quantum phase estimation circuits to the second plurality of qubits.

The second plurality of private keys is determined using a second plurality of respective public keys and the same base point P used to determine the first plurality of private keys. The first and second pluralities of private keys may be encrypted with elliptic curve cryptography (ECC).

In some embodiments, the first and second series of quantum phase estimation circuits are applied in parallel.

In some embodiments, the first and second series of QPE circuits include respective subroutines to determine a value of a parameter λᵣ when a first elliptic curve point P₁ is equal to a second elliptic curve point P₂. For example, Equation (2) below illustrates how the parameter λᵣ may be determined, and FIG. 9B illustrates an example quantum circuit diagram to determine λᵣ.

At 710 a joint modular multiplicative inverse circuit is applied to a first qubit of the first plurality of qubits and a second qubit of the second plurality of qubits. The joint modular multiplicative inverse circuit calculates a modular multiplicative inverse of a modular product of a first value of the first qubit and a second value of the second qubit. While the first and second series of quantum phase estimation circuits generally operate on only the first and second pluralities of qubits, respectively, the joint modular multiplicative inverse circuit jointly operates on at least one qubit from each of the first and second pluralities of qubits. The modular multiplicative inverse operation may utilize a relatively large quantity of computational resources compared to other subroutines in the QPE circuits (e.g., compared to modular multiplication).

The joint modular multiplicative inverse circuit replaces two modular multiplicative inverse operations (one for each of the two series of QPE circuits) with a single joint modular multiplicative inverse that includes one modular multiplicative inverse operation and three modular multiplication operations, as shown in FIG. 13B. Said more explicitly, the joint modular multiplicative inverse circuit may involve performing a modular multiplication of the first value and the second value, performing a modular multiplication of the first value and the modular multiplicative inverse of the product of the first and second values to obtain a modular multiplicative inverse of the second value, and performing a modular multiplication of the second value and the modular multiplicative inverse of the product of the first and second values to obtain a modular multiplicative inverse of the first value. As illustrated in Table 3, for both Toffoli count and active volume architectures, an n-qubit modular multiplicative inverse utilizes over 10 times as many computational resources as an n-qubit modular multiplication. Accordingly, replacing two modular multiplicative inverse operations with one modular multiplicative inverse operation and three modular multiplications results in a significant reduction in computational resources.

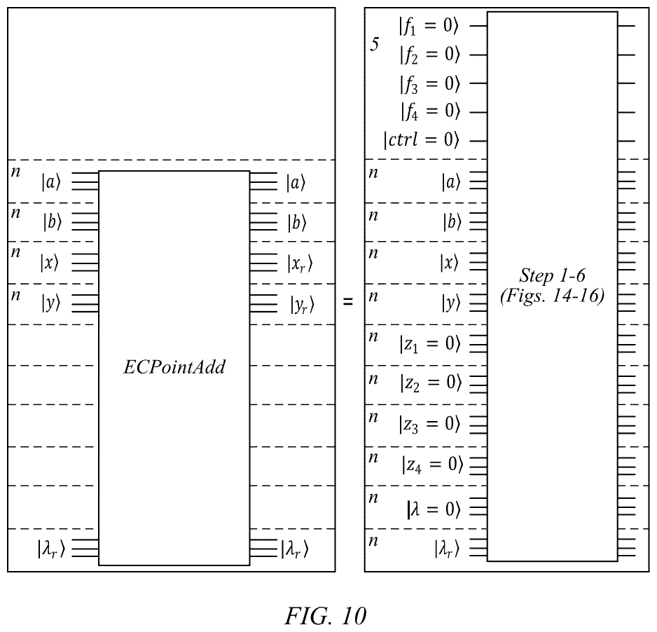

The joint modular multiplicative inverse operation may be used to replace two separate modular multiplicative inverse operations in each of a plurality of subroutines of the first and second series of QPE circuits. For example, in the exemplary series of QPE circuits shown in FIGS. 9A and 13A, each of the operations U₂^{N}_{P}, U₂ⁿ_{Q} and U₂ⁿ_{Qk} contain four instances of the modular multiplicative inverse operation, as described in the details of these circuits, e.g., as shown and discussed in reference to FIGS. 10, 14B and 16A-B. One or more (and potentially all) of these modular multiplicative inverse operations may be replaced by a joint modular multiplicative inverse operation between the first and second series of quantum phase estimation circuits 706 and 708, to reduce the overall computational overhead.

In some embodiments, the first and second series of quantum phase estimation circuits and the joint modular multiplicative inverse circuit utilize an active-volume quantum computing architecture. Advantageously, resource estimates for active-volume architectures may not scale with the number of qubits utilized, so that the additional qubits involved in performing the joint modular multiplicative inverse (relative to performing two separate single modular multiplicative inverses) may not adversely affect the overall resource cost.

At 712 and 714, the first and second pluralities of private keys are determined. In some embodiments, the first and second series of QPE circuits are configured to determine the private keys exactly. Example circuits that perform classical measurements to determine the private key k and the private keys km are shown in FIGS. 9A and 13A, respectively. As illustrated, the constants c and ckm are determined from classical measurements, and km may be determined by dividing these values.

In some embodiments, the first and second series of QPE circuits determine approximations of the first and second pluralities of private keys, respectively. In these embodiments, the exact private keys may then be determined using utilizing a brute force (classical computing) decryption method using the approximate private keys. For example, if 240 bits of a 256 bit private key are determined with the series of QPE circuits, the remaining 16 bits of the private key may be determined by checking each of the 2¹⁶ possibilities with a classical computer to determine the exact private key that fits the respective public key. The fraction of the total number of bits in the private key that is determined exactly using quantum decryption may be adjusted based on the computational power of both the quantum computer and the classical computer. For example, the number of bits of the private keys that are determined with brute force classical computing may be adjusted to reduce or minimize the overall run-time of the quantum-plus-classical computation.

At 716 the private keys are stored in a (classical) non-transitory computer-readable memory medium.

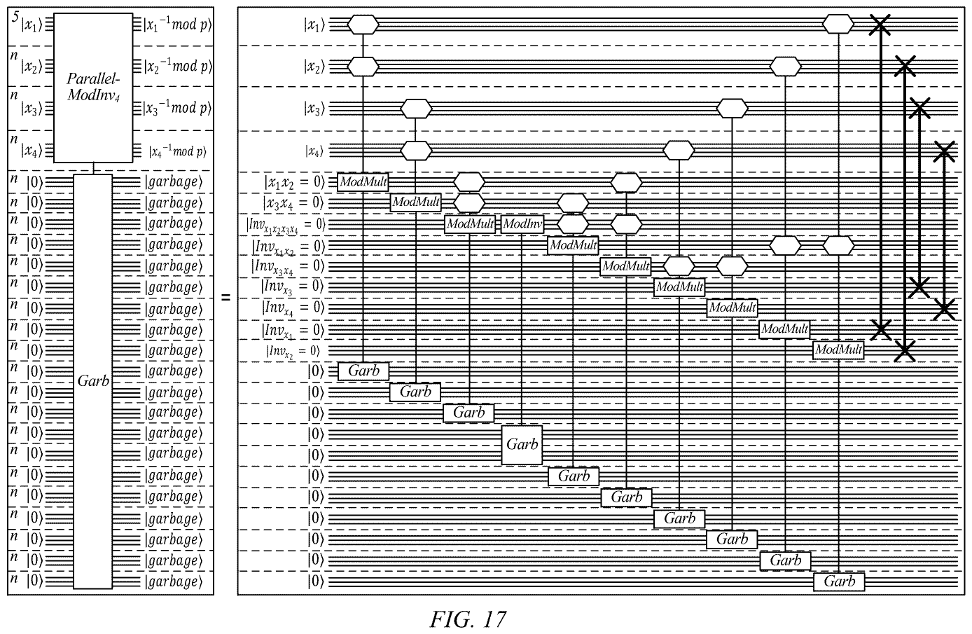

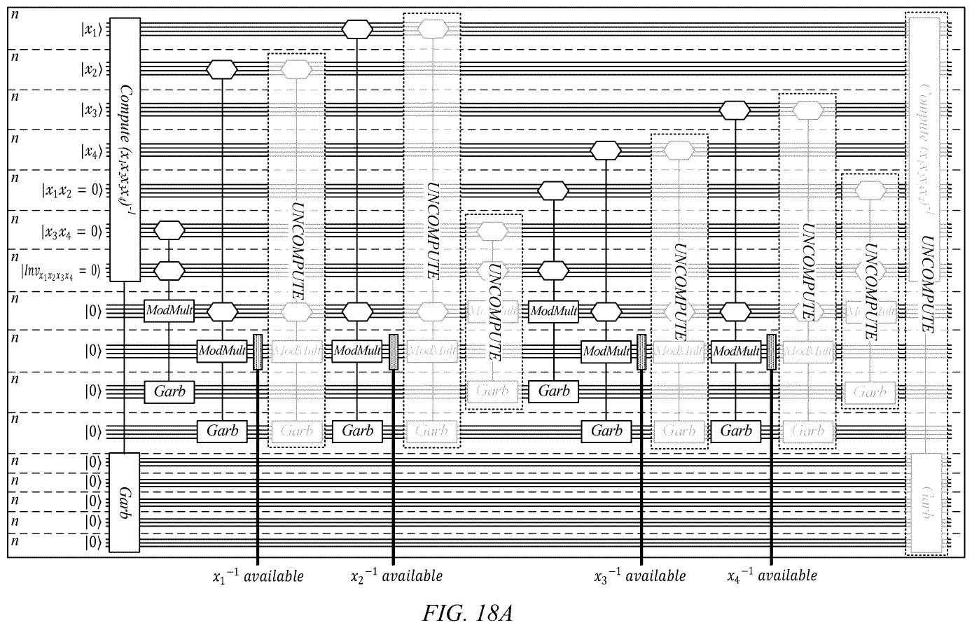

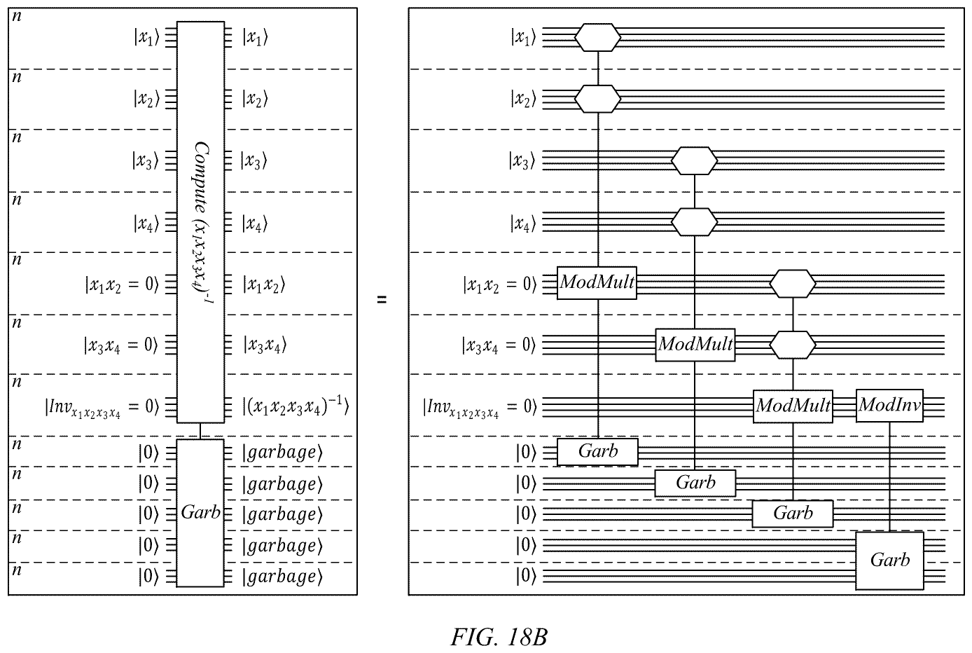

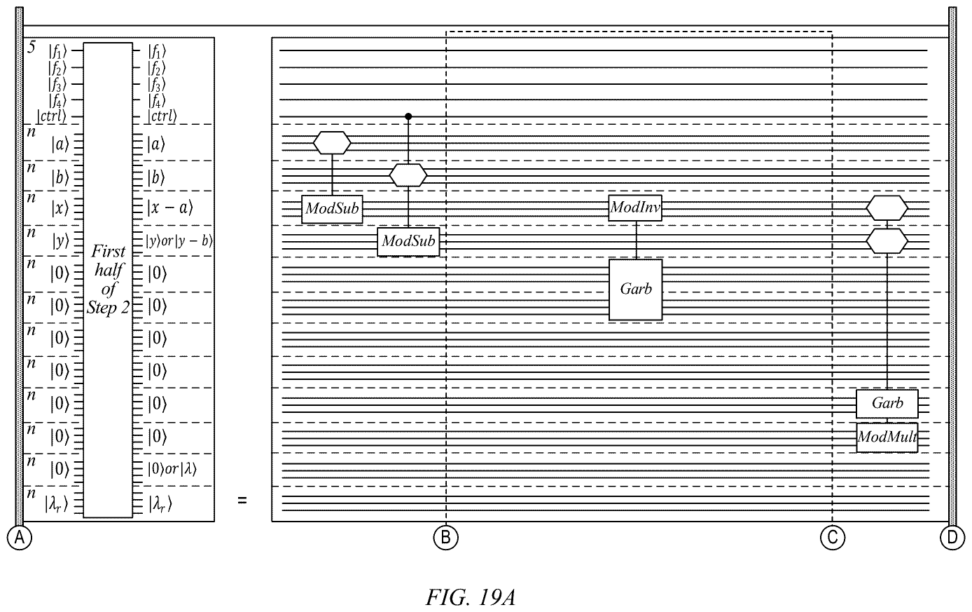

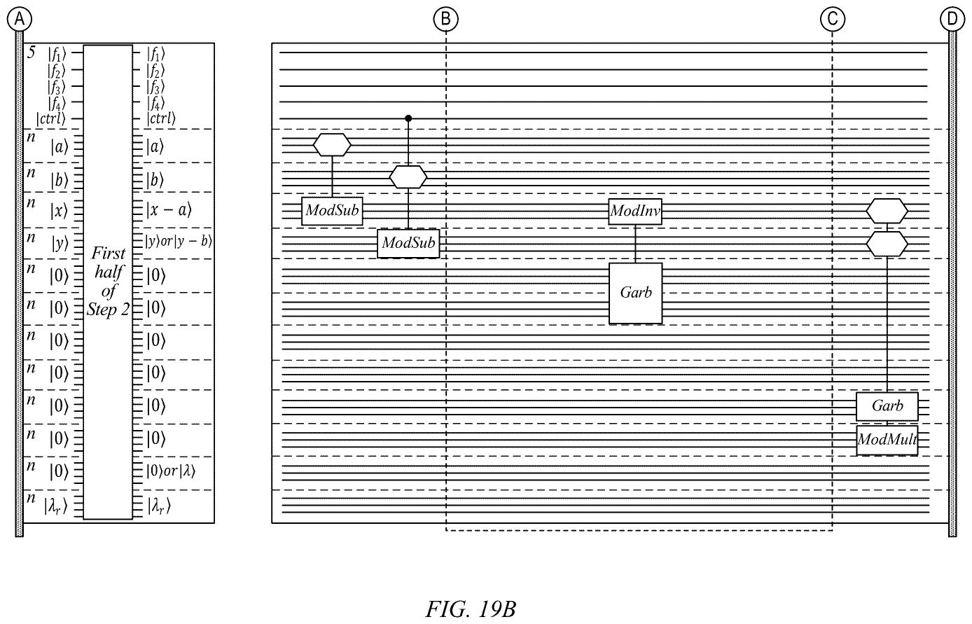

Note that FIG. 7 illustrates the case of implementing a joint modular multiplicative inverse circuit on two parallel QPE processes. More generally, a joint modular multiplicative inverse circuit may be applied to any larger number of 2ⁿ parallel QPE processes. For example, FIGS. 17 and 18A-B illustrate two alternative joint modular multiplicative inverse circuits that jointly perform a modular multiplicative inverse operation on four numbers, which may be used to determine four separate pluralities of private keys. In other words, the methods described in FIG. 7 that determine first and second pluralities of private keys may be generalized to determine 2ⁿ different sets of private keys, for any positive integer value of n.

In accordance with some example embodiments, a blockchain network that implements elliptic curve keys can be managed using the approaches discussed herein to identify private keys that correspond to respective public keys. For example, fraudulent transactions performed on the given blockchain (e.g., private blockchain network based on elliptic curve key pairs) can be corrected by identifying a private key of a malicious entity to reverse the fraudulent transaction via the quantum information processing system implementing the approaches discussed herein.

### Additional Description

The following numbered paragraphs provide additional technical detail and description regarding embodiments herein, discuss the inner workings of the described methods, and develop expressions for the computational complexity of the computations, in various embodiments.

One or more embodiments relate to systems and methods for using Shor's algorithm for the computation of elliptic curve private keys and methods and systems to determine resource estimates for using Shor's algorithm for the computation of elliptic curve private keys in a silicon-photonics-inspired active-volume architecture. In some embodiments, a fault-tolerant surface-code quantum computer includes modules with a logarithmic number of non-local inter-module connections, modifying the algorithmic cost function compared to 2D-local architectures. In some embodiments the non-local connections reduce the cost per key by a factor of 300-700 depending on the operating regime. At 10% threshold, assuming a 10-μs code cycle and non-local connections, one key can be generated every 10 minutes using 6000 modules with 1152 physical qubits each. By contrast, a device with strict 2D-local connectivity utilizes more qubits and produces one key every 38 hours. Some embodiments include architecture-independent algorithmic modifications that reduce the Toffoli count per key by up to a factor of 5. These modifications involve reusing the stored state for multiple keys and spreading the cost of the modular division operation over multiple parallel instances of the algorithm.

In a 2D local connectivity architecture, the quantum computer is a 2D grid of physical qubits, where physical two-qubit gates are supported only between nearest neighbors. In contrast, an active volume architecture with logarithmic non-local connections partitions physical qubits into N modules, where each module includes physical qubits in a 2D grid with nearest-neighbor two-qubit gates supported within the module. Each module is further connected to O(log N) other modules, and physical transversal two-qubit measurements are supported between pairs of connected modules.

In a 2D local connectivity scheme using superconducting qubits with a 1 μs code cycle and 9.4 million physical qubits (6000 logical qubits), a 256-bit key may be decrypted in 3.8 hours. In a 2D local connectivity scheme using trapped ion qubits with a 1 ms code cycle and 9.4 million physical qubits (6000 logical qubits), a 256-bit key may be decrypted in 160 days.

In a logarithmic non-local active volume scheme using superconducting qubits with a 1 us code cycle and 6.9 million physical qubits divided into 6000 modules with 1152 qubits each, a 256-bit key may be decrypted in 58 seconds and four 256-bit keys may be decrypted in parallel after 8.3 seconds per key. In a logarithmic non-local active volume scheme using photonic fusion-based quantum computing with 6-ring resource state generators (RSGs) with {1 μs, 10 μs, 100 μs, 1 ms} delays and 6000 interleaving modules, a 256-bit key may be decrypted in {58 seconds, 9.7 minutes, 1.6 hours, 16 hours}, and four 256-bit keys may be decrypted in parallel after {8.3 seconds, 1.4 minutes, 14 minutes, 2.3 hours}, per key. In a logarithmic non-local active volume scheme using trapped ion qubits with a 1 ms code cycle and 6.9 million physical qubits divided into 6000 modules with 1152 qubits each, a 256-bit key may be decrypted in 16 hours and four 256-bit keys may be decrypted in parallel after 2.3 seconds per key. Advantageously, embodiments herein that utilize active volume architectures for quantum decryption provide significant speed-up to decrypt private keys.

Note that, for photonic fusion-based quantum computing, longer delays are strictly beneficial in an active-volume architecture with logarithmic non-local connections. Doubling the delay length doubles the memory provided by each RSG, and also doubles the code cycle, but compensates this slowdown by doubling the number of logical operations that are executed in parallel. The additional memory can be used to reduce the cost per key through the cheaper modular inverse operation described herein, and the longer code cycles help avoid the reaction limit.

Currently, the most widely adopted asymmetric cryptography schemes are RSA and elliptic curve cryptography (ECC). The NIST-recommended minimum key size for RSA is 2048 bits, whereas only 256 bits are recommended for ECC. This choice is motivated by the resilience of ECC keys against classical-computing-based attacks. However, both cryptosystems are susceptible to the potential threat of quantum computing. In this regard, the smaller key size of ECC keys renders them more vulnerable to quantum computers, as substantiated by lower gate counts observed in the existing literature. Consequently, it is reasonable to anticipate that 256-bit ECC will be the first widely used cryptosystem compromised by quantum computing.

What size should a quantum computer be to break 256-bit ECC keys, and how much time does it take per key? The problem size surpasses the capability of quantum computers without error correction, necessitating fault-tolerant quantum computing (FTQC). We focus on resource estimates for surface-code-based FTQC, where logical qubits are encoded as surface-code patches including hundreds or thousands of physical qubits. There exist two types of general-purpose architectures for surface codes: baseline architectures with nearest-neighbor logical two-qubit operations on a 2D grid, and active-volume architecture utilizing a logarithmic number of non-local connections between patches. Embodiments incorporating active volume architecture are described in further detail herein in reference to FIGS. 5-6. An FTQC employing an active-volume architecture leverages non-local connections to parallelize the execution of logical operations, resulting in a significant speedup compared to a fault-tolerant quantum computer with the same footprint, but strict 2D-local connectivity.

Different architectures. The existing literature on FTQC resource estimates primarily focuses on baseline architectures, relying on determining logical qubit counts (no) and Toffoli gate counts (N_{Tof}) due to the relevance of the cost function n_{Q}·N_{Tof}. Resource estimates for active-volume architectures are different, albeit not more complicated. Instead of counting qubits and gates, different fundamental subroutines are counted based on their specific costs, known as the active volume. The following description provides a simplified active-volume resource estimation procedure using an ECC decryption method, in accordance with some embodiments. In some embodiments, architecture-independent gate counts are improved and optimization techniques are tailored for active-volume architectures.

The time scale of surface-code quantum computers is defined by the code cycle length t_{C}. The code distance d determines the logical qubit size as d² physical data qubits and logical cycle duration as t_{L}=d·t_{C}. In baseline architectures, a quantum computer with the capacity to execute n_{Q}-qubit computations include 2n_{Q} logical qubits. Gates are executed sequentially, with one T gate per logical cycle or one Toffoli gate per four logical cycles. In an active-volume architecture, a quantum computer includes modules with d² physical data qubits. Each module either operates as a memory or workspace module. Memory modules increase the memory capacity by one logical qubit, while workspace modules enhance computational speed by one block per logical cycle. Subroutine costs are measured in blocks. Non-local connections between modules enable parallelized logical operations. The number of blocks executed per logical cycle equals the number of workspace qubits. The assignment of memory and workspace qubits can be changed dynamically during runtime, e.g., as described in further detail herein in reference to FIGS. 5-6. For simplicity, our resource estimates assume an equal allocation of memory and workspace qubits, with n_{L} logical qubits resulting in n_{L}/2 memory qubits and a speed of n_{L}/2 blocks per logical cycle. Active-volume resource estimates focus on counting the total number of blocks in a computation, i.e., the active volume.

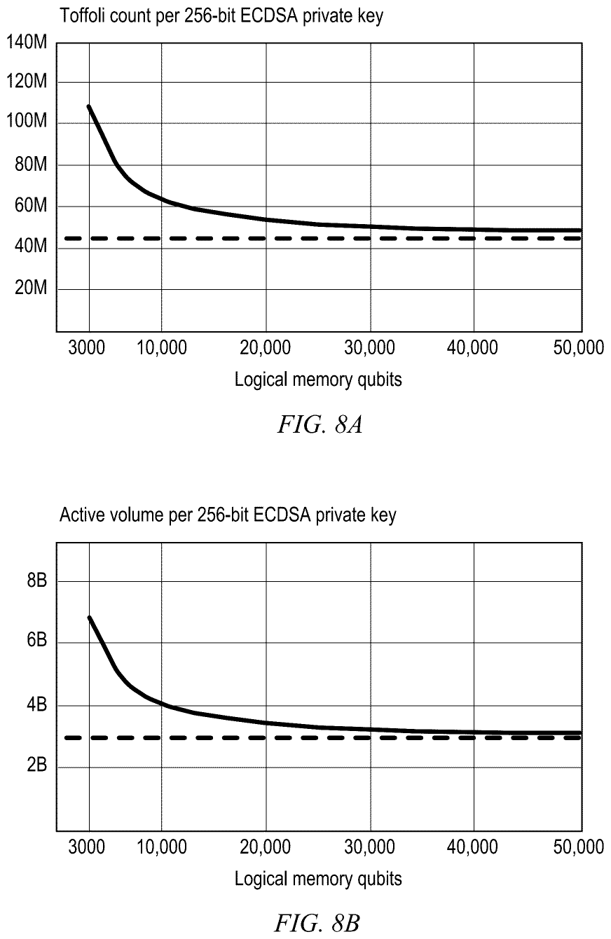

FIGS. 8A-B show Toffoli counts and active volume estimates for decrypting a 256-bit Elliptic Curve Digital Signature Algorithm (ECDSA) private key, according to some embodiments. Every instance of the algorithm uses 3000 logical memory qubits. With k instances running in parallel, the Toffoli count per key is (44+65/k) million, and the active volume per key is (2.8+3.8/k) billion blocks. In the baseline and active-volume architectures considered in this paper, the total number of logical qubits is twice the number of logical memory qubits. The orange lines show the asymptotic Toffoli count and active volume.

Different hardware. One or more embodiments herein relate to resource estimates for different hardware platforms, namely superconducting qubits, trapped ions, and photonic fusion-based quantum computers (FBQC). For superconducting qubits and trapped ions, we assume circuit-based quantum computers comprising collections of physical qubits executing single-qubit and two-qubit gates. We consider different code cycle lengths (1 μs for superconducting qubits and 1 ms for trapped ions) to account for the distinct physical time scales.

In contrast, FBQC need not be constructed as an array of physical qubits but rather can be constructed as a network of photonic chips that generate resource states. Resource-state generators (RSGs), responsible for generating specific multi-photon states, form the majority of the device footprint. Additional components for photon rerouting, measurement, and delay lines also contribute to the computation. Therefore, the physical size of the FBQC depends on the total RSG rate (f_{RSG}). Note that this rate is unrelated to the physical clock rate, as, e.g., either 350 RSGs clocked at 1 GHz or 6000 RSGs clocked at 58 MHz result in the same total RSG rate of 350 GHz.

While the ratio of logical qubits to physical qubits in circuit-based quantum computers is determined by the code distance, photonic FBQC allows for further flexibility captured by an additional parameter: the temporal length of the longest delay line (t_{d}). Delay lines are devices that store photons for a fixed amount of time. Photons produced by RSGs are only present for a small fraction of the total computation, with the longest-lived photons in the device surviving for t_{d} between the time they are generated and the time they are measured in a single-photon detector. The delay line length t_{d} does not limit the maximum duration of the computation, but sets the code cycle time as t_{C}=t_{d}.

The number of logical qubits (n_{L}) in an FBQC depends on the maximum number of resource states present simultaneously, which is the total RSG rate multiplied by t_{d}. As each logical qubit has a footprint of d² resource states in an example device based on 6-ring resource states, n_{L}=f_{RSG}·t_{d}/d². Longer delays increase the code cycle length and the number of logical qubits contributed by each RSG. The maximum usable delay line length is limited by the transmission loss rate. We consider delay line lengths from 1 μs to 1 ms to capture the interval between fast superconducting qubits and slow ion traps. Examples of physical instantiations of such delays are fiber delays that are 200 m (1 μs) or 2 km (10 μs) long, or free-space delays with mirrors separated by 300 meters and 100 reflections (100 μs) or 1000 reflections (1 ms). Other implementations are also possible.

Algorithmic modifications. We begin by breaking down the ECC algorithm into fundamental arithmetic subroutines. We introduce three modifications: (1) reusing the state computed in the first half of the algorithm to generate multiple keys by repeating the second half, reducing the cost by up to a factor of 2, (2) determining 48 of the 256 bits of the key through brute force search on a classical computer, slightly decreasing the cost, and (3) adapting for quantum computing, a classical computing technique cla for computing multiple modular multiplicative inverses using a single inversion and a few multiplications.

The dominant cost in the ECC algorithm is the computation of inverses. It is possible to compute the inverses of multiple numbers x₁, . . . , xₙ by first computing their product, then computing the inverse of the product (x₁, . . . xₙ)⁻¹ and finally obtaining the individual inverses xᵢ⁻¹ through multiplication. We can make use of this by running multiple instances of the ECC algorithm in parallel computing different private keys. When the different instances reach the point when they would compute an inverse, this method enables them to share resources and use a single inversion to compute the inverses with a reduced cost per instance. Asymptotically, this replaces the cost of modular inversion by the cost of three modular multiplications, which reduces the cost per key by up to a factor of around 2.5.

The resulting behavior is illustrated in FIGS. 8A-B, where the Toffoli count and active volume per key decrease with increased quantum computer memory. In a baseline architecture, this is not a favorable trade-off, as doubling the qubit count leads to a less than twofold decrease in the Toffoli count, resulting in an overall increase in the cost function n_{Q}·n_{Tof}. In contrast, active-volume architectures benefit from the reduced Toffoli count and active volume, making them more efficient in a better-than-linear manner with increased size.

Resource estimates. Resource estimates may be based on approximated Toffoli counts and active volumes of fundamental arithmetic subroutines and lookup tables, as shown in Table 1 below.

TABLE 1

| | Toffoli | Active |
|---|---|---|
| Subroutine | count | volume |
| n-qubit addition/subtraction | n | 60n |
| n-qubit controlled addition/subtraction | 2n | 100n |
| n-qubit (controlled) constant addition | n | 60n |
| n-qubit (controlled) comparison | n | 60n |
| n-qubit negation | n | 60n |
| n-controlled Toffoli | n | 50n |
| n-controlled SWAPs | n | 60n |
| QROM lookup of k b-bit numbers | k | k · (50 + 0.75b) |
| QROM unlookup of k numbers | 3 \sqrt{k} | 0.75k + 170 \sqrt{k} |

These estimates are derived with a slight overestimation of Toffoli counts and active volumes for simplicity. Additionally, we assume an overestimated qubit count by considering 3000 logical memory qubits per algorithm instance. The numbers assume a physical error rate at 10% of the surface-code threshold error rate, which is a common assumption in the literature. A more conservative assumption closer to 50% of the threshold could lead to a doubling of the code distance, resulting in a twofold increase in the computational time and a fourfold increase in the device footprint. Note that there are more optimistic estimates in the literature, considering shorter code cycles and lower-distance surface codes.

While a device with a baseline architecture with 6000 logical qubits and a 1 ms code cycle takes 160 days to generate a 256-bit key, in accordance with one or more embodiments, a device with an active-volume architecture can generate one key every 16 hours using 25% less footprint. Devices with shorter code cycles generate keys at a correspondingly faster rate and attain the same 240-fold speedup due to non-local connections. The source of the footprint reduction is a distance reduction from d=28 to d=24 due to the reduced volume of the computation. The speedup is primarily derived from the parallel execution of Toffoli gates. While the baseline architecture executes one Toffoli gate every four logical cycles, the 3000 workspace qubits in the active volume architecture execute around 50 Toffoli gates in every logical cycle, if these Toffoli gates are part of arithmetic circuits.

In some embodiments, the active-volume architecture can benefit from the cheaper inversion operation. With a 10 μs code cycle, a device with 6000 logical qubit modules can generate one key every 9.7 minutes. A device with four times the footprint that generates four keys in parallel can generate one key every 1.4 minutes, i.e., almost 7 times faster, resulting in an overall spacetime volume reduction. More precisely, the device generates four keys simultaneously in 5.6-minute bursts. Photonic implementations of active-volume architectures benefit greatly from longer delay lines, as this increases the number of logical qubits that each RSG provides, which in turn unlocks active-volume reductions reducing the cost per key. With long delay lines, even a device with a relatively small footprint can compute keys at an acceptable rate.

The minimum duration of a fault-tolerant quantum computation is set by the reaction depth multiplied by the reaction time, a physical time scale related to classical processing and communication. A standard assumption in the literature is 10 μs, but this is not a physical limit, and improvements are possible. Further details related to optimizing the reaction depth are provided below. The reaction limit is particularly important for superconducting qubits with short code cycles or high-footprint photonic devices with short delay lines.

### Subroutine Breakdown

In this section, we decompose the ECC algorithm into the fundamental subroutines shown in Table 1, above, and perform a Toffoli count and active volume estimate. Note that estimates for n-qubit adders, Toffolis, SWAPs and QROM lookups may be used to derive the remaining entries in Table 1. For example, subtraction can be performed by flipping all bits of the minuend performing an addition with the input carry set to 1, comparison can be performed using a subtraction, and negation can be performed by flipping all bits followed by an increment operation. The UnLookup refers to the uncomputation of a lookup table using controlled SWAPs and a smaller lookup table. We will apply the cost estimate for the n-controlled Toffolis to Toffoli gates with n controls as well as groups of n standard 2-controlled Toffoli gates.

Elliptic curve keys. The overall goal of the quantum algorithm is to determine a private key k using the public key Q as an input. In elliptic curve cryptography, a cryptographic scheme is defined via an elliptic curve

$${y}^{2} = {x}^{3} + {c}_{1} x + {c}_{2} \qquad ( 1 )$$

with curve parameters c₁ and c₂, as well as a (typically prime) modulus p and a base point P=(Pₓ, P_{y}). Points on this curve are pairs of integer coordinates modulo p. A key pair can be created by generating a random integer 0≤k≤r−1, where r is the order of the curve defined below, as the private key and computing Q=[k]P as the public key via elliptic curve point multiplication. Given two elliptic curve points P₁=(a, b) and P₂=(x, y), the addition operation P₃=P₁+P₂=(xᵣ, yᵣ) is defined as:

$$( {x}_{r} , {y}_{r} ) = \{ \begin{matrix}∅ & if {P}_{1} = - {P}_{2} , \\ ( {x}_{r} , {y}_{r} ) = ( x , y ) & if {P}_{1} = ∅ \\ ( {x}_{r} , {y}_{r} ) = ( a , b ) & if {P}_{2} = ∅\end{matrix} , \qquad ( 2 )$$

$$else$$

$${x}_{r} = {λ}^{2} - x - a mod p$$

$${y}_{r} = λ ( a - {x}_{r} ) - b mod p$$

$$with λ = \{ \begin{matrix}{λ}_{r} = \frac{3 {a}^{2} + {c}_{1}}{2 b} = \frac{{y}_{r} + b}{a - {x}_{r}} & if {P}_{1} = {P}_{2} \\ \frac{y - b}{x - a} = \frac{{y}_{r} + b}{a - {x}_{r}} & else\end{matrix}$$

Here, −P₂=(x, −y), and Ø refers to the point at infinity, for which we will choose the representation Ø=(0,0). Note that all arithmetic operations, including addition, multiplication and division, are modular arithmetic operations modulo p. Furthermore, an additional known parameter is the order of a curve r, which is defined as [r]P=Ø. A multiple of the base point P can be computed efficiently via repeated doubling and addition. However, there is no known efficient classical algorithm for the reverse operation. Given a public key as a multiple of the base point Q=[k]P=P+P+ . . . +P, classical computers are currently unable to compute k efficiently, which is the primary feature exploited in elliptic curve cryptography.

Overall structure. A quantum computer can compute k efficiently using Shor's algorithm for elliptic curve discrete logarithms. FIG. 9A illustrates a phase estimation circuit for the generation of a private key k using a public key Q and an issue point P. The overall structure of this quantum circuit is shown in FIG. 9A for the computation of n-bit keys. Note that n indicates the number of qubits in each register. The algorithm includes two phase estimation steps with unitaries Uₚ and U_{Q} acting on two n-qubit registers |x [symbol] and |y), where

$${U}_{P} \vert R = ( x , y ) 〉 = \vert R + P 〉 , and \qquad ( 3 )$$

$${U}_{Q} \vert R 〉 = \vert R + Q 〉 = \vert R + [ k ] P 〉 \qquad ( 4 )$$

are unitary operators performing elliptic curve point addition with the base point P and public key Q, respectively. The phase estimation is performed on an input state |P)=|Pₓ) ⊗ |P_{y}>. Note that the eigenstates of Uₚ that overlap with |P) are all of the form

$$\vert {ψ}_{c} 〉 = {\sum }_{j = 0}^{r - 1} {e}^{i c j \frac{2 π}{r}} \vert [ j ] P 〉 , {U}_{P} \vert {ψ}_{c} 〉 = {e}^{- i c \frac{2 π}{r}} \vert {ψ}_{c} 〉 . \qquad ( 5 )$$

Therefore, a quantum phase estimation with Uₚ in the first half of the algorithm prepares a random state |ψ_{c}) and generates the corresponding integer c with 0≤c≤r−1 as an output. The state |ψ_{c}) is a simultaneous eigenstate of U_{Q} with:

$$\begin{matrix}{U}_{Q} \vert {ψ}_{c} 〉 = {\sum }_{j = 0}^{r - 1} {e}^{i c j \frac{2 π}{r}} \vert [ j ] P + Q 〉 \\ = {\sum }_{j = 0}^{r - 1} {e}^{i c j \frac{2 π}{r}} \vert [ j + k ] P 〉 = {e}^{- i c k \frac{2 π}{r}} \vert {ψ}_{c} 〉 .\end{matrix} \qquad ( 6 )$$

The second phase estimation with U_{Q} on the state |ω_{c}) generates the eigenphase ck as an output. Since c is known from the first phase estimation, k can be obtained after a modular division of ck by c.

Naively, each phase estimation includes n repetitions of controlled elliptic curve point additions. A windowing technique can be used to reduce the number of lookup additions, as shown in FIG. 9B. FIG. 9B illustrates a windowed elliptic-curve point addition in groups of 16. Each group of 16 controlled unitaries is replaced by a single point addition operation (ECPointAdd) and a QROM lookup of 2¹⁶ pre-computed elliptic curve points (a, b)=[c]R for c ∈ [0 . . . 2¹⁶−1] together with the constant λᵣ utilized for point doubling, as well as an uncomputation of the lookup table. While the optimal window size will depend on the key size, we found a windows size of 16 to be close to optimal for 256-bit keys. Note that there are 16 such group-of-16 operations in each phase estimation step, where R takes the values R=2^{16j} P for 0≤j≤15.

Advantageously, embodiments disclosed herein allow for private key computation with reduced resources by implementing two algorithmic modifications: (a) Multiple keys can be generated by repeating the second half of the algorithm for different public keys and (b) k parallel modular inversions can be performed with 3k−3 modular multiplications and a single modular inversion.

Elliptic curve point addition. One or more embodiments disclosed herein provide for an improved ECPointAdd circuit that, unlike typical circuits, does not ignore the exceptional cases where input or output points are Ø, or point doubling is performed. This improved circuit slightly increases the cost of the point addition operation, but since we will later consider performing multiple repetitions of this operation when generating multiple keys, we may be less tolerant to algorithmic errors.

The circuit shown in FIG. 10 inputs two points P₁=(a, b) and P₂=(x, y) stored in four n-qubit registers, as well as the constant λᵣ=(3a²+c₁)/(2b). It performs an in-place point addition using 5n+5 additional ancilla qubits and outputs the result in the (x, y) register. The first 5 ancilla qubits |f₁₋₄ [symbol] and |ctrl [symbol] are used to indicate the exceptional cases of the point addition. The flags f₁-f₄ indicate that a=x, b=−y, P₁=Ø and P₂=Ø, respectively.

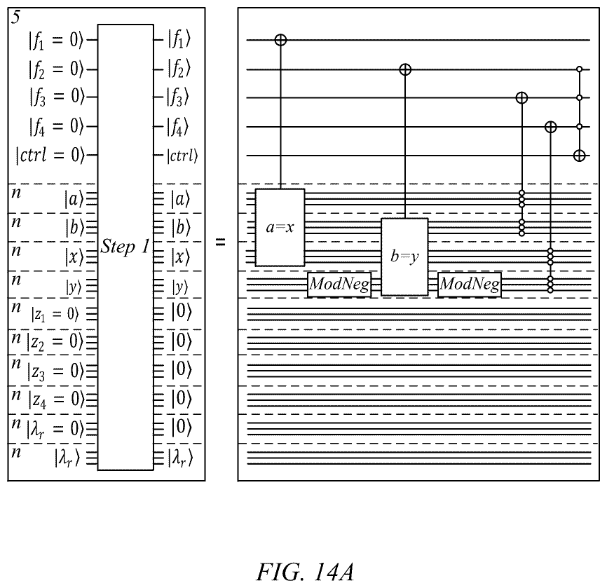

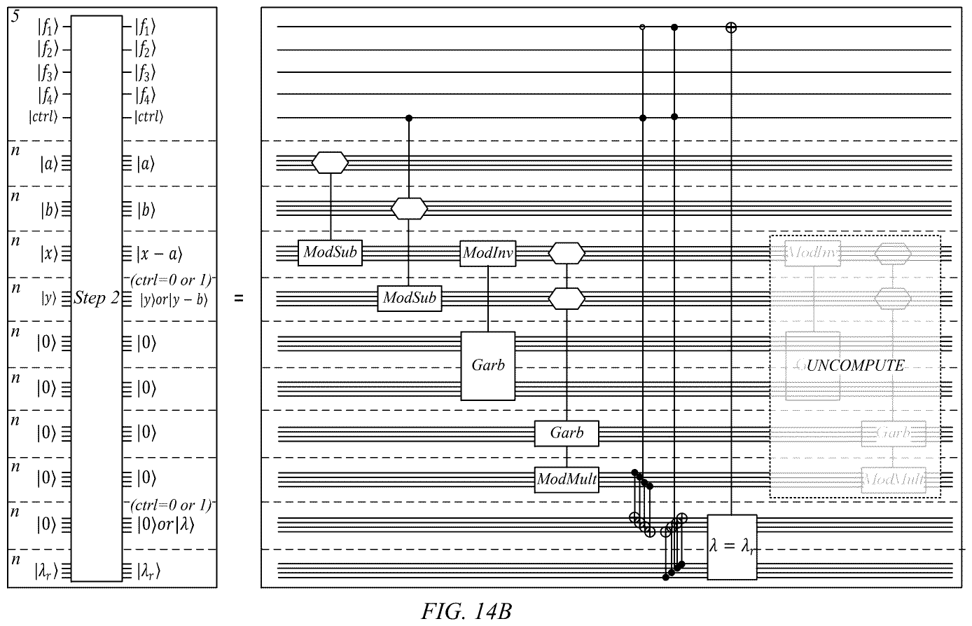

In step 1 of the circuit shown in FIG. 14A, the flags are first set by using equality checks between n-qubit registers, as well as modular negations and n-qubit Toffolis. The quantum circuit shown in FIG. 14A includes 6 n-controlled Toffoli gates and 2 n-qubit modular negation subroutines. Each n-qubit equality check can be implemented with an n-qubit Toffoli conjugated by CNOT gates, so we assign a cost of 6 n-controlled Toffoli gates and 2 n-qubit modular negations to step 1. The ctrl flag is set if f₂=f₃=f₄=0. This flag determines that neither the input points nor the output point are Ø, indicating that we are in the else branch of the point addition described in Eq. 2. Note that we ignore negligibly cheap operations such as the 3-controlled Toffoli used at the end of step 1. In step 2 shown in FIG. 14B, we compute into the last ancilla register, either via modular arithmetic if f₁=0, or by copying λᵣ into the register if f₁=1. An equality check between λ and λᵣ resets the flag f₁. Note that a red uncompute box is meant to describe the complex conjugate of the operation contained inside the box. The quantum circuit shown in FIG. 14B includes 3 n-controlled Toffoli gates, 1 n-qubit modular subtraction, 1 n-qubit controlled modular subtraction, 2 n-qubit modular multiplication, and 2 n-qubit modular multiplicative inverse subroutines.

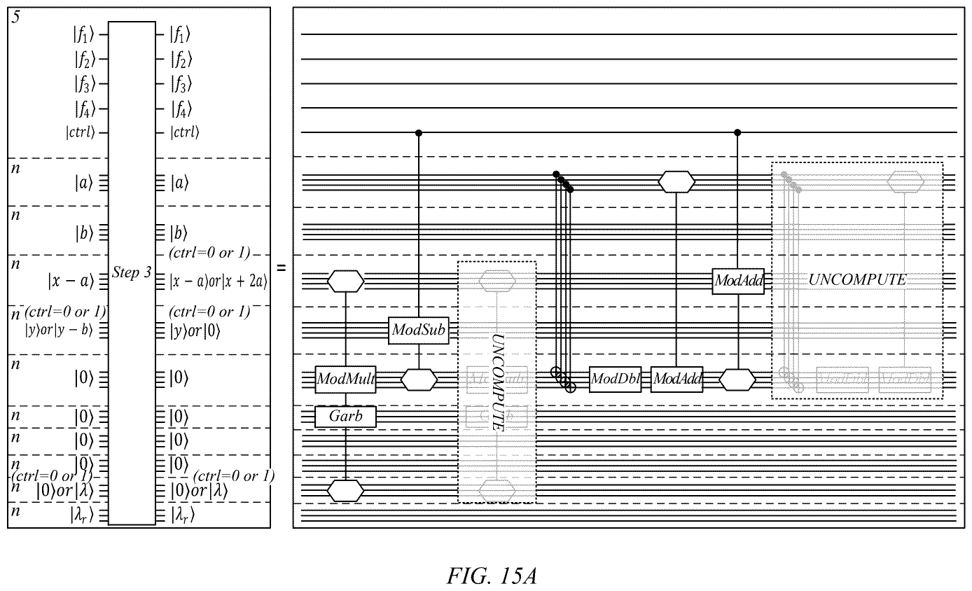

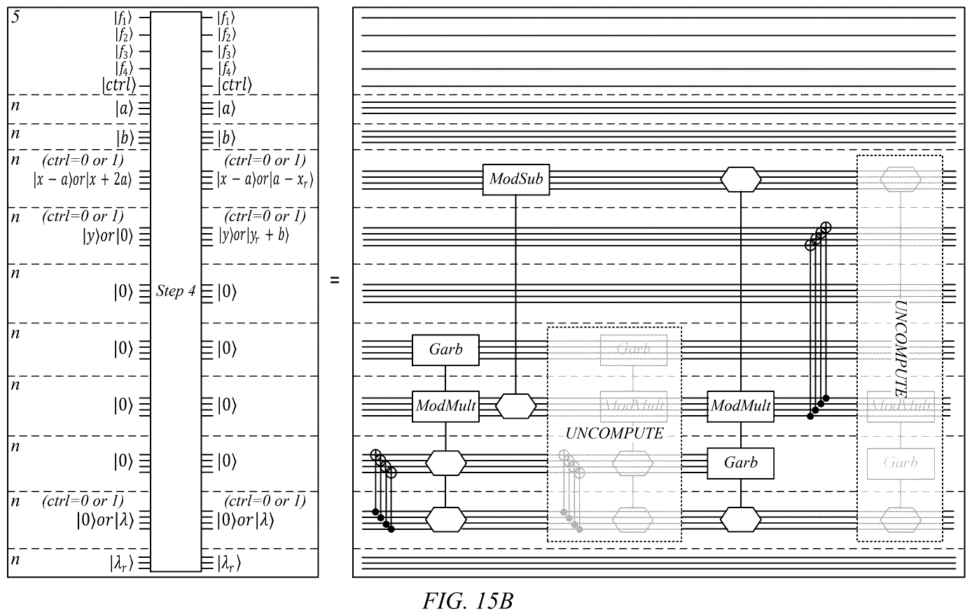

In steps 3 and 4 shown in FIGS. 15A and 15B, respectively, we use modular arithmetic operations to compute a−xᵣ and yᵣ+b in the |x [symbol] and |y) registers. The quantum circuit shown in FIG. 15A includes 2 n-qubit modular addition, 1 n-qubit controlled modular negation, 1 n-qubit controlled modular subtraction, 2 n-qubit modular doubling, and 2 n-qubit modular multiplication subroutines. The quantum circuit shown in FIG. 15B includes 1 n-qubit modular subtraction and 4 n-qubit modular multiplication subroutines.

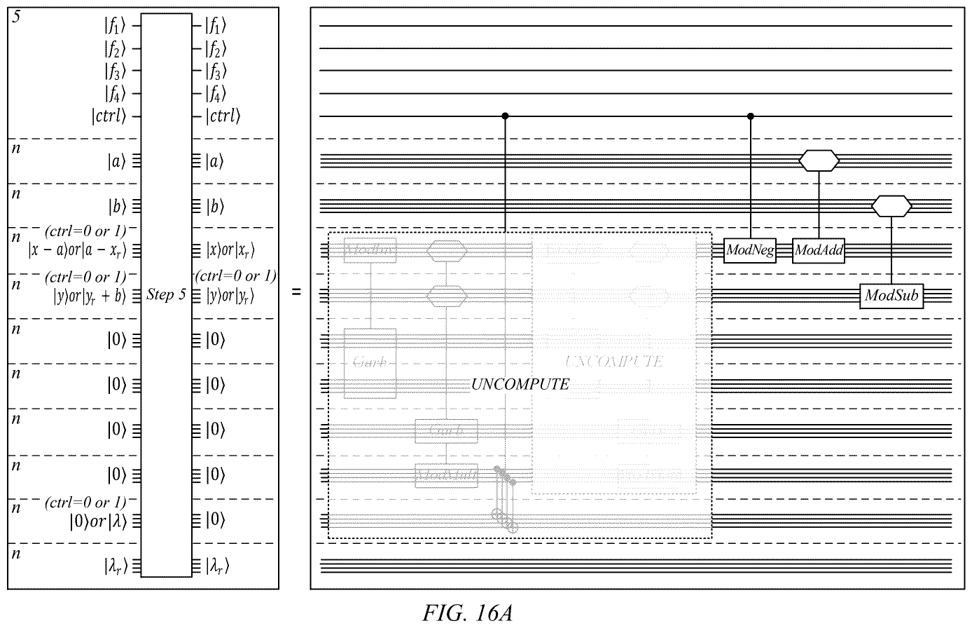

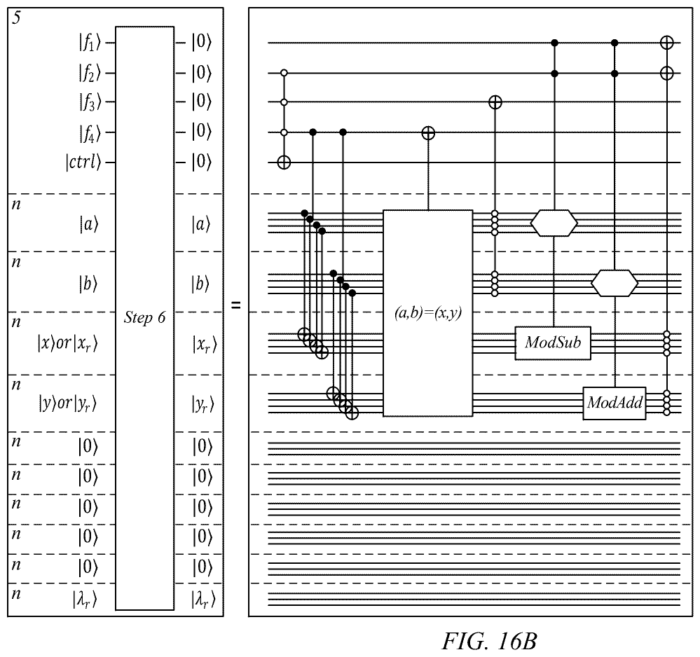

In step 5, shown in FIG. 16A, the |λ) register is reset to |0) by exploiting the fact that λ can be (un-) computed from a−xᵣ and yᵣ+b. At the end of step 5, the |x, y) registers either contain x, and yᵣ if ctrl=1, or the unchanged inputs x and y if ctrl=0, thereby completing the else branch of Eq. 2. The quantum circuit shown in FIG. 16A includes 1 n-controlled Toffoli gate, 1 n-qubit modular addition, 1 n-qubit controlled modular subtraction, 1 n-qubit controlled modular negation, 2 n-qubit modular multiplication, and 2 n-qubit modular multiplicative inverse subroutines.

In step 6, shown in FIG. 16B, the ctrl flag is reset and the exceptional cases are treated. If f₄=1, then P₂=Ø and P₁ is copied into the output register. The quantum circuit shown in FIG. 16B includes 8 n-controlled Toffoli gates, 1 n-qubit controlled modular addition, and 1 n-qubit controlled modular subtraction subroutines. The flag is reset via an equality check. If f₃=1, then P₁=Ø and no operation needs to be performed, but the flag may be reset via a 2n-qubit Toffoli. Finally, if f₁=f₂=1, then P₁=−P₂ and the output may be set to (0,0) via a subtraction and an addition before the flag is reset.

The total subroutine count is shown in Table 2, below.

TABLE 2

| Subroutine | Count |
|---|---|
| n-controlled Toffoli | 18 |
| n-qubit modular addition | 3 |
| n-qubit controlled modular addition | 2 |
| n-qubit modular subtraction | 2 |
| n-qubit controlled modular subtraction | 4 |
| n-qubit modular negation | 2 |
| n-qubit controlled modular negation | 1 |
| n-qubit modular doubling | 2 |
| n-qubit modular multiplication | 10 |
| n-qubit modular multiplicative inverse | 4 |

In the next step, we decompose these modular arithmetic subroutines into the elementary subroutines listed in Table 1.

Modular arithmetic. We decompose modular arithmetic subroutines and perform an active volume estimate. We implicitly assume that all numbers are stored in Montgomery representation, to take advantage of existing efficient constructions for modular multiplication and inversion.

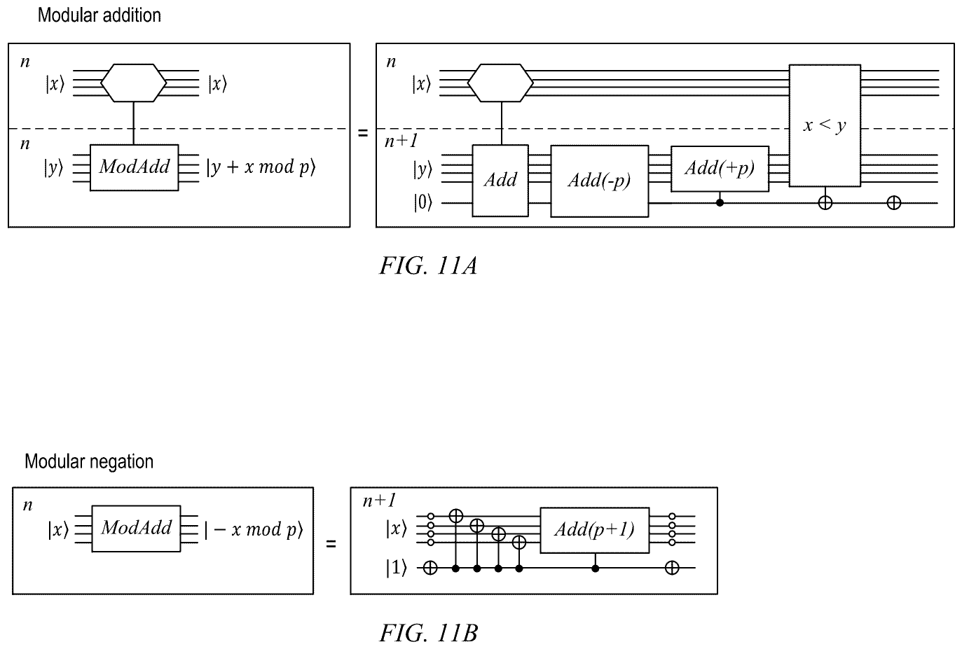

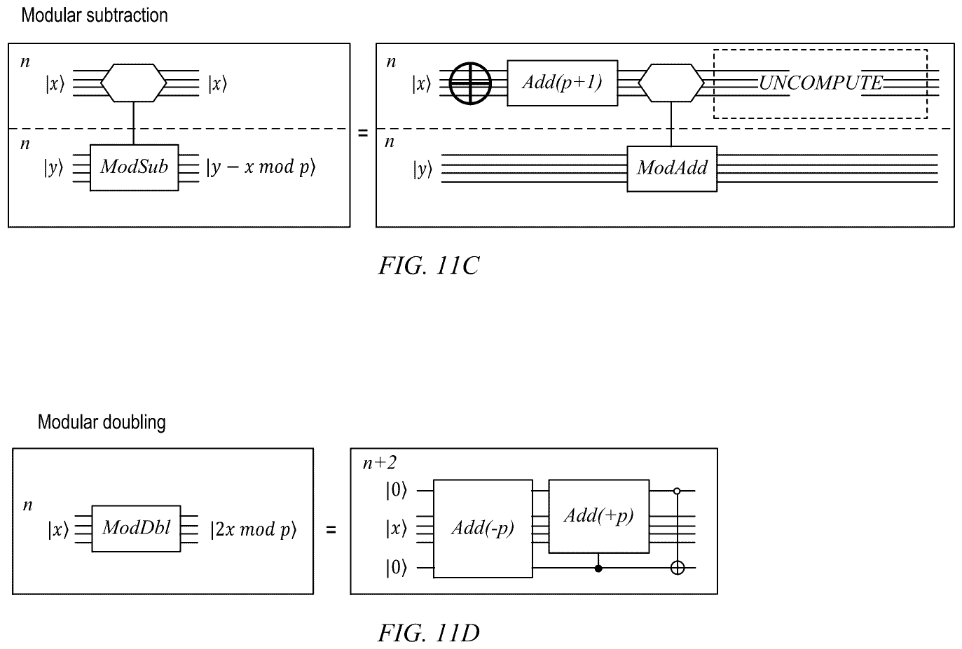

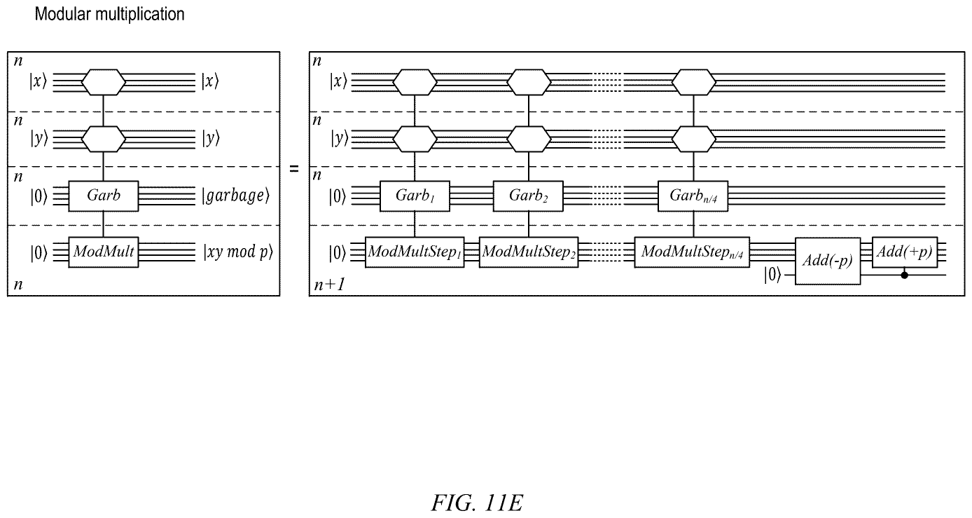

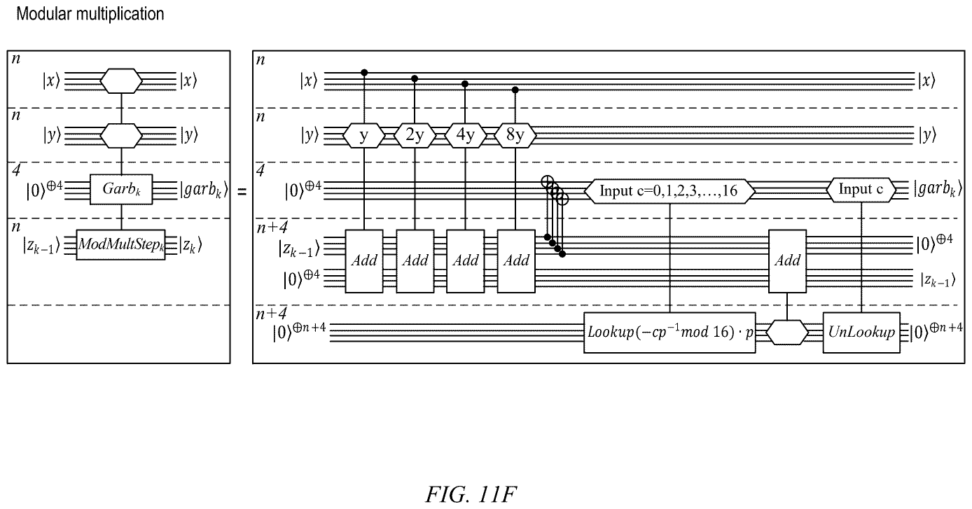

A quantum circuit for performing in-place modular addition is shown in FIG. 11A, according to some embodiments, and is implemented by first converting y into an n+1-qubit number with the most significant bit initialized as |0 [symbol] and then performing a non-modular addition. Next, a modular reduction is performed by subtracting the modulus p and checking if the result is negative (if the most significant bit is 1), in which case p is added back to the result. The most significant bit is reset to 0 via a comparator. Using the resource estimates in Table 1 for adders, constant adders and comparators, the Toffoli count of n-qubit modular addition is 4n and the active volume is 240n. In a controlled modular addition, only the first addition and the comparator are be controlled, leading to a Toffoli count of 5n and an active volume of 280n.

A quantum circuit for performing modular negation of x is illustrated in FIG. 11B, according to some embodiments, and is performed by flipping all bits and adding p+1, unless x=0, in which case no operation needs to be performed. The exceptional case is checked with a flag that is computed and uncomputed with an n-qubit Toffoli. While the circuit shows two n-qubit Toffolis, the uncomputation can be done using measurements, if the temporary AND ancilla qubits are kept throughout the operation. The Toffoli count is therefore 2n and the active volume 110n. In a controlled modular negation, the CNOTs flipping the bits are replaced by n Toffoli gates and the addition of p+1 is replaced by a controlled addition, increasing the Toffoli count to 3n and the active volume to 160n.

FIG. 11C is a quantum circuit for performing modular subtraction, according to some embodiments. Modular subtraction can be done by performing a modular negation of the subtrahend without checking for the exceptional case of x=0, followed by a modular addition and an uncomputation of the negation. The total Toffoli count is 6n and the active volume is 360n. Controlling the adder to implement a controlled subtraction increases the Toffoli count to 7n and the active volume to 400n.

FIG. 11D is a quantum circuit for performing modular doubling, according to some embodiments. Modular doubling is performed by converting x to an n+2-bit integer by attaching two |0 [symbol] qubits as the least and most significant bits. A reduction is performed using the same operations as in the modular addition. The least significant bit is reset to 0 by checking only the most significant bit. If a reduction took place (i.e., 2x≥p), then the resulting number is odd and the bit does not need to be reset. If no reduction took place (i.e., 2x<p), then the resulting number is even and the bit is reset with a zero-controlled-NOT gate.

FIGS. 11E-F are quantum circuit diagrams for performing modular multiplication, according to some embodiments. The modular multiplication operation shown relies on the Montgomery representation. It generates an additional garbage register that can be uncomputed whenever the multiplication is uncomputed. The n-qubit multiplication include n/4 steps, each adding 4 qubits to the garbage register. In each step, four controlled additions are performed. An efficient modular reduction together with a division by 16 is performed using a 16-item lookup table and an addition. Therefore, each step has a Toffoli count of 9n+28 and an active volume of 472n+1492. The n/4 steps are followed by a final reduction using two constant adders, resulting in a total Toffoli count of 2.25n²+9n and an active volume of 118n²+493n. Again, the window size of 16 is motivated by 256-bit keys, while the optimal value will depend on the number of bits.

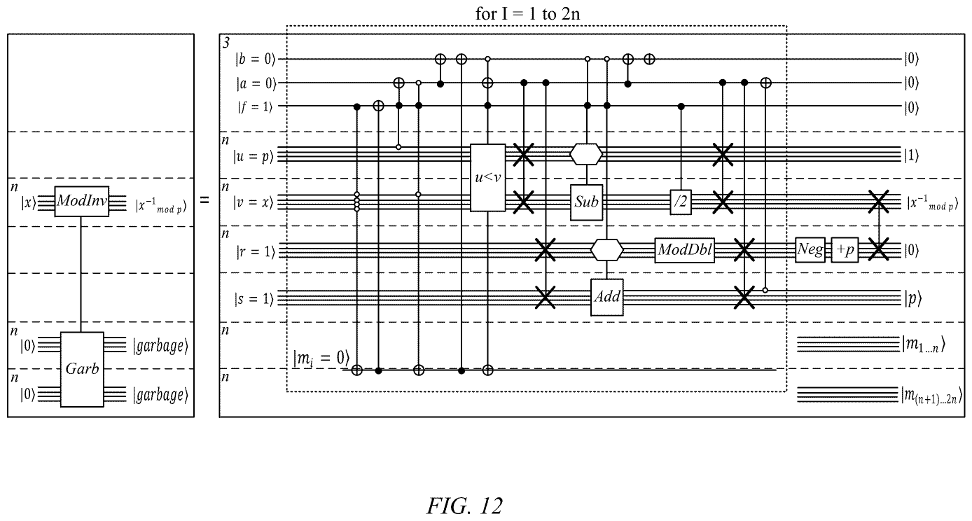

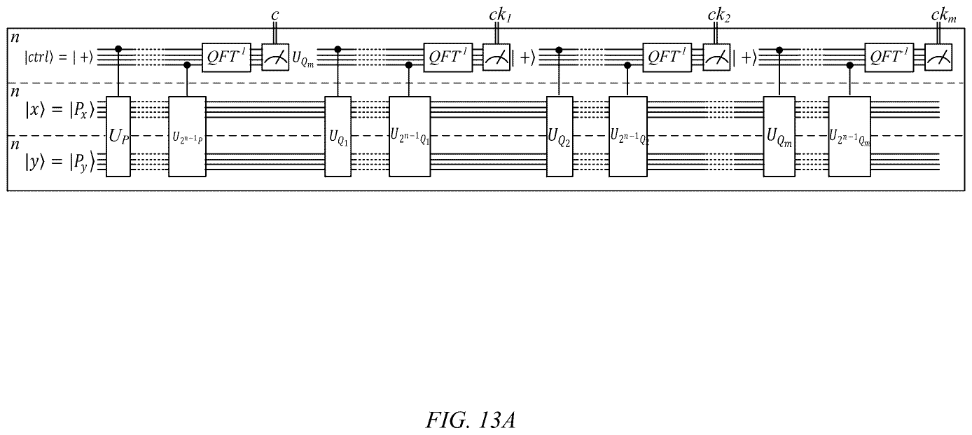

FIG. 12 is a quantum circuit diagram illustrating an efficient modular inversion circuit, according to some embodiments. It computes the modular multiplicative inverse x⁻¹ in-place using five n-qubit ancilla registers and generating two n-qubit ancilla registers as garbage. The four registers labeled |u [symbol] , |v), |r) and |s) are initialized in u=p, v=x, r=0 and s=1. The block encased in a dotted line in FIG. 12 is repeated 2n times. It mainly contains an n-controlled Toffoli, a comparator, a controlled addition, a controlled subtraction, a modular doubling, four n-qubit controlled SWAPs and a controlled non-modular halving (which can be implemented with n controlled SWAPs), and therefore has a Toffoli count of 13n and an active volume of 730n. Each repetition of this block adds one qubit to the garbage register. After 2n repetitions, the terminal values are u=1, v=0, r=p−x⁻¹ and s=p. After the final negation, constant addition and SWAP, all registers apart from the output and garbage registers contain known values, and can therefore be discarded. The total cost of this inversion operation is 26n²+2n Toffolis or 1460n²+120n blocks of active volume. This operation is over 10 times more expensive than a multiplication, and is therefore the dominant contribution to the cost of elliptic curve point addition.

Table 3, below, summarizes all resource estimates of the above-described modular arithmetic operations:

TABLE 3

| Subroutine | Toffoli count | Active volume |
|---|---|---|
| n-qubit modular addition | 4n | 240n |
| n-qubit controlled modular addition | 5n | 280n |
| n-qubit modular negation | 2n | 111n |
| n-qubit controlled modular negation | 3n | 160n |
| n-qubit modular subtraction | 6n | 360n |
| n-qubit controlled modular subtraction | 7n | 400n |
| n-qubit modular doubling | 2n | 120n |
| n-qubit modular multiplication | 2.25n² + 9n | 118n² + 493n |
| n-qubit modular multiplicative inverse | 26n² + 2n | 1460n² + 120n |

Algorithmic modifications. The following paragraphs introduce three modifications to the described embodiments that advantageously reduce the resource count.

First, we observe in FIG. 13A that multiple private keys k_{1 . . . m} of the same elliptic curve can be generated by repeating the second phase estimation m times for different public keys Q_{1 . . . m}, as the state |ψ_{c}) is a simultaneous eigenstate of all U_{Qj} of valid public keys Qⱼ. In our resource estimates, we will choose the code distance such that the expected runtime before a logical error is 10 phase estimation blocks. We will terminate the algorithm after a block generates an invalid private key. Therefore, rather than assuming that this method halves the cost per key, we will take into account the initial phase estimation block that generates the state |ψ_{c} [symbol] by increasing the cost per key by a factor of 10/9 compared to the cost of a single phase estimation block.

For our second modification, we observe that it is not necessary to generate all bits of the private key on the quantum computer. Instead of using 16 repetitions of the group-of-16 operation in FIG. 9B, we can use only 13 repetitions to generate, e.g., 208 of the 256 bits of the rescaled private key ck. This narrows down the list of possible candidates to 2⁴⁸ keys. The correct key can then be found via brute force search. A list of 2⁴⁸ candidate keys may be searched in [symbol] (10⁶) CPU hours using current computing speeds. With costs per CPU hour on the order of cents, this can be a worthwhile trade-off reducing the cost per key by a factor of 13/16.

The third modification aims to reduce the cost of the modular inversion operation. Suppose we are running two instances of the ECC algorithm on the same (larger) quantum computer to break two keys at the same time. We execute the subroutines of the two instances in an alternating fashion-first a subroutine of the first instance and then a subroutine of the second instance. Eventually, both instances will reach a modular inversion operation. Rather than performing two costly modular inversion operations, we may instead compute both inverses using a single inversion and three multiplications. As shown in FIG. 13B, we can invert two numbers x₁ and x₂ by first computing the product x₁x₂, inverting the product, and obtaining the individual inverses using two additional multiplications. A more detailed example of a quantum circuit for inverting the product as described above is shown in FIGS. 17 and 18A-B.

If we have four instances running in parallel, we can invert four numbers using 9 multiplications and one inversion, as shown in FIG. 17. More generally, k numbers can be inverted using 3k−3 multiplications and a single inversion, or 3 multiplications and 1/k inversions per instance. Note that the naive construction uses 6k−4 n-qubit garbage registers, but this can be reduced to 2k+2 log₂k garbage registers by making inverses available sequentially, as shown in FIGS. 18A-B. The asymptotic cost per inversion is three modular multiplications, which reduces the active volume per inversion by up to a factor of around 4, but uses more memory to run multiple instances of the algorithm in parallel.

By adding the costs of all subroutines listed in Table 2, we arrive at the cost estimate for an ECPointAdd operation in Table 4, below:

TABLE 4

| Subroutine | Toffoli count | Active volume |
|---|---|---|
| k parallel n-qubit | (3k − 3) − (2.25n² + | (3k − 3) − (118n² + |
| modular inversions | 9n) + 26n² + 2n | 493n) + 1460n² + 120n |
| Effective cost per | 6.75n² + 27n + | 354n² + 1479n + |
| inversion | (19.25n² − 25n)/k | (1106n² − 1359n)/k |
| k parallel n-qubit | (49.5² + 289n) − k + | (2596² + 15966n) − |
| elliptical curve | 77n² − 100n | k + 4424n² − 5436n |
| point additions | | |
| Effective cost per | 49.5n² + 289n + | 2596n² + 15966n + |
| ECPointAdd | (77n² − 100n)/k | (4424n² − 5436n)/k |
| k parallel 256-bit | (44k + 65) − 10⁶ | (2.8k + 3.8) − 10⁹ |
| elliptical curve | | |
| private additions | | |
| Effective cost per | (44 + 65/k) − 10⁶ | (2.8 + 3.8/k) − 10⁹ |
| 256-bit key | | |

### Resource Estimate

The full algorithm to break 256-bit ECC keys include 13 repetitions of the group-of-16 operation shown in FIG. 9B, per key. Each operation include a 216-item table lookup of 768-bit numbers, an ECPointAdd operation, and an uncomputation of the lookup table. The resulting Toffoli count for k parallel instances is (44k+65)·10⁶ Toffoli gates and (2.8k+3.8)·10⁹ blocks of active volume. Asymptotically, the cost per key approaches 44 million Toffoli gates and 2.8 billion logical blocks of active volume for large quantum computers. We adjust these costs by a factor of 10/9 to account for the expected time before a logical error of 10 phase estimation blocks.

The circuits shown in FIGS. 9A-B and FIG. 10 contain 11 registers of 256 qubits each. Note that the size of the control register in the phase estimation can be reduced substantially by using iterative phase estimation. For simplicity, we will use an overestimate of 3000 logical memory qubits per instance of the ECC algorithm. This can account for additional ancilla qubits that may be present during the execution of arithmetic circuit in the baseline architecture, or stale magic states and bridge qubits stored in memory in an active-volume architecture.

### Baseline Architecture

We first perform a resource estimate for a baseline architecture with 2D-local connections. This architecture does not benefit from the parallel modular inverse operation, so we only consider one instance of the algorithm. In total, 6000 logical qubits and 109 million Toffoli gates are utilized per key.

Determining the code distance. With four logical cycles per block, each key generation has a spacetime volume of 2.6×10¹² logical blocks of size d³. Each such block accounts for a d×d patch of physical data qubits operating for d code cycles and can be estimated to contribute a logical error rate of p_{L}=10^{-d/2} at 10% threshold. We choose the code distance such that the total error probability after 10 phase estimation blocks (i.e., after executing 2.6×10¹³ logical blocks) is slightly below 50%. With d=28, the probability of a logical error after 10 phase estimation blocks is around 20% in this estimate. Taking into account the factor of 10/9, the average time per key is 484 million logical cycles, where a logical cycle include d code cycles.

Circuit-based quantum computers. For superconducting qubits and trapped ions, each distance-d logical qubit include 2d² physical qubits, taking into account the ancilla qubits used for the measurement of surface-code check operators. Therefore, both use 9.4 million physical qubits. With a 1 μs code cycle, superconducting qubits generate one key every 484· 28 seconds, or 3.8 hours. With a 1 ms code cycle, trapped ions generate one key every 160 days.

Photonic FBQC. In order to encode 6000 logical qubits in a photonic fusion-based quantum computer based on 6-ring resource states, the device would store 6000d² photonic resource states simultaneously. With a maximum delay length of 1 μs, 4.7 million resource states may be generated every 1 μs, i.e., a total RSG rate of 4.7 THz is desired. Due to a code cycle of 1 μs, such a device generates keys at the same rate as the superconducting qubit device. With 10 us delays, the device footprint can be reduced by a factor of 10 to a 470 GHz total RSG rate, while the time per key increases by a factor of 10 to 1.6 days. Longer delays of 100 ms and 1000 ms decrease the device footprint in additional factor-of-10 steps, and increase the time per key to 16 days and 160 days.

### Active-Volume Architecture

We consider two scenarios for the active-volume architecture: one in which we are generating one key at a time using 3000 logical memory qubits, and one in which we are generating four keys in parallel using 12000 logical memory qubits. In the first scenario, the active volume per key is 6.6 billion blocks, while in the second scenario, the active volume per key is reduced to 3.75 billion blocks due to the cheaper inversion operation.

Determining the code distance. In an active-volume architecture, the total spacetime volume is twice the active volume, i.e., 1.3×10¹⁰ logical blocks in the first scenario. This can also be understood from the observation that 3000 workspace qubits execute 3000 active-volume blocks in every logical cycle, so it will take 2.2×10⁶ logical cycles to finish the computation. The number of logical cycles multiplied by the 6000 logical qubits present in the device also yields a total spacetime volume of 1.3×10¹⁰ logical blocks. If we now choose the code distance such that the total error probability after executing 1.3×10¹¹ logical blocks is below 50%, we can reduce the code distance to d=24.

Circuit-based quantum computers. While the non-local connections in an active-volume architecture are motivated by photonics, the architecture is hardware-agnostic. We can perform an active-volume estimate for superconducting qubits and trapped ions, even if no concrete proposal for an implementation of these non-local connections exists for these qubits. In the first scenario, the device include 6000 qubit modules, each containing a distance-24 surface-code patch, i.e., 1152 physical qubits. Executing 3000 blocks per logical cycle, the device generates one key every 58 seconds (superconducting qubits) or 16 hours (trapped ions), which is 240 times faster with a 27% smaller footprint compared to the baseline estimate. In the second scenario, the device footprint increases by a factor of 4, but due to the cheaper inversion operation, the time per key decreases by a factor of 7.

Photonic FBQC. We obtain similar resource estimates for photonic fusion-based quantum computers, for which a concrete implementation of an active-volume architecture is described in. Compared to a baseline architecture, the RSG rate in the first scenario decreases by 27% due to the reduced code distance. The time per key decreases by the same factor of 240, where device footprint and computational speed can traded off linearly by varying the delay length. However, the decrease in the cost per key with larger memory capacity implies that we should always seek to maximize the delay length, as the extra logical qubits unlocked by longer delay lines can be used to reduce the computational volume cost per key. In the second scenario, the cost per key is reduced by an additional 40%.

### Reaction Depth

One important consideration in any resource estimate is the reaction limit. Due to the sequential nature of the classical processing related to surface-code-based FTQC, it is impossible to execute computations faster than the reaction depth multiplied by the reaction time. The reaction time is the time that it takes to perform a layer of single-qubit measurements, feed the measurement results into a decoder, perform a decoding tasks, and use the result to send back measurement instructions to the quantum computer. Since the n-qubit adders considered in this estimate have a reaction depth of 2n, we can upper bound the reaction depth as twice the Toffoli count. When we are executing k instances of the algorithm in parallel, the subroutines can be parallelized straightforwardly, so the naive estimate of the reaction depth should be divided by k.

A typical assumption in the literature is a reaction time of 10 μs. In this case, the algorithm generating one key at a time would be naively reaction limited at 36 minutes per key, whereas the algorithm generating four keys in parallel would be reaction limited at 5 minutes per key (or 20 minutes for groups of four keys). This is particularly problematic in implementations with short code cycles like superconducting qubits or photonic devices with short delay lines. Note that, in this case, the reaction limit is irrelevant for photonic devices with long delay lines and slow ion traps.

There are several ways one can avoid the reaction limit. The first is to reduce the reaction time. The assumed 10 μs are not based on physical limits, and an optimized architecture can, in principle, feature lower reaction times. The second is to use lower-depth subroutines. We have not focused on optimizing the reaction depth. One can use lower depth subroutines for arithmetic operations or depth-reducing tricks such as oblivious carry runways to increase the cost of the algorithm in favor of a lower depth. The third option is only relevant for photonic FBQC, which is to increase the delay length. Longer delay lines can be used to avoid the reaction limit, as they increase the code cycle time in favor of a smaller footprint. Note that this does not make the device less efficient. On the contrary, the additional logical qubits gained by longer delays make the device more efficient due to the option of cheaper subroutines. If two devices have the same footprint in terms of total RSG rate but different delay lengths, the device with the longer delay length will both generate keys at a faster rate and feature a lower (i.e., less strict) reaction limit.

### SUMMARY

We have performed an active-volume estimate for the cost of generating elliptic curve private keys on a fault-tolerant quantum computer. We also introduced three algorithmic modifications that reduce the Toffoli count per key by up to a factor of 5. We found that this algorithm benefits particularly strongly from the non-local connections in an active-volume architecture. When generating one key at a time, the active volume architecture features an over 300 times lower cost per key. This can be understood from the observation that the spacetime cost per Toffoli in a baseline architecture is proportional to 4n_{Q} due to the presence of four sequential T gates per Toffoli, whereas in an active-volume architecture it is an n_{Q}-independent cost of ≈60 in a computation that primarily relies on arithmetic operations. For n_{Q}=3000, this results in a factor of 200. The reduced code distance decreases the cost by an additional factor of (28/24)³≈1.6. With more memory qubits to take advantage of the cheaper modular inversion, the cost difference between baseline and active volume architectures can be up to a factor of 700 per key.

Photonic FBQC particularly benefits from long delay lines in this example. Not only do long delay lines increase the memory of device, but they also increase the value that can be extracted from each component, as the additional memory can be used to decrease the cost of some subroutines. Long delay lines also help avoid the reaction limit without sacrificing device performance.

We focused on resource estimates for 256-bit keys at a physical error rate corresponding to 10% of the surface code threshold error rate. While larger key sizes may benefit from a more careful balancing of window sizes, the rough behavior is that doubling the key size results in a twofold increase in footprint and an eightfold increase in Toffoli count and active volume (and time per key) due to the cubic scaling in key size. A larger physical error rate will also increase the footprint and runtime. Closer to 50% threshold, we can expect the code distance to roughly double, resulting in a fourfold increase in footprint and a twofold increase in the computational time per key.

Compared to the active-volume estimate for 2048-bit RSA keys, the active volume per 256-bit ECC key is lower by a factor of 100-300. However, the active volume per 2048-bit RSA key may be reduced through further optimizations, e.g., by adjusting the window size of windowed arithmetic to rebalance the contributions of arithmetic and data lookups to the active volume. Still, one can expect the generation of 2048-bit RSA keys to be over an order of magnitude more expensive than 256-bit ECC keys.

### Additional Figures

Additional figures are shown in FIGS. 14-21. FIGS. 14A-B show steps 1 and 2 of the elliptic curve point addition circuit in FIG. 10, according to some embodiments. FIGS. 15A-B shows steps 3 and 4 of the elliptic curve point addition circuit in FIG. 10, according to some embodiments. FIGS. 16A-B show steps 5 and 6 of the elliptic curve point addition circuit in FIG. 10, according to some embodiments. FIG. 17 shows an example of parallel modular inversion of four numbers, according to some embodiments. FIGS. 18A-B show parallel modular inversion of four numbers in which the four inverses are made available sequentially to save qubits, according to some embodiments.

FIGS. 19A-B show an example of two quantum circuits being executed in parallel, each one employing a modular inversion, according to some embodiments.

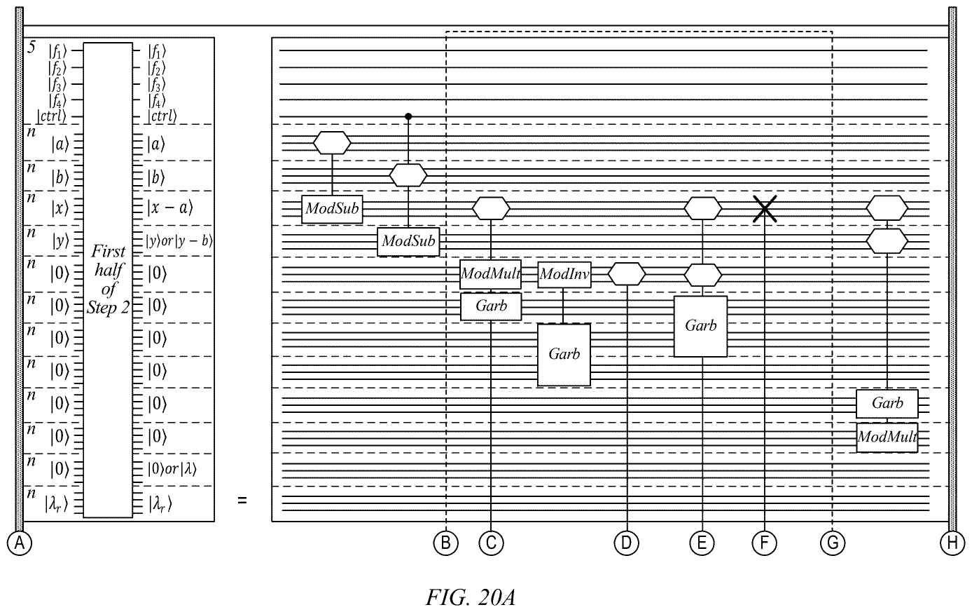

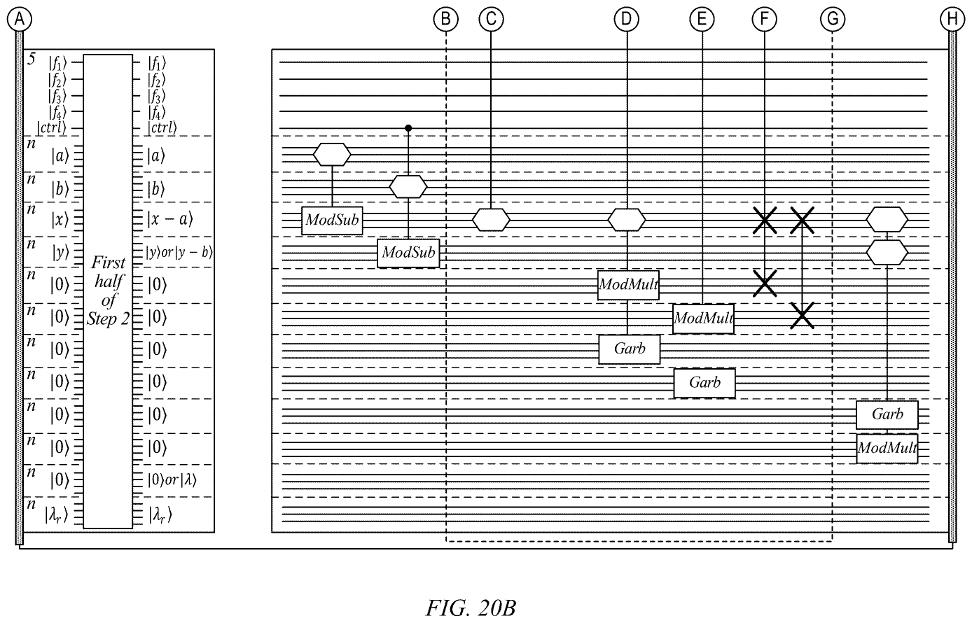

FIGS. 20A-B shows how a parallel modular inversion can take advantage of shared resources, in accordance with one or more embodiments.

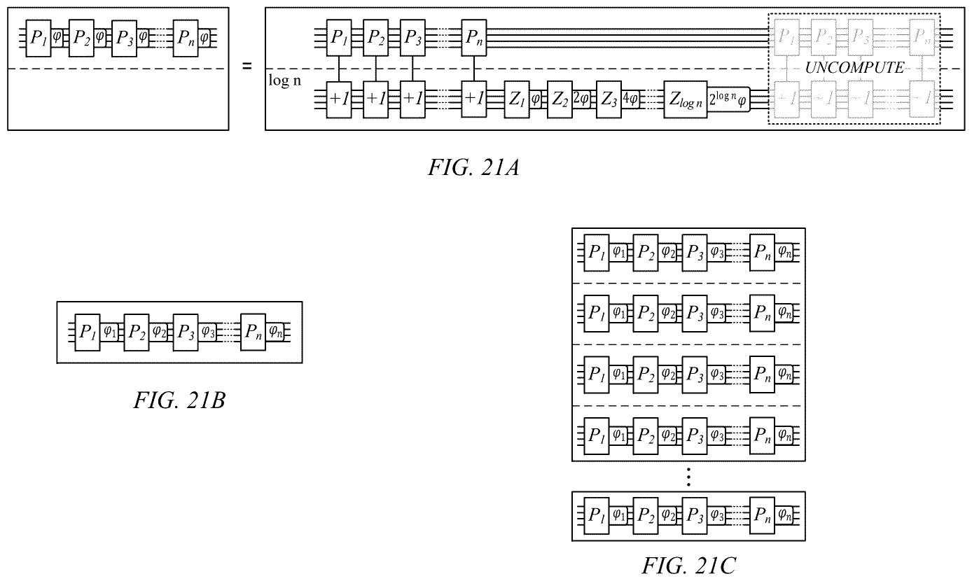

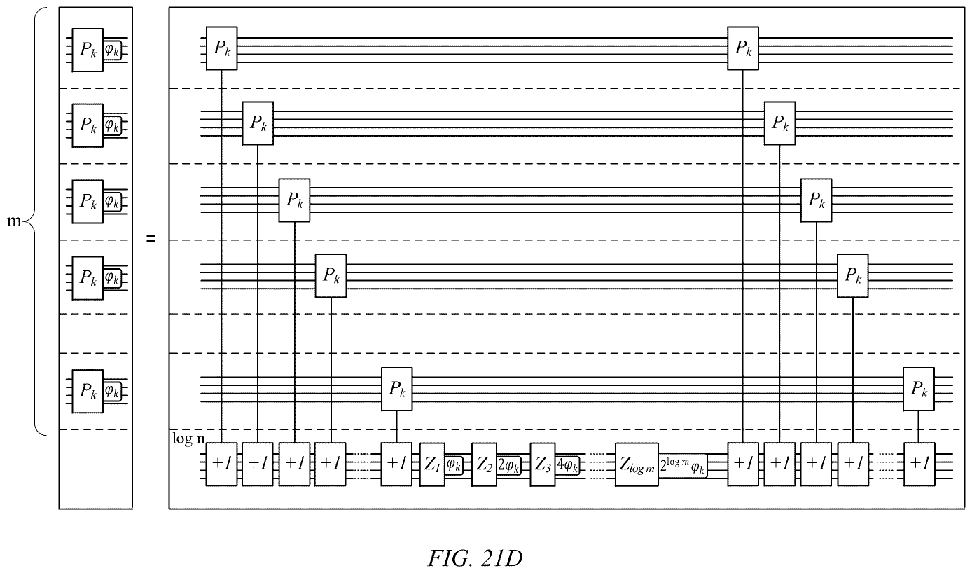

FIGS. 21A-D illustrate embodiments related to quantum chemistry simulation, according to some embodiments. FIG. 21A shows a Hamming-weight phasing (HWP) circuit construction that reduces the cost of groups of mutually commuting Pauli rotations P_phi with the same angle phi. When the Pauli operators P₁, . . . Pₙ mutually commute, this circuit can be used to replace the rotations with n controlled increment operations, log n rotations and an uncomputation of the increment operations. (P₁-controlled-+1 is the generalized version of a controlled-increment arithmetic operation.) Specialized constructions can be used to execute the n controlled increments together with the uncomputation using only n Toffoli gates. Effectively, this reduces the cost of n rotations by the cost of n Toffoli gates and log n rotations, which is often much cheaper. However, this can usually only be used, if rotations within an algorithm commute and have the same angle.

FIG. 21B shows an algorithm consisting of a sequence of arbitrary rotations. FIG. 21B illustrates an instance of a rotation-based algorithm with arbitrary P₁, . . . Pₙ and φ₁ . . . φₙ. Here, the rotations all have different angles and don't necessarily commute, so the HWP construction shown in FIG. 21A may not be used straightforwardly. As for the case of the embodiments described above, multiple instances of this algorithm may be executed in parallel, as shown in FIG. 21C. FIG. 21D shows that, analogous to the parallel inversion trick described above, the m parallel instances can share their resources to execute the rotations of arbitrary angles with a reduced per-rotation cost, even if the algorithm does not have a structure amenable to HWP. Since we are running copies of the same algorithm, we are guaranteed to have blocks of m mutually commuting (since they are supported on entirely different qubit registers) rotations with the same angle. Using the same HWP trick, the effective cost of each rotation can be reduced to 1 Toffoli gate and (log m/m) rotations, allowing us to exploit the cost reduction even if the rotations within each algorithm are arbitrary and non-commuting.

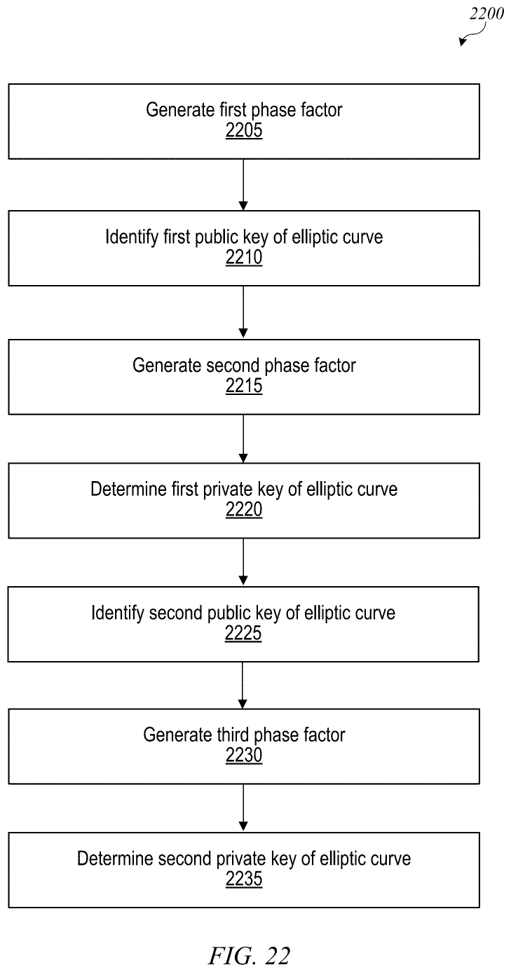

### FIG. 22-Flowchart for Determining First and Second Private Keys

FIG. 22 is a flowchart of an example method 2200, in accordance to some example embodiments. In some implementations, one or more process operations of FIG. 22 may be performed by devices including a classical processor and a quantum information processing system.

In various embodiments, some of the method elements shown may be performed concurrently, in a different order than shown, or may be omitted. Additional method elements may also be performed as desired. As shown, this method may operate as follows.

As shown in FIG. 22, the method 2200 may include generating, on a quantum information processing system, a first phase factor by performing a first measurement on a quantum state (at operation 2205). For example, device may generate, on a quantum information processing system, a first phase factor by performing a first measurement on a quantum state, as described above. As also shown in FIG. 22, the method 2200 may include identifying, on one or more classical processors, a first public key of an elliptic curve (at operation 2210). For example, device may identify, on one or more classical processors, a first public key of an elliptic curve, as described above. As further shown in FIG. 22, the method 2200 may include generating, on the quantum information processing system, a second phase factor by performing a second measurement on the quantum state, the second measurement being performed after the first measurement (at operation 2215). For example, the device may generate, on the quantum information processing system, a second phase factor by performing a second measurement on the quantum state, the second measurement being performed after the first measurement, as described above.

As also shown in FIG. 22, the method 2200 may include determining, on the one or more classical processors, a first private key of the elliptic curve, the first private key being determined based on the second phase factor and the first phase factor (at operation 2220). For example, device may determine, on the one or more classical processors, a first private key of the elliptic curve, the first private key being determined based on the second phase factor and the first phase factor, as described above. As further shown in FIG. 22, the method 2200 may include identifying, on the one or more classical processors, a second public key of the elliptic curve (at operation 2225). For example, device may identify, on the one or more classical processors, a second public key of the elliptic curve, as described above.

As also shown in FIG. 22, the method 2200 may include generating, on the quantum information processing system, a third phase factor by performing a third measurement on the quantum state, the third measurement being performed after the first and second measurements (at operation 2230). For example, device may generate, on the quantum information processing system, a third phase factor by performing a third measurement on the quantum state, the third measurement being performed after the first and second measurements, as described above. As further shown in FIG. 22, the method 2200 may include determining, on the one or more classical processors, a second private key of the elliptic curve, the second private key being determined based on the third phase factor and the first phase factor (at operation 2235). For example, device may determine, on the one or more classical processors, a second private key of the elliptic curve, the second private key being determined based on the third phase factor and the first phase factor, as described above.

Although FIG. 22 shows example at operations of the method 2200, in some implementations, the method 2200 may include additional operations, fewer operations, different operations, or differently arranged operations than those depicted in FIG. 22. Additionally, or alternatively, two or more of the blocks of the method 2200 may be performed in at the same time.

### Additional Embodiments

Example 1: A method comprising: generating, on a quantum information processing system, a first phase factor by performing a first measurement on a quantum state; identifying, on one or more classical processors, a first public key of an elliptic curve; generating, on the quantum information processing system, a second phase factor by performing a second measurement on the quantum state, the second measurement being performed after the first measurement; determining, on the one or more classical processors, a first private key of the elliptic curve, the first private key being determined based on the second phase factor and the first phase factor; identifying, on the one or more classical processors, a second public key of the elliptic curve; generating, on the quantum information processing system, a third phase factor by performing a third measurement on the quantum state, the third measurement being performed after the first and second measurements; and determining, on the one or more classical processors, a second private key of the elliptic curve, the second private key being determined based on the third phase factor and the first phase factor. The first and second series of quantum phase estimation circuits may be applied in parallel, in some embodiments.
Example 2: The method of Example 1, wherein before the first measurement the quantum state is prepared by applying a phase estimation scheme on a plurality of qubits.
Example 3: The method of Example 1 or Example 2, wherein the phase estimation scheme comprises one or more unitary gates.
Example 4: The method of any one of Examples 1-3, wherein the one or more unitary gates are configured to perform elliptic point addition with a base point of the elliptic curve and the first public key.
Example 5: The method of any one of Examples 1-4, wherein performing the first measurement comprises applying a Inverse Quantum Fourier Transform gate.
Example 6: The method of any one of Examples 1-5, wherein the phase estimation scheme is a first phase estimation scheme, and wherein before the second measurement the quantum state is prepared by applying a second phase estimation scheme on the plurality of qubits.
Example 7: The method of any one of Examples 1-6, wherein the second phase estimation scheme comprises one or more unitary gates.
Example 8: The method of any one of Examples 1-7, wherein the elliptic curve is from a plurality of elliptic curves, each elliptic curve of the plurality of elliptic curves having different base points.
Example 9: The method of any one of Examples 1-8, wherein the one or more unitary gates are configured to perform elliptic point addition with a base point of the elliptic curve and the second public key.
Example 10: A method, comprising: determining a first plurality of private keys based at least in part on an application of a first series of quantum phase estimation circuits to a first plurality of qubits, wherein the first plurality of private keys is determined further based at least in part on a first plurality of respective public keys and a base point P, determining a second plurality of private keys based at least in part on an application of a second series of quantum phase estimation circuits to a second plurality of qubits, wherein the second plurality of private keys is determined further based at least in part on a second plurality of respective public keys and the base point P; wherein applying the first and second series of quantum phase estimation circuits comprises: applying at least one joint modular multiplicative inverse circuit on a first qubit of the first plurality of qubits and a second qubit of the second plurality of qubits, wherein the at least one joint modular multiplicative inverse circuit calculates a modular multiplicative inverse of a modular product of a first value of the first qubit and a second value of the second qubit; and storing the first and second pluralities of private keys in a non-transitory computer-readable memory medium.
Example 11: The method of Example 10, wherein applying the at least one joint modular multiplicative inverse circuit further comprises: performing a modular multiplication of the first value and the second value; performing a modular multiplication of the first value and the modular multiplicative inverse of the product of the first and second values to obtain a modular multiplicative inverse of the second value; and performing a modular multiplication of the second value and the modular multiplicative inverse of the product of the first and second values to obtain a modular multiplicative inverse of the first value.
Example 12: A non-transitory computer-readable memory medium comprising program instructions that, when executed by a processor, cause a quantum computing system to perform the methods of any of Example 10 or Example 11-16.
Example 13: The method of any one of Examples 10-12, wherein the first and second pluralities of private keys are encrypted with elliptic curve cryptography (ECC).
Example 14: The method of any one of Examples 10-13, wherein the first and second series of quantum phase estimation circuits and the joint modular multiplicative inverse circuit utilize an active-volume quantum computing architecture.
Example 15: The method of any one of Examples 10-14, wherein determining the first and second pluralities of private keys further comprises: applying the first and second series of quantum phase estimations circuits to determine approximations of the first and second pluralities of private keys, respectively; and utilizing a brute force decryption method to determine the first and second pluralities of private key based on the approximations of the first and second pluralities of private keys, respectively.
Example 16: The method of any one of Examples 10-15, wherein the first series of quantum phase estimation circuits comprises: a first subcircuit, the method further comprising applying the first subcircuit to: apply a series of unitary operators {U_{P}, U_{2P}, . . . , U₂ⁿ_{P}} to prepare a state |ψ_{c}), where c is an integer and n is a total number of bits of each private key of the first plurality of private keys; perform a first classical measurement to measure the integer c; and a second subcircuit, the method further comprising applying the second subcircuit to: apply a series of unitary operators {U_{Qj}, U_{2Qj}, . . . U₂ⁿ_{Qj}} a plurality of times for each of a plurality of values of j={1, . . . , m}, where m is a total number of private keys in the first plurality of private keys, to prepare a plurality of respective states |ψ_{ck} [symbol] for j={1, . . . , m}; and perform second classical measurements to measure the integers ckⱼ, wherein kⱼ for j={1, . . . , m} are the first plurality of private keys.
Example 17: The method of any one of Examples 10-16, wherein the first and second series of quantum phase estimation circuits comprise respective subroutines to determine a value of a parameter λ_r when a first elliptic curve point P1 is equal to a second elliptic curve point P2.
Example 18: A quantum circuit, comprising: a first series of quantum phase estimation circuits configured to receive as input a first plurality of qubits and output a first plurality of private keys, wherein the first plurality of private keys is output based at least in part on a first plurality of respective public keys and a base point P, a second series of quantum phase estimation circuits configured to receive as input a second plurality of qubits and output a second plurality of private keys, wherein the second plurality of private keys is output based at least in part on a second plurality of respective public keys and the base point P; wherein the first and second series of quantum phase estimation circuits are configured to be executed in parallel; and at least one joint modular multiplicative inverse circuit configured to receive as input a first qubit of the first plurality of qubits and a second qubit of the second plurality of qubits, wherein the at least one joint modular multiplicative inverse circuit is configured to calculate a modular multiplicative inverse of a modular product of a first value of the first qubit and a second value of the second qubit.
Example 19: The quantum circuit of Example 18, wherein the at least one joint modular multiplicative inverse circuit is configured to: perform a modular multiplication of the first value and the second value; perform a modular multiplication of the first value and the modular multiplicative inverse of the product of the first and second values to obtain a modular multiplicative inverse of the second value; and perform a modular multiplication of the second value and the modular multiplicative inverse of the product of the first and second values to obtain a modular multiplicative inverse of the first value.
Example 20: The quantum circuit of Example 18 or Example 19, wherein the first and second pluralities of private keys are encrypted with elliptic curve cryptography (ECC).
Example 21: The quantum circuit of any one of Examples 18-20, wherein the first and second series of quantum phase estimation circuits and the joint modular multiplicative inverse circuit utilize an active-volume quantum computing architecture.
Example 22: The quantum circuit of any one of Examples 18-21, wherein the first series of quantum phase estimation circuits comprises: a first subcircuit, wherein the first subcircuit is configured to: apply a series of unitary operators {U_{P}, U_{2P}, . . . , U₂ⁿ_{P}} to prepare a state |ψ_{c} [symbol] , where c is an integer and n is a total number of bits of each private key of the first plurality of private keys; and perform a first classical measurement to measure the integer c; and a second subcircuit, wherein the second subcircuit is configured to: apply a series of unitary operators {U_{Qj}, U_{2Qj}, . . . U₂ⁿ_{Qj}} a plurality of times for each of a plurality of values of j={1, . . . , m}, where m is a total number of private keys in the first plurality of private keys, to prepare a plurality of respective states |ψ_{ckj} [symbol] for j={1, . . . , m}; and perform second classical measurements to measure the integers ckⱼ, wherein kⱼ for j={1, . . . , m} are the first plurality of private keys.
Example 23: The quantum circuit of any one of Examples 18-22, wherein the first and second series of quantum phase estimation circuits comprise respective subcircuits to determine a value of a parameter λ_r when a first elliptic curve point P1 is equal to a second elliptic curve point P2.
Example 24: A method for performing a quantum simulation to evolve a plurality of m physical systems in time, the method comprising: representing time evolution of each physical system j of the plurality of m physical systems as a series of n Pauli operators, Pᵢⱼ for i=1 . . . n and j=1 . . . m, where the i denotes the n Pauli operators in the series and j denotes the m physical systems; for each respective value of i, constructing a respective Hamming-weight phasing circuit to implement the m Pauli operators Pᵢⱼ, for j=1 . . . m, with the respective value of i.
Example 25: The method of Example 24, wherein the Hamming-weight phasing circuits each comprise log (n) Pauli operators.

It should be understood that all numerical values used herein are for purposes of illustration and may be varied. In some instances, ranges are specified to provide a sense of scale, but numerical values outside a disclosed range are not precluded.

It should also be understood that all diagrams herein are intended as schematic. Unless specifically indicated otherwise, the drawings are not intended to imply any particular physical arrangement of the elements shown therein, or that all elements shown are necessary. Those skilled in the art with access to this disclosure will understand that elements shown in drawings or otherwise described in this disclosure may be modified or omitted and that other elements not shown or described may be added.

This disclosure provides a description of the claimed invention with reference to specific embodiments. Those skilled in the art with access to this disclosure will appreciate that the embodiments are not exhaustive of the scope of the claimed invention, which extends to all variations, modifications, and equivalents.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

It will also be understood that, although the terms first, second, etc., are, in some instances, used herein to describe various elements, these elements should not be limited by these terms. These terms are only used to distinguish one element from another. For example, a first switch could be termed a second switch, and, similarly, a second switch could be termed a first switch, without departing from the scope of the various described embodiments. The first switch and the second switch are both switches, but they are not the same switch unless explicitly stated as such.

As used herein, the term “if” is, optionally, construed to mean “when” or “upon” or “in response to determining” or “in response to detecting” or “in accordance with a determination that,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

1-29. (canceled)

30. A method, comprising:
determining a first plurality of private keys based at least in part on an application of a first series of quantum phase estimation circuits to a first plurality of qubits, wherein the first plurality of private keys is determined further based at least in part on a first plurality of respective public keys and a base point P;
determining a second plurality of private keys based at least in part on an application of a second series of quantum phase estimation circuits to a second plurality of qubits, wherein the second plurality of private keys is determined further based at least in part on a second plurality of respective public keys and the base point P,
wherein applying the first and second series of quantum phase estimation circuits comprises:
applying at least one joint modular multiplicative inverse circuit on a first qubit of the first plurality of qubits and a second qubit of the second plurality of qubits, wherein the at least one joint modular multiplicative inverse circuit calculates a modular multiplicative inverse of a modular product of a first value of the first qubit and a second value of the second qubit; and
storing the first and second pluralities of private keys in a non-transitory computer-readable memory medium.

31. The method of claim 30,
wherein applying the at least one joint modular multiplicative inverse circuit further comprises:
performing a modular multiplication of the first value and the second value;
performing a modular multiplication of the first value and the modular multiplicative inverse of the product of the first and second values to obtain a modular multiplicative inverse of the second value; and
performing a modular multiplication of the second value and the modular multiplicative inverse of the product of the first and second values to obtain a modular multiplicative inverse of the first value.

32. The method of claim 30,
wherein the first and second pluralities of private keys are encrypted with elliptic curve cryptography (ECC).

33. The method of claim 30,
wherein the first and second series of quantum phase estimation circuits and the joint modular multiplicative inverse circuit utilize an active-volume quantum computing architecture.

34. The method of claim 30,
wherein determining the first and second pluralities of private keys further comprises:
applying the first and second series of quantum phase estimations circuits to determine approximations of the first and second pluralities of private keys, respectively; and
utilizing a brute force decryption method to determine the first and second pluralities of private key based on the approximations of the first and second pluralities of private keys, respectively.

35. The method of claim 30,
wherein the first series of quantum phase estimation circuits comprises:
a first subcircuit, the method further comprising applying the first subcircuit to:
apply a series of unitary operators {U_{P}, U_{2P}, . . . , U₂ⁿ_{P}} to prepare a state |ψc [symbol] , where c is an integer and n is a total number of bits of each private key of the first plurality of private keys; and
perform a first classical measurement to measure the integer c; and
a second subcircuit, the method further comprising applying the second subcircuit to:
apply a series of unitary operators {U_{Qj}, U_{2Qj}, . . . U₂ⁿ_{Qj}} a plurality of times for each of a plurality of values of j={1, . . . , m}, where m is a total number of private keys in the first plurality of private keys, to prepare a plurality of respective states |ψ_{ckj} [symbol] for j={1, . . . , m}; and
perform second classical measurements to measure the integers ck,
wherein kⱼ for j={1, . . . , m} are the first plurality of private keys.

36. The method of claim 30,
wherein the first and second series of quantum phase estimation circuits comprise respective subroutines to determine a value of a parameter λᵣ when a first elliptic curve point P₁ is equal to a second elliptic curve point P₂.

37. The method of claim 30,
wherein the first and second series of quantum phase estimation circuits are applied in parallel.

38. The method of claim 30,
wherein the first and second series of quantum phase estimation circuits utilize an active volume quantum computing architecture.

39. A quantum circuit, comprising:
a first series of quantum phase estimation circuits configured to receive as input a first plurality of qubits and output a first plurality of private keys, wherein the first plurality of private keys is output based at least in part on a first plurality of respective public keys and a base point P,
a second series of quantum phase estimation circuits configured to receive as input a second plurality of qubits and output a second plurality of private keys, wherein the second plurality of private keys is output based at least in part on a second plurality of respective public keys and the base point P; and
at least one joint modular multiplicative inverse circuit configured to receive as input a first qubit of the first plurality of qubits and a second qubit of the second plurality of qubits, wherein the at least one joint modular multiplicative inverse circuit is configured to calculate a modular multiplicative inverse of a modular product of a first value of the first qubit and a second value of the second qubit.

40. The quantum circuit of claim 39,
wherein the at least one joint modular multiplicative inverse circuit is configured to:
perform a modular multiplication of the first value and the second value;
perform a modular multiplication of the first value and the modular multiplicative inverse of the product of the first and second values to obtain a modular multiplicative inverse of the second value; and
perform a modular multiplication of the second value and the modular multiplicative inverse of the product of the first and second values to obtain a modular multiplicative inverse of the first value.

41. The quantum circuit of claim 39,
wherein the first and second pluralities of private keys are encrypted with elliptic curve cryptography (ECC).

42. The quantum circuit of claim 39,
wherein the first and second series of quantum phase estimation circuits and the joint modular multiplicative inverse circuit utilize an active-volume quantum computing architecture.

43. The quantum circuit of claim 39,
wherein the first series of quantum phase estimation circuits comprises:
a first subcircuit, wherein the first subcircuit is configured to:
apply a series of unitary operators {U_{P}, U_{2P}, . . . , U₂ⁿ_{P}} to prepare a state |ψ_{c} [symbol] , where c is an integer and n is a total number of bits of each private key of the first plurality of private keys; and
perform a first classical measurement to measure the integer c; and
a second subcircuit, wherein the second subcircuit is configured to:
apply a series of unitary operators {U_{Qj}, U_{2Qj}, . . . U₂ⁿ_{Qj}} a plurality of times for each of a plurality of values of j={1, . . . , m}, where m is a total number of private keys in the first plurality of private keys, to prepare a plurality of respective states |ψ_{ckj} [symbol] for j={1, . . . , m}; and
perform second classical measurements to measure the integers ckⱼ wherein kⱼ for j={1, . . . , m} are the first plurality of private keys.

44. The quantum circuit of claim 39,
wherein the first and second series of quantum phase estimation circuits comprise respective subcircuits to determine a value of a parameter λᵣ when a first elliptic curve point P₁ is equal to a second elliptic curve point P₂.

45. The quantum circuit of claim 39,
wherein the first and second series of quantum phase estimation circuits are configured to be applied in parallel.

46. The quantum circuit of claim 39,
wherein the quantum circuit implements an active volume quantum computing architecture.

47. The quantum circuit of claim 39,
wherein, in determining the first and second pluralities of private keys, the first and second series of quantum phase estimation circuits are further configured to:
determine approximations of the first and second pluralities of private keys, respectively; and
utilize a brute force decryption method to determine the first and second pluralities of private key based on the approximations of the first and second pluralities of private keys, respectively.

48. A non-transitory computer-readable memory medium comprising program instructions that, when executed by a processor, cause a quantum computing system to:
determine a first plurality of private keys based at least in part on an application of a first series of quantum phase estimation circuits to a first plurality of qubits, wherein the first plurality of private keys is determined further based at least in part on a first plurality of respective public keys and a base point P,
determine a second plurality of private keys based at least in part on an application of a second series of quantum phase estimation circuits to a second plurality of qubits, wherein the second plurality of private keys is determined further based at least in part on a second plurality of respective public keys and the base point P;
wherein, in applying the first and second series of quantum phase estimation circuit, the program instructions are executable to cause the quantum computing system to:
apply at least one joint modular multiplicative inverse circuit on a first qubit of the first plurality of qubits and a second qubit of the second plurality of qubits, wherein the at least one joint modular multiplicative inverse circuit calculates a modular multiplicative inverse of a modular product of a first value of the first qubit and a second value of the second qubit; and
store the first and second pluralities of private keys in the non-transitory computer-readable memory medium.

49. The non-transitory computer-readable memory medium of claim 48, wherein, in applying the at least one joint modular multiplicative inverse circuit, the program instructions are executable to cause the quantum computing system to:
perform a modular multiplication of the first value and the second value;
perform a modular multiplication of the first value and the modular multiplicative inverse of the product of the first and second values to obtain a modular multiplicative inverse of the second value; and
perform a modular multiplication of the second value and the modular multiplicative inverse of the product of the first and second values to obtain a modular multiplicative inverse of the first value.
